(19) United States
(12) Patent Application Publication
(10) Pub. No.: US 2015/0323711 A1
(43) Pub. Date: Nov. 12, 2015

(54) SCATTERER SUBSTRATE

(71) Applicant: Sharp Kabushiki Kaisha, Osaka-shi, Osaka (JP)

(72) Inventors: Hisanori BESSHO, Osaka-shi (JP); Hidetsugu MATSUKIYO, Osaka-shi (JP); Mitsuhiro KODEN, Osaka-shi (JP); Yoshimasa FUJITA, Osaka-shi (JP); Osamu KAWASAKI, Osaka-shi (JP)

(21) Appl. No.: 14/648,276

(22) PCT Filed: Nov. 6, 2013
(86) PCT No.: PCT/JP2013/079987

§ 371 Date: May 29, 2015

(30) Foreign Application Priority Data
Nov. 30, 2012 (JP) 2012-262798

(51) Int. Cl. G02B 5/02; G02F 1/1335

(52) U.S. Cl. CPC G02B 5/0242; G02F 1/133617; G02F 2001/133614

(57) ABSTRACT

A scatterer substrate includes at least a substrate; and a scatterer layer which is overlapped and disposed on one surface side of the substrate and has a plurality of non-light emitting particles that change a traveling direction of light, in which the scatterer layer is formed of at least the particles and gaps maintained between the particles and the substrate.

### TECHNICAL FIELD

The present invention relates to a scatterer substrate capable of emitting incident light to the outside without reflecting the incident light on an interface between a substrate and the outside.

The present application claims priority based on Japanese Patent Application No. 2012-262798 filed in Japan on Nov. 30, 2012 and the contents of which are incorporated herein by reference.

### BACKGROUND ART

In recent years, with advanced information society, a flat panel display (FPD) has been highly demanded. Examples of the flat panel display include a non-self-luminous liquid crystal display (LCD), a self-luminous plasma display (PDP), an inorganic electroluminescence (inorganic EL) display, and an organic electroluminescence (hereinafter, also referred to as an “organic EL” or an “organic LED”) display.

Particularly, in a liquid crystal display among these flat panel displays, a lighting device is generally provided as a light source on the rear surface of a transmissive liquid crystal display element and the viewability is improved by irradiating the rear surface of the liquid crystal element with light.

In such a liquid crystal display, light emitted from a light source is generally non-polarized light and 50% or more of the light is absorbed by a polarizer arranged at illumination light incident side of a liquid crystal display element and thus utilization efficiency of light from the light source is low. In addition, in a color liquid crystal display device in which a white light source is used as a light source and color filters corresponding to three primary colors or four primary colors are arranged in a display surface and which performs color display according to additive color mixture, since more than 70% of light is absorbed by such color filters, the utilization efficiency of light from the light source is extremely low and thus an increase in utilization efficiency of light is a major issue.

In order to solve the above-described problem, for example, a color display device is known which includes a pair of transparent substrates which are arranged with a certain interval such that surfaces on which transparent electrodes are formed face each other; a liquid crystal layer which is interposed between the transparent substrates; a liquid crystal display element which has voltage applying means for applying a voltage corresponding to an image signal to pixels in a matrix shape formed by the transparent electrodes of the pair of transparent substrates; an excitation light source which emits light of a blue region to a blue-green region; a phosphor for wavelength conversion which absorbs light of a blue region to a blue-green region from the excitation light source and emits red light; a phosphor for wavelength conversion which absorbs light of a blue region to a blue-green region from the excitation light source and emits green light; and a color filter that cuts light other than light of a blue region to a blue-green region (for example, see PTLs 1 and 2).

According to the above-described configuration, since a blue display pixel can use blue light emitted from a blue light source as it is, light utilization efficiency can be increased.

However, in a liquid crystal display device using a blue light source, there is a problem in that a display image looks yellowish when seen from an oblique direction and viewing angle color display characteristics are deteriorated.

Accordingly, for example, a liquid crystal display device is known which includes a blue light source which emits blue light; a liquid crystal element which includes liquid crystal cells and a pair of polarizers with the liquid crystal cells interposed therebetween; a color filter which has a phosphor excited by the blue light and emitting red fluorescence and a phosphor excited by the blue light and emitting green fluorescence; and a light scattering film which scatters at least the blue light (for example, see PTL 3).

### CITATION LIST

### Patent Literature

PTL 1: Japanese Unexamined Patent Application Publication No. 2000-131683

PTL 2: Japanese Unexamined Patent Application Publication No. 2006-309225

PTL 3: Japanese Unexamined Patent Application Publication No. 2009-244383

### SUMMARY OF INVENTION

### Technical Problem

In the color display device described in PTLs 1 and 2, since blue display pixels can use blue light emitted from a blue light source as it is, light utilization efficiency can be increased.

However, in the liquid crystal display device using a blue light source, there is a problem in that a display image looks yellowish when seen from an oblique direction and viewing angle color display characteristics are deteriorated.

In the liquid crystal display device described in PTL 3, an example is described in which light emitted from blue pixels is scattered by a light scattering film formed of light scattering particles and a transparent resin to increase a viewing angle. However, since light scattering particles are surrounded by a resin, there is a problem in that “color blurring” occurs in which scattering light scattered by light scattering particles is reflected on an interface between a substrate and the outside having different refractive indices, the reflected scattering light enters adjacent blue pixels, light emitted from pixels which are not to emit light originally is observed, and this leads to degradation of display quality.

The present invention is made in consideration of the above-described problems and an object thereof is to provide a scatterer substrate, a light emitting device, a display device, and a lighting device which emit incident light to the outside without reflecting the incident light on an interface between a substrate and the outside and are capable of emitting the incident light to the outside by diffusing the incident light to have a wide viewing angle.

### Solution to Problem

In order to solve the above-described problems, several aspects of the present invention provide a scatterer substrate described below.

That is, a scatterer substrate according to the invention includes at least: a substrate; and a scatterer layer which is overlapped and disposed on one surface side of the substrate and has a plurality of non-light emitting particles that change a traveling direction of light, in which the scatterer layer is formed of at least the particles and gaps maintained between the particles and the substrate.

The particles may be formed of an inorganic material.

Two or more and ten or fewer particles may be present in a thickness direction of the scatterer layer.

The particles may have an average particle diameter of 50 nm or more and 10 μm or less.

The particles may be formed of at least two kinds of particles whose average particle diameters are different from each other.

The particles may include first particles and second particles which have average particle diameters different from each other, the relationship between an average particle diameter Da of the first particles and an average particle diameter Db of the second particles may satisfy Da≧Db, and the relationship between a volume Va of the first particles occupying the scatterer layer and a volume Vb of the second particles occupying the scatterer layer may satisfy Va≧Vb.

The particles may be disposed such that the thickness of the particles on one surface side of the substrate is 10 μm or greater.

The gaps may be filled with a low refractive index medium.

The low refractive index medium may be a gas.

The gas may contain at least one selected from air, N₂, O₂, Ar, and CO₂.

The gap may be a vacuum.

In the scatterer substrate, a bonding layer which bonds the particles adjacent to each other may be formed between the particles.

The substrate may be formed of glass.

A light emitting device according to the invention includes: the scatterer substrate; and a light source which emits light.

In the light emitting device, a light-reflective partition wall may be formed along at least one side surface of the scatterer layer which is arranged along a direction in which the light source and the scatterer substrate are laminated.

At least a region, which is in contact with the scatterer layer, of the partition wall may have light scattering properties.

In the light emitting device, phosphor layers which emit fluorescence by using light from the light source may be arranged along a direction in which the light source and the scatterer substrate are laminated.

The light emitting device may further include: an excitation light source which emits blue light; a red phosphor layer which constitutes a red pixel that is excited by the blue light and emits red fluorescence; a green phosphor layer which constitutes a green pixel that is excited by the blue light and emits green fluorescence; and the scatterer layer which constitutes a blue pixel that scatters the blue light, which are arranged so as to face the excitation light source.

The light emitting device may further include: an excitation light source which emits blue light; a red phosphor layer which constitutes a red pixel that is excited by the blue light and emits red fluorescence; a green phosphor layer which constitutes a green pixel that is excited by the blue light and emits green fluorescence; a blue phosphor layer which constitutes a blue pixel that is excited by the blue light and emits blue fluorescence, which are arranged so as to face the excitation light source; and the scatterer layer which scatters the fluorescence.

A light-reflective partition wall may be formed along a side surface of the phosphor layers.

At least a region, which is in contact with the phosphor layers, of the partition wall may have light scattering properties.

A wavelength selection layer which has characteristics of transmitting at least light having a predetermined wavelength region centering on a peak wavelength of the blue light and reflecting at least light having a predetermined wavelength region centering on a light emitting peak wavelength of the phosphor layers may be formed on an incident surface side of the phosphor layers on which the blue light is incident.

In the light emitting device, further, a low refractive index layer whose refractive index is lower than that of the phosphor layers may be formed between the phosphor layers and the wavelength selection layer.

The refractive index of the low refractive index layer may be in a range of 1 or higher and 1.5 or lower.

The low refractive index layer may be formed of a gas.

In the light emitting device, a light absorbing layer may be further formed between the phosphor layers adjacent to each other or between the phosphor layers and the blue scatterer layer.

The light absorbing layer may be formed on at least one of an upper surface and a lower surface of the partition wall.

A display device according to the invention includes at least the light emitting device.

The display device may further include an active matrix driving element for the light source.

The light source may be formed of any one of a light emitting diode, an organic electroluminescence element, and an inorganic electroluminescence element.

The light source may be a planar light source, and a liquid crystal element in which a transmittance of light emitted from the light source is controllable may be provided between the light source and the substrate.

The light source may emit the blue light having directivity.

In the display device, a polarizer in which an extinction ratio in a wavelength range of 435 nm or more and 480 nm or less is 10000 or greater may be further provided between the excitation light source and the substrate.

In the display device, a color filter may be formed at least between the phosphor layers and blue scatterer film and the low refractive index film or between the low refractive index film and the substrate.

A lighting device according to the invention includes the light emitting device.

### Advantageous Effects of Invention

According to the present invention, it is possible to provide a scatterer substrate, a light emitting device, a display device, and a lighting device which emit incident light to the outside without reflecting the incident light on an interface between a substrate and the outside and are capable of emitting the incident light to the outside by diffusing the incident light to have a wide viewing angle.

### BRIEF DESCRIPTION OF DRAWINGS

FIG. 1 is a sectional view schematically illustrating a first example of a light emitting device in the related art.

FIG. 2 is a sectional view schematically illustrating a second example of a light emitting device in the related art.

FIG. 3 is a sectional view schematically illustrating a third example of a light emitting device in the related art.

FIG. 4 is a sectional view schematically illustrating a first embodiment of a light emitting device according to the present invention.

FIG. 5 is a sectional view schematically illustrating a second embodiment of a light emitting device according to the present invention.

FIG. 6 is a sectional view schematically illustrating a third embodiment of a light emitting device according to the present invention.

FIG. 7 is a sectional view schematically illustrating a fourth embodiment of a light emitting device according to the present invention.

FIG. 8 is a sectional view schematically illustrating a fifth embodiment of a light emitting device according to the present invention.

FIG. 9 is a sectional view schematically illustrating a sixth embodiment of a light emitting device according to the present invention.

FIG. 10 is a sectional view schematically illustrating a seventh embodiment of a light emitting device according to the present invention.

FIG. 11 is a sectional view schematically illustrating an eighth embodiment of a light emitting device according to the present invention.

FIG. 12 is a sectional view schematically illustrating a ninth embodiment of a light emitting device according to the present invention.

FIG. 13 is a sectional view schematically illustrating a tenth embodiment of a light emitting device according to the present invention.

FIG. 14 is a sectional view schematically illustrating an eleventh embodiment of a light emitting device according to the present invention.

FIG. 15 is a sectional view schematically illustrating an organic EL element substrate constituting a display device according to the present invention.

FIG. 16 is a sectional view schematically illustrating an LED substrate constituting a display device according to the present invention.

FIG. 17 is a sectional view schematically illustrating an inorganic EL element substrate constituting a display device according to the present invention.

FIG. 18 is a sectional view schematically illustrating an organic EL display constituting a display device according to the present invention.

FIG. 19 is a plan view schematically illustrating an organic EL display constituting a display device according to the present invention.

FIG. 20 is a sectional view schematically illustrating a display device according to the present invention.

FIG. 21 is a sectional view schematically illustrating a display device according to the present invention.

FIG. 22 is an external view illustrating a mobile phone which is an application example of a display device according to the present invention.

FIG. 23 is an external view illustrating a thin television which is an application example of a display device according to the present invention.

FIG. 24 is a sectional view schematically illustrating an embodiment of organic EL lighting according to the present invention.

FIG. 25 is a sectional view schematically illustrating an embodiment of a lighting device according to the present invention.

FIG. 26 is an explanatory view describing a viewing angle in an embodiment.

FIG. 27A is a photograph in which the state of emitted light of a light emitting device of the present invention is observed.

FIG. 27B is a photograph in which the state of emitted light of a light emitting device in the related art is observed.

FIG. 28 is a graph indicating calculation results of Examples.

FIG. 29 is a sectional view schematically illustrating an embodiment of a storage container according to the present invention.

### DESCRIPTION OF EMBODIMENTS

Hereinafter, embodiments of a scatterer substrate, a light emitting device, a display device, and a lighting device according to the present invention will be described with reference to the accompanying drawings.

In addition, the embodiments shown below will be described in detail for understanding the scope of the invention and the present invention is not limited thereto unless otherwise noted.

Further, for the sake of convenience of description, the drawings used in the description below are illustrated by enlarging main portions and dimensions and ratios of respective constituent elements are not necessarily the same as the actual dimensions and ratios.

### [Light Emitting Device in Related Art: First Example]

First, in order to clarify the difference between a light emitting device in the related art and the light emitting device of the present invention, the configuration and the action of the light emitting device in the related art will be described.

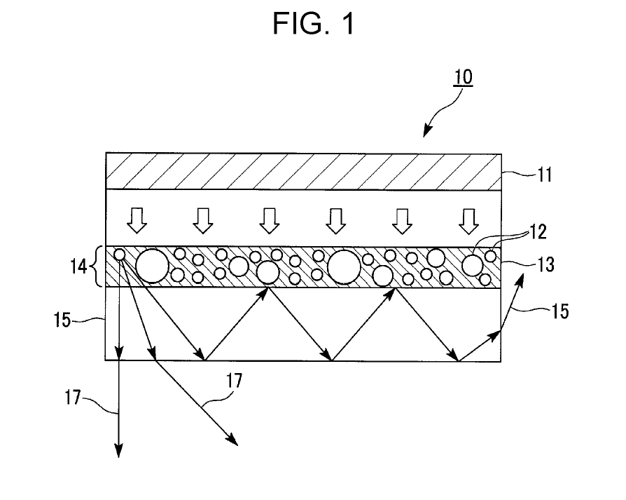

FIG. 1 is a sectional view schematically illustrating a first example of the light emitting device in the related art.

A light emitting device 10 in the related art is schematically configured of an excitation light source 11 which emits light; light scattering particles 12 which are disposed so as to face the light source and changes a traveling direction of light emitted from the light source; and a substrate 15 on which a scatterer layer 14 formed of a transparent resin 13 in which the particles are mixed is formed.

Light emitting device in the related art: In the first example, in a case where light is incident on a scatterer layer from the outside, the light is incident to light scattering particles and becomes scattering light through a transparent resin. A component proceeding to a substrate side through the transparent resin and a component proceeding to a light source side through the transparent resin or a component incident on other particles again are present in the scattering light. Here, refractive index interfaces due to refractive index differences of respective layers are present between the scatterer layer and the substrate and between the substrate and the outside. In a case of the present configuration, since a refractive index of a transparent resin constituting a scatterer layer is generally around 1.5 and a refractive index of glass generally used as a substrate is around 1.5, most scattering light of the scattering light which proceeds to the substrate side is incident on the substrate without being totally reflected on the interface between the scatterer layer and the substrate. However, there is a problem in that a refractive index interface is present between the substrate (refractive index: around 1.5) and the outside (refractive index: 1.0) and light (light beam 16 in the figure) incident on the same interface at an angle of larger than 42° (angle greater than or equal to a critical angle) is totally reflected based on Snell's law and cannot be extracted to the outside.

### [Light Emitting Device in Related Art: Second Example]

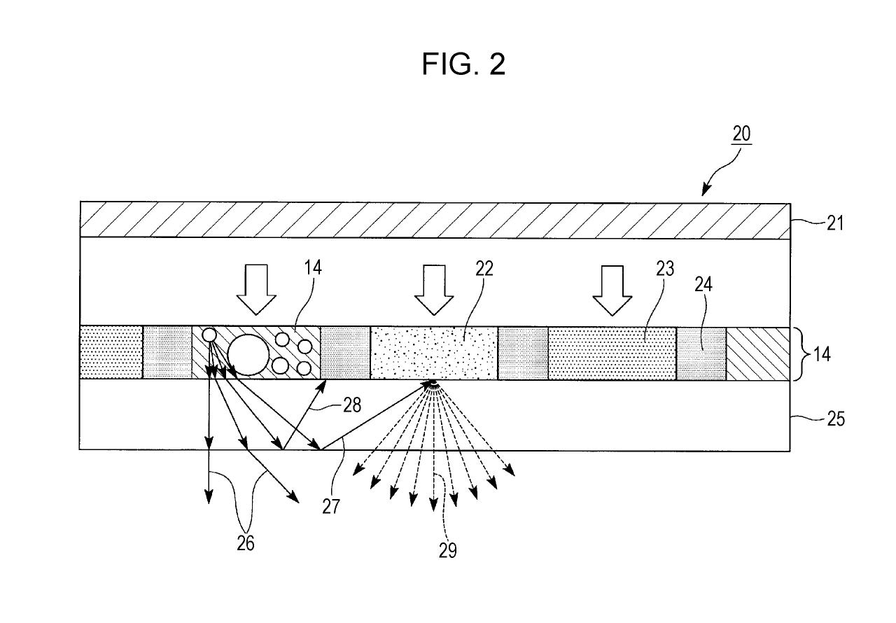

FIG. 2 is a sectional view schematically illustrating a second example of the light emitting device in the related art.

A light emitting device 20 in the related art is schematically configured of an excitation light source 21 which emits excitation light; a first phosphor layer 22 which is disposed so as to face the excitation light source, is excited by the excitation light, and emits fluorescence; a second phosphor layer 23; the scatterer layer 14 of the first example is formed between the phosphor layers adjacent to each other; and a substrate 25 in which light absorbing layers 24 are respectively formed between respective layers.

In a case where the light emitting device is configured of a plurality of layers illustrated in FIG. 2, light absorbing layers are formed between layers such that light emitted from respective layers is not mixed. However, a part of light of light scattered by the scatterer layer which is totally reflected on the interface between the substrate and the outside is absorbed by the light absorbing layer (light beam 28 in the figure), but there is a problem in that a part of light is incident on the phosphor layers adjacent to each other (light beam 27 in the figure), the phosphor layers emit light, the light emitted from the respective layers is mixed, color blurring is generated, and thus display quality is degraded.

### [Light Emitting Device in the Related Art: Third Example]

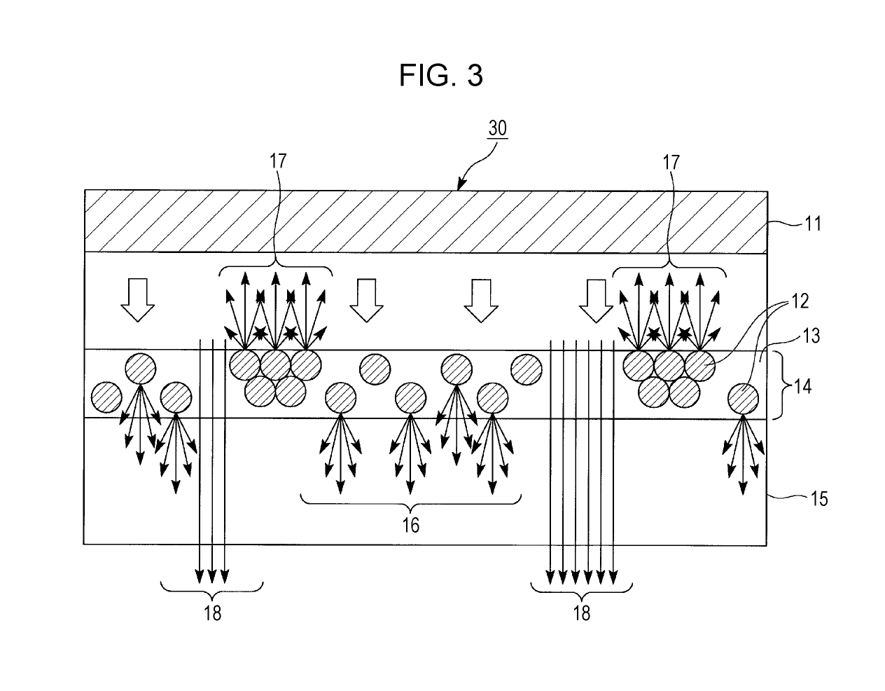

FIG. 3 is a sectional view schematically illustrating a third example of a light emitting device in the related art. Further, elements having the same configurations as those of FIG. 1 are denoted by the same reference numerals.

A light emitting device 30 in the related art is schematically configured of a light source 11 which emits light; light scattering particles 12 which are disposed so as to face the light source and change the traveling direction of light emitted from the light source; and a substrate 15 on which a scatterer layer 14 formed of a transparent resin 13 in which the particles are mixed is formed.

The light emitting device in the related art: In the third example, in a case where light is incident on the scatterer layer from the outside, most light is divided into a component (forward scattering component: reference numeral 16 in the figure) which is scattered by particles (1) and proceeds to a substrate side; a component (back-scattering component: reference numeral 17 in the figure) which is scattered by particles (2) and proceed to the light source side, and a component (forward transmitted component: reference numeral 18 in the figure) which proceeds to the substrate side without reaching particles (3). In a case where particles are not uniformly dispersed in a resin, for example, in a case where a region in which particles are concentrated on the scatterer layer in the thickness direction is present, the back-scattering component (2) becomes dominant. Further, in a case where a region in which particles are not present on the scatterer layer in the thickness direction due to formation of a through hole, the forward transmitted component (3) becomes dominant. That is, in a case where particles are not uniformly dispersed in resin, there is a problem in that components which can be extracted to a viewer side (substrate side) as scattering light, that is, the forward scattering components (1), become decreased.

Hereinafter, embodiments of the scatterer substrate, the light emitting device, the display device, and the lighting device according to the present invention will be described with reference to the accompanying drawings. In addition, the embodiments shown below will be described in detail for understanding the scope of the invention and the present invention is not limited thereto unless otherwise noted. Further, for the sake of convenience of description, the drawings used in the description below are illustrated by enlarging main portions and dimensions and ratios of respective constituent elements are not necessarily the same as the actual dimensions and ratios.

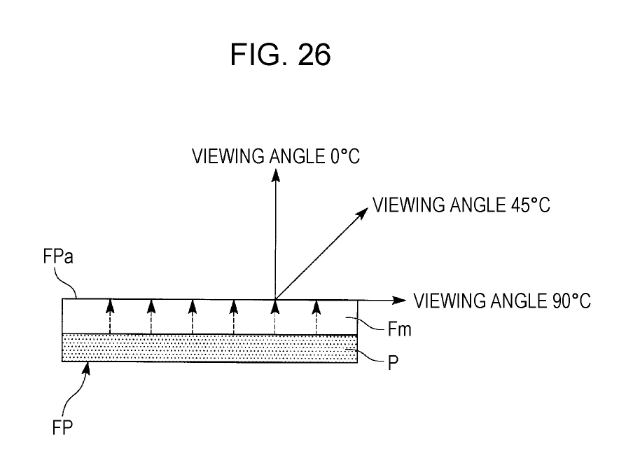

Further, in respective embodiments of the scatterer substrate, the light emitting device, the display device, and the lighting device described below in detail, in the term “viewing angle,” as illustrated in FIG. 26, a direction along an emission surface FPa of light (fluorescence) of a phosphor substrate FP formed of a (transparent) substrate P on which a phosphor Fm is formed is defined as a viewing angle of 90° and a direction perpendicular to the emission surface is defined as a viewing angle of 0°. For example, a viewing angle of 45° C. indicates an angle inclined at an angle of 45° between the direction (90°) along the emission surface of the phosphor substrate and the direction (0°) perpendicular to the emission surface.

### [Light Emitting Device]

### (1) First Embodiment

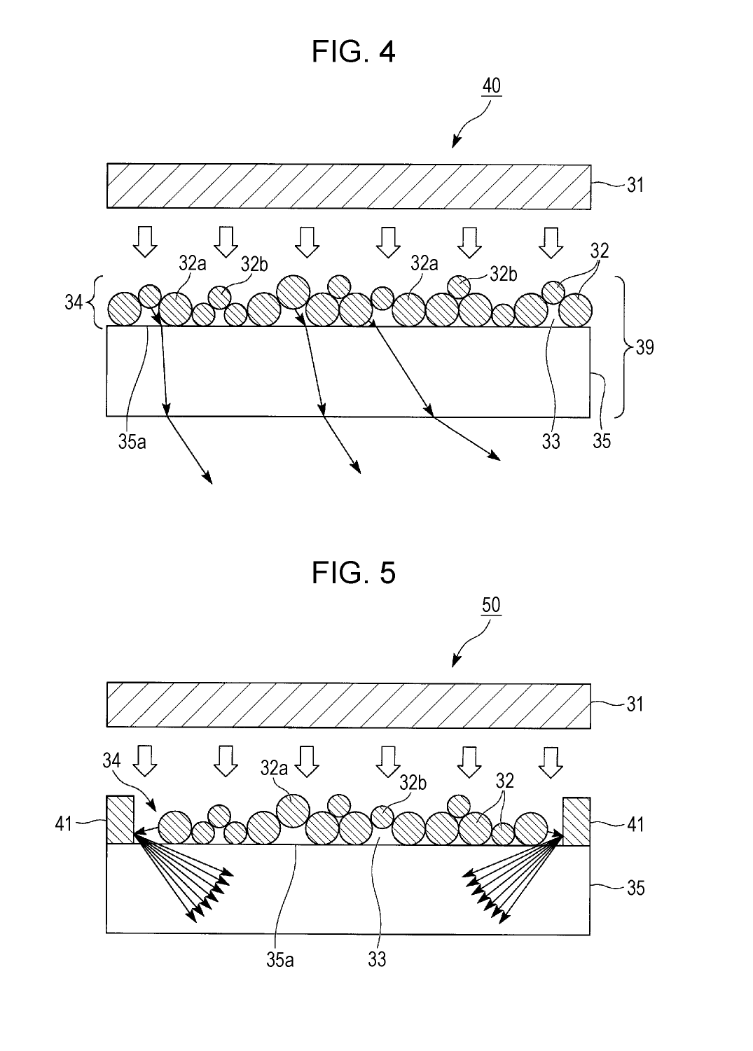

FIG. 4 is a sectional view schematically illustrating a light emitting device according to a first embodiment.

A light emitting device 40 is configured of a light source 31 which emits light; a substrate 35 which is disposed so as to face the light source 31; and a scatterer substrate 39 which has a scatterer layer 34 disposed on one surface 35a of the substrate 35. In addition, the scatterer layer 34 constituting the scatterer substrate 39 is configured of a plurality of non-light emitting particles 32 which change the traveling direction of light emitted from the light source 31; and gaps 33 which are maintained at least between the particles 32 and one surface of the substrate 35.

Hereinafter, respective constituent members constituting the light emitting device 40 and the formation method thereof will be described in detail, but the present embodiment is not limited to these constituent members and the formation method.

As the light source 31, light sources emitting ultraviolet light, blue light, and white light are used. Examples of such light sources include an ultraviolet light emitting diode (hereinafter, also referred to as an “ultraviolet LED”), a blue light emitting diode (hereinafter, also referred to as a “blue LED”), an ultraviolet light emitting inorganic electroluminescence element (hereinafter, also referred to as an “ultraviolet light emitting inorganic EL element”), a blue light emitting inorganic electroluminescence element (hereinafter, also referred to as a “blue light emitting inorganic EL element”), an ultraviolet light emitting organic electroluminescence element (hereinafter, also referred to as an “ultraviolet light emitting organic EL element”), and a blue light emitting organic electroluminescence element (hereinafter, also referred to as a “blue light emitting organic EL element”). The light sources described above can be exemplified as the light source 31, but the light source is not limited thereto.

In addition, since an image is displayed by directly switching the light source 31, ON and OFF of light emission can be controlled, but a layer having a shutter function such as a liquid crystal is arranged between the light source 31 and the scatterer substrate and ON and OFF of light emission can be controlled by controlling the layer. Further, ON and OFF of a layer having a shutter function such as a liquid crystal and a light source 41 can be also controlled.

Since it is necessary for scattering light from the scatterer layer 34 to be extracted to the outside, the substrate 35 is required to transmit emitted light in a light emitting region of a light source and examples thereof include an inorganic material substrate formed of glass, quartz, or the like and a plastic substrate or the like formed of polyethylene terephthalate, polycarbazole, polyimide, or the like. However, the present embodiment is not limited thereto.

In addition, from a viewpoint that a curved portion or a bent portion can be formed without generating stress, it is preferable to use a plastic substrate as the substrate 35. Further, from a viewpoint of capability of improving gas barrier properties, a substrate formed by coating a plastic substrate with an inorganic material is more preferable. In this manner, it is possible to resolve deterioration of an organic EL element due to transmission of moisture (it is known that an organic EL element is deteriorated due to even a small amount of moisture) which is the biggest problem in a case where a plastic substrate is used as a substrate of an organic EL element.

The non-light emitting particles 32 are provided in the scatterer layer 34 and have properties of changing the traveling direction of light in at least the scatterer layer 34. The scatterer layer 34 is configured of at least one particle 32 and gaps provided between the particles 32 and the one surface 35a of the substrate 35. It is preferable that the particles 32 are configured of two kinds of particles 32a and 32b whose particle diameters are different from each other.

As the particles 32, an inorganic material or an organic material may be used. In the case of using an inorganic material, examples of the particles 32 include particles (microparticles) containing at least one kind of metal oxide selected from the group consisting of silicon, titanium, zirconium, aluminum, indium, zinc, tin, and antimony as a main component, but the present embodiment is not limited to these inorganic materials.

In addition, in a case where particles (inorganic microparticles) formed of an inorganic material are used as the particles 32, examples thereof include silica beads (refractive index: 1.44), alumina beads (refractive index: 1.63), titanium oxide beads (refractive index of anatase type: 2.52 and refractive index of rutile type: 2.71), zirconia oxide beads (refractive index: 2.05), zinc oxide beads (refractive index: 2.00), and barium titanate (BaTiO₃) (refractive index: 2.4), but the present embodiment is not limited to these inorganic microparticles.

In a case where particles (organic microparticles) formed of an organic material are used as the particles 32, examples thereof include polymethylmethacrylate beads (refractive index: 1.49), acryl beads (refractive index: 1.50), acryl-styrene copolymer beads (refractive index: 1.54), melamine beads (refractive index: 1.57), high refractive index melamine beads (refractive index: 1.65), polycarbonate beads (refractive index: 1.57), styrene beads (refractive index: 1.60), crosslinked polystyrene beads (refractive index: 1.61), polyvinyl chloride beads (refractive index: 1.60), melamine formaldehyde beads (refractive index: 1.65), benzoguanamine-melamine formaldehyde beads (refractive index: 1.68), and silicone beads (refractive index: 1.50), and the present embodiment is not limited to these organic microparticles.

The gap 33 is filled with a low refractive medium. The low refractive medium is not particularly limited as long as the medium is formed of a gas.

Examples of the gas material constituting the gap 33 include air; a single component such as nitrogen gas, oxygen gas, argon gas, or carbon dioxide gas; a mixture of arbitrary components; an inert gas formed of argon; or the like.

In addition, it is preferable that the gap 33 is a vacuum. Further, in a case of using the gas material described above, the presence concentration and the pressure state are not particularly limited.

The scatterer layer 34 is configured of non-light emitting particles 32 that change the traveling direction of the above-described light and gaps 33 provided between the particles 32 and the one surface 35a of the substrate 35. As a method of forming the scatterer layer 34, a sedimentation coating method of pouring a solution in which particles having a specific gravity greater than that of an aqueous solution are dispersed in the same aqueous solution such as sodium silicate into a sedimentation tube, providing a substrate for application to a bottom portion of the sedimentation tube, coating the substrate with particles using its own weight, discharging the aqueous solution, and forming a scatterer layer; a chemical adsorption method of adsorbing a substrate and particles using a covalent bond between molecules; and an LB film method of adsorbing a substrate and particles in a trough by van der Waals force between molecules, but the method is not limited to these methods.

In addition, a method of dispersing the non-light emitting particles 32 in a transparent resin, forming a film on a substrate, and firing the transparent resin at a high temperature can be exemplified.

In a case of forming the scatterer layer 34 by using such a method, it is preferable to use an inorganic material for non-light emitting particles. In order to fire a transparent resin in which particles are dispersed to form a gap between particles, it is necessary to generally heat the transparent resin at a temperature of 400° C. or higher. The heat resistant temperature of an organic material varies depending on the material, but a temperature of approximately 300° C. is general. Accordingly, in a case where particles formed of an organic material are used, since there is a concern that particles are deteriorated due to the firing process of a resin, it is preferable to use particles formed of an inorganic material.

As the above-described transparent resin, for example, an acrylic resin (refractive index: 1.49), a melamine resin (refractive index: 1.57), nylon (refractive index: 1.53), polystyrene (refractive index: 1.60), melamine beads (refractive index: 1.57), polycarbonate (refractive index: 1.57), polyvinyl chloride (refractive index: 1.60), polyvinylidene chloride (refractive index: 1.61), polyvinyl acetate (refractive index: 1.46), polyethylene (refractive index: 1.53), polymethyl methacrylate (refractive index: 1.49), polyMBS (refractive index: 1.54), medium density polyethylene (refractive index: 1.53), high density polyethylene (refractive index: 1.54), tetrafluoroethylene (refractive index: 1.35), polyethylene chloride trifluoride (refractive index: 1.42), and polytetrafluoroethylene (refractive index: 1.35) are used, but the present embodiment is not limited to these resins.

Examples of the dispersing device of particles which disperses particles according to the dispersing method include a general stirring device having a mechanism such as a propeller blade, a turbine blade, or a battle blade on the tip thereof; a high-speed rotation centrifugal radiation type stirring device having a toothed disc-shape impeller mechanism in which blades of a circular saw are alternately bent in the vertical direction on the tip thereof; an ultrasonic emulsification dispersing device that intensively generates ultrasonic energy to perform a dispersing process; and a bead mill device which fills a container with beads and rotates the container, and grinds a raw material to pulverize and disperse the material, but the dispersing device is not limited thereto.

Examples of the method of forming the above-described materials include a coating method such as a spin coating method, a dipping method, a doctor blade method, an ejection coating method, or a spray coating method; a known wet process using a printing method such as an inkjet method, a letterpress printing method, an intaglio printing method, a screen printing method, or a micro gravure coating method; a known dry process such as a resistance heating vapor deposition method, an electron beam (EB) vapor deposition method, a molecular beam epitaxy (MBE) method, a sputtering method, or an organic vapor phase deposition (OVPD); and a forming method such as a laser transfer method.

Further, the scatterer layer 34 can be patterned according to a photolithography method using a photosensitive resin as a polymer resin. Here, as the photo sensitive resin, a mixture of one or plural kinds of photosensitive resins (photocurable resist material) having a reactive vinyl group such as an acrylic acid resin, a methacrylic acid resin, a polyvinyl cinnamic acid resin, or a hard rubber resin can be used.

A scatterer layer can be directly patterned using a wet process such as an inkjet method, a letterpress printing method, an intaglio printing method, a screen printing method, or a dispenser method; a known dry process such as a resistance heating vapor deposition method using a shadow mask, an electron beam (EB) vapor deposition method, a molecular beam epitaxy (MBE) method, a sputtering method, or an organic vapor phase deposition (OVPD); or a laser transfer method.

A material different from the material of the particles 32, for example, an intermediate layer bonding the particles 32 in contact to each other, may be formed between the non-light emitting particles 32.

As the kind of material constituting the intermediate layer, various kinds of materials can be employed and materials using silicic acid polymerization (Si—O—Si-crosslinking), a phosphate bond (P—O—P—), or a PVA (polyvinyl alcohol) bond can be exemplified.

It is preferable that the particle diameter, the refractive index, and the concentration of the non-light emitting particles 32 constituting the scatterer layer 34 are optimized according to the purpose thereof.

For example, in a case where a scattering profile having an obviously high luminance value with a large viewing angle compared to the luminance value in a direction at a viewing angle of 0° is necessary, since it is necessary to provide wide scattering properties for the forward direction thereof, it is preferable to use particles having a particle diameter which is approximately the same as the wavelength of light.

The average particle diameter of the particles 32 is more preferably in the range of 150 nm to 900 nm. In this manner, the particle diameter of particles is approximately the same as the wavelength of light in the entire visible light region, the light reaching the particles causes Mie scattering in which forward scattering and side scattering are dominant, and the direction of light proceeding in the oblique direction can be changed.

For example, in a case where the non-light emitting particles in a scatterer layer are configured of particles whose particle diameter is exceedingly larger than the wavelength of light, since the spread of emitted light (scattering light) with respect to incident light which is incident on the particles is narrow, that is, extremely high transmission characteristics can be obtained, but the spread of emitted light (scattering light) is narrow as described above, scattering characteristics (viewing angle characteristic) cannot be sufficiently obtained.

Meanwhile, for example, in a case where the non-light emitting particles in the scatterer layer are configured of particles which are exceedingly smaller than the wavelength of light, since the spread of emitted light (scattering light) with respect to incident light which is incident on the particles is extremely large and the ratio of light (back-scattering light) emitted to the opposite side of the incident light becomes greater, scattering characteristics with a wide viewing angle can be obtained, but transmission characteristics cannot be sufficiently obtained.

It is preferable that two or more of the non-light emitting particles constituting the scatterer layer are present in the scatterer layer in the thickness direction. In this manner, the light which is emitted from a light source and incident on the scatterer layer is sufficiently scattered and the scattered light having characteristics of wide light distribution can be extracted to the outside through the substrate.

For example, in a case where the number of particles in the thickness direction is less than two, the light which is emitted from a light source and incident on the scatterer layer is not sufficiently scattered and extracted to the outside through the substrate.

It is preferable that ten or fewer non-light emitting particles constituting the scatterer layer are present in the scatterer layer in the thickness direction. In this manner, the light which is emitted from a light source and incident on the scatterer layer is suitably scattered to the forward direction and the scattered light having characteristics with wide light distribution can be extracted to the outside through the substrate.

For example, in a case where the number of particles in the thickness direction is eleven or more, the light which is emitted from a light source and incident on the scatterer layer is extremely scattered, back-scattering light returning to the light source side becomes dominant, and the ratio of light which can be extracted to the outside becomes decreased.

It is preferable that the non-light emitting particles 32 forming the scatterer layer are configured of at least two kinds of particles 32a and 32b whose average particle diameters are different from each other. Further, in the case where the non-light emitting particles 32 are configured of two kinds of particles 32 which are first particles 32a and second particles 32b whose average particle diameters are different from each other, it is preferable that the relationship between an average particle diameter Da of the first particles and an average particle diameter Db of the second particles is Da≧Db and the relationship between a volume Va of the first particles 32a occupying the scatterer layer 34 and a volume Vb of the second particles 32b formed on the substrate 35 is Va≧Vb.

In general, a scattering intensity parameter determining scattering characteristics is represented by a relationship among a difference between the refractive index of the particles 32 and the refractive index of the environment surrounding the particles; a particle diameter parameter α (α=πD/λ, [D: particle diameter of the particle, λ: wavelength of light]); and a scattering angle θ (angle between incident light incident on the particles and the light scattering after reaching the particles).

Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering does not almost occur on the backside. Further, in a case of “α>>1,” the scattering intensity distribution becomes a diffraction scattering region based on geometrical optics in which forward scattering becomes dominant and scattering almost does not occur on the side and the backside.

That is, with a decrease in the average particle diameter, the scattering characteristics of particles become wide scattering characteristics and transmission characteristics of light become degraded.

For example, it is possible to achieve both of high transmission characteristics and wide scattering characteristics by forming a scatterer substrate such that the first particles 32a having the above-described diffraction scattering characteristics and the second particles 32b having a Mie scattering characteristics satisfy a relationship of “volume of first particles volume of second particles” in the scatterer layer, that is, by configuring the scatterer substrate such that particles having a small average particle diameter which have wide scattering characteristics are added to a scatterer layer, on which particles having a large average particle diameter which have excellent transmission characteristics are formed, in a small amount, to the extent that the transmission characteristics are not degraded by the particles having a small average particle diameter, as a scattering assist material. In a case where the relationship between the volumes of the above-described two kinds of particles is reversed, that is, the volume of the first particles is smaller than the volume of the second particles, back-scattering components of the second particles become excessive and, as a result, transmission characteristics cannot be sufficiently obtained.

It is more preferable that the volume ratio of the first particles 32a to the scatterer layer 34 is in a relationship of “Va≧10 vol %.” When the concentration becomes lower than 10 vol %, scattering characteristics cannot be sufficiently obtained.

It is more preferable that the volume ratio of the second particles to the scatterer layer is in a relationship of “0.5 vol %≦Vb≦5 vol %.” When the concentration becomes lower than 0.5 vol %, scattering characteristics cannot be sufficiently obtained. Meanwhile, when the concentration becomes higher than 0.5 vol %, transmission characteristics cannot be sufficiently obtained.

It is more preferable that the film thickness of the scatterer layer 34 is 10 μm or greater. When the film thickness becomes thinner than 10 μm, components passing through gaps among the non-light emitting particles 32 and transmitted to the outside without being scattered become significant and, as a result, scattering characteristics cannot be sufficiently obtained.

The action and the effect of the light emitting device 40 will be described with reference to FIG. 4.

In the light emitting device 30, in a case where light is incident on the scatterer layer 34 from the outside, most light is incident on the non-light emitting particles 32 through the gaps 33 and becomes scattering light. In the scattering light, a component proceeding to the substrate 35 side, a component proceeding to the light source 31 side, and a component incident on other non-light emitting particles 32 again through the gaps 33 are present. Here, refractive index interfaces due to refractive index differences of respective layers are present between the scatterer layer 34 and the substrate 35 and between the substrate 35 and the outside.

In the present embodiment, since the refractive index of the gap 33 constituting the scatterer layer 34 is around 1.0, the substrate 35 is interposed between the gap 33 having a refractive index of around 1.0 and the outside having a refractive index of around 1.0. In such a configuration, since scattering light proceeding to the substrate 35 side among scattering light scattered by the non-light emitting particles 32 is incident on the substrate 35 after passing through the gap 33 having a refractive index of around 1.0, the scattering light incident on the substrate 35 is not totally reflected on the interface between the substrate 35 and the outside and most of the scattering light can be extracted to the outside. Accordingly, the light emitting device 30 with excellent light extraction efficiency can be realized.

### (2) Second Embodiment

FIG. 5 is a sectional view schematically illustrating a second embodiment of a light emitting device according to the present invention. In FIG. 5, constituent elements which are the same as those of the light emitting device 30 illustrated in FIG. 4 will not be described.

A light emitting device 50 includes a light source 31 which emits light; a substrate 35 which is disposed so as to face the light source 31; and a scatterer layer 34 which is disposed on one surface 35a of the substrate 35. The scatterer layer 34 is configured of non-light emitting particles 32 which change the traveling direction of light emitted from the light source 31 and gaps 33 which are formed between the particles 32 and the one surface of the substrate 35. In addition, light-reflective partition walls 41 are formed on at least one side surface of the scatterer layer 34 along the lamination direction of the substrate 35.

As the light-reflective partition wall 41, a structure in which reflective metal powder such as Al, Ag, Au, Cr, or an alloy thereof or a reflective resin film formed of a resin containing metal particles are formed can be exemplified, but the present embodiment is not limited thereto.

Further, the partition wall 41 may have light scattering properties in at least a portion in contact with the scatterer layer 34. As a material forming the partition wall 41 (hereinafter, also referred to as a “partition wall material”) or a material forming the light scattering layer (light scattering film) provided on the side surface of the partition wall 41 (hereinafter, also referred to as a “light scattering film material”), a material containing a resin and light scattering particles is used.

As a resin of the partition wall 41, for example, an acrylic resin (refractive index: 1.49), a melamine resin (refractive index: 1.57), nylon (refractive index: 1.53), polystyrene (refractive index: 1.60), melamine beads (refractive index: 1.57), polycarbonate (refractive index: 1.57), polyvinyl chloride (refractive index: 1.60), polyvinylidene chloride (refractive index: 1.61), polyvinyl acetate (refractive index: 1.46), polyethylene (refractive index: 1.53), polymethyl methacrylate (refractive index: 1.49), polyMBS (refractive index: 1.54), medium density polyethylene (refractive index: 1.53), high density polyethylene (refractive index: 1.54), tetrafluoroethylene (refractive index: 1.35), polyethylene chloride trifluoride (refractive index: 1.42), and polytetrafluoroethylene (refractive index: 1.35) are used, but the present embodiment is not limited to these resins.

The light scattering particles of the partition wall 41 may be an inorganic material or an organic material.

In the case of using an inorganic material as the light scattering particles, examples thereof include particles (microparticles) containing at least one kind of metal oxide selected from the group consisting of silicon, titanium, zirconium, aluminum, indium, zinc, tin, and antimony as a main component, but the present embodiment is not limited to these inorganic materials.

In addition, in a case where particles (inorganic microparticles) formed of an inorganic material are used as the light scattering particles, examples thereof include silica beads (refractive index: 1.44), alumina beads (refractive index: 1.63), titanium oxide beads (refractive index of anatase type: 2.50 and refractive index of rutile type: 2.70), zirconia oxide beads (refractive index: 2.05), zinc oxide beads (refractive index: 2.00), and barium titanate (BaTiO₃) (refractive index: 2.4), but the present embodiment is not limited to these inorganic microparticles.

In a case where particles (organic microparticles) formed of an organic material are used as the light scattering particles, examples thereof include polymethylmethacrylate beads (refractive index: 1.49), acryl beads (refractive index: 1.50), acryl-styrene copolymer beads (refractive index: 1.54), melamine beads (refractive index: 1.57), high refractive index melamine beads (refractive index: 1.65), polycarbonate beads (refractive index: 1.57), styrene beads (refractive index: 1.60), crosslinked polystyrene beads (refractive index: 1.61), polyvinyl chloride beads (refractive index: 1.60), benzoguanamine-melamine formaldehyde beads (refractive index: 1.68), and silicone beads (refractive index: 1.50), and the present embodiment is not limited to these organic microparticles.

The partition wall material and the light scattering film material may include a defoaming agent or a leveling agent such as a photopolymerization initiator, a dipropylene glycol monomethyl ether, or 1-(2-methoxy-2-methylethoxy)-2-propanol.

Further, the color of the partition wall 41 may be white. Specifically, the partition wall material and the light scattering film material may contain a white resist.

Examples of the white resist include a material containing a carboxyl group-containing resin without an aromatic ring, a photopolymerization initiator, a hydrogenated epoxy compound, rutile type titanium oxide, and a diluent.

The partition wall material and the light scattering film material can be made into a photoresist by selecting an alkali-soluble resin as a resin constituting the partition wall material and adding a photopolymerization monomer, a photopolymerization initiator, and a solvent and thus a light scattering layer provided on the partition wall 41 or the side surface of the partition wall 41 can be patterned according to a photolithography method.

The light emission in the light emitting device 50 will be described with reference to FIG. 5.

In the light emitting device 40, in a case where light is incident on the scatterer layer 34 from the outside, most light is incident on the non-light emitting particles 32 through the gaps 33 and becomes scattering light. In the scattering light, a component proceeding to the substrate 35 side, a component proceeding to the light source 31 side, and a component incident on other non-light emitting particles 32 again through the gaps 33 are present. Here, refractive index interfaces due to refractive index differences of respective layers are present between the scatterer layer 34 and the substrate 35 and between the substrate 35 and the outside. In the present embodiment, since the refractive index of the gap 33 constituting the scatterer layer 34 is around 1.0, the substrate 35 is interposed between the gap 33 having a refractive index of around 1.0 and the outside having a refractive index of around 1.0.

In such a configuration, since scattering light proceeding to the substrate 35 side among scattering light scattered by the non-light emitting particles 32 is incident on the substrate 35 after passing through the gap 33 having a refractive index of around 1.0, the scattering light incident on the substrate 35 is not totally reflected on the interface between the substrate 35 and the outside and most of the scattering light can be extracted to the outside. In addition, in the present configuration, since the light-reflective partition wall 41 is provided on the side surface of the scatterer layer 34, scattering light incident on a side surface portion of the scatterer layer 34 among scattering light scattering in the scatterer layer 34 is reflected on the side surface of the light-reflective partition wall 41 and can be recycled to a component which can be extracted to the substrate 35 side.

That is, the scattering light scattering in the scatterer layer 34 can be efficiently extracted to the outside by providing the partition wall 41 having light reflectivity on the side surface of the scatterer layer 34. In addition, in a case where a portion in contact with the scatterer layer 34 of the partition wall 41 has light scattering properties, for example, in a case where a scattering light component reflected on the substrate due to Fresnel loss generated by a difference between refractive indices of the substrate and the outside is reflected on the partition wall 41 and is incident on the substrate again, first, since the scattering light component which is Fresnel-reflected on the substrate 35 and incident on the partition wall 41 is reflected (scattered) on the partition wall 41 at an angle different from the incident angle and incident on the substrate at an angle different from the first incident angle, there is a possibility that Fresnel loss generated when light is incident on the substrate 35 again can be reduced and thus the ratio of the scattering light component which can be extracted to the outside can be increased. That is, when the partition wall 41 having light scattering properties is provided on the side surface of the scattering layer 34, the scattering light scattering in the scatterer layer 34 can be further efficiently extracted to the outside.

### (3) Third Embodiment

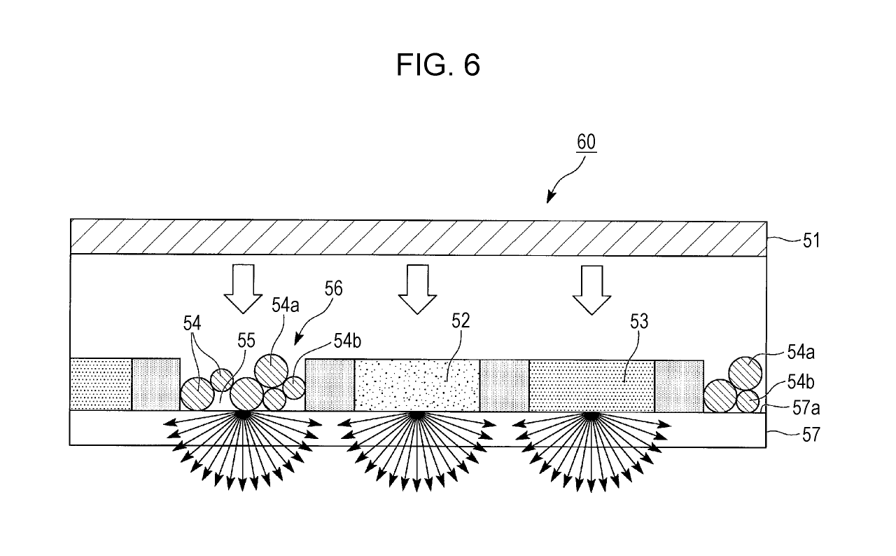

FIG. 6 is a sectional view schematically illustrating a light emitting device according to a third embodiment. A light emitting device 60 is configured of an excitation light source 51 which emits excitation light; a first phosphor layer 52 which is disposed so as to face the excitation light source 51, is excited by the excitation light, and emits fluorescence; a second phosphor layer 53; non-light emitting particles 54 which are provided between the first phosphor layer 52 and the second phosphor layer 53 and change the traveling direction of light emitted from the excitation light source 51; and a substrate 57 on which a scatterer layer 56 formed of gaps 55 which are formed between the particles 51 and one surface 57a of the substrate 57 is formed.

In the present embodiment, it is preferable that the particles 54 are configured of two kinds of particles 54a and 54b whose particle diameters are different from each other.

As the light source 51 that excites a phosphor, light sources emitting ultraviolet light and blue light are used. Examples of such light sources include light emitting elements such as an ultraviolet light emitting diode (hereinafter, also referred to as an “ultraviolet LED”), a blue light emitting diode (hereinafter, also referred to as a “blue LED”), an ultraviolet light emitting inorganic electroluminescence element (hereinafter, also referred to as an “ultraviolet light emitting inorganic EL element”), a blue light emitting inorganic electroluminescence element (hereinafter, also referred to as a “blue light emitting inorganic EL element”), an ultraviolet light emitting organic electroluminescence element (hereinafter, also referred to as an “ultraviolet light emitting organic EL element”), and a blue light emitting organic electroluminescence element (hereinafter, also referred to as a “blue light emitting organic EL element”). The above-described light emitting elements can be exemplified as the light sources 11, but the light sources are not limited thereto.

In addition, since an image is displayed by directly switching the light source 51, ON and OFF of light emission can be controlled, but a layer having a shutter function such as a liquid crystal is arranged between the light source 51, and the phosphor layers 52, 53, and scatterer layer 56 and ON and OFF of light emission can be controlled by controlling the layer. Further, ON and OFF of a layer having a shutter function such as a liquid crystal and an excitation light source 11 can be also controlled.

The phosphor layers 52 and 53 are configured of a red phosphor layer, a green phosphor layer, and a blue phosphor layer that absorbs excitation light from light emitting elements such as an ultraviolet LED, a blue LED, an ultraviolet light emitting inorganic EL element, and a blue light emitting inorganic EL element and respectively emit red light, green light, and blue light.

The red phosphor layer, the green phosphor layer, and the blue phosphor layer are formed of thin films having a rectangular shape when seen in a plan view.

Further, if necessary, it is preferable that phosphors emitting cyan light and yellow light are added to respective pixels constituting the phosphor layer 13. Here, the color reproduction range of the pixels can be further widened than that of a display device using pixels emitting light of three primary colors of red, green, and blue by adjusting color purity of respective pixels that emit cyan light and yellow light to be outside of a triangle which is to be bonded by a point of color purity of the pixels emitting red light, green light, and blue light on a chromaticity diagram.

The phosphor layers 52 and 53 may be configured of only phosphor materials exemplified below, may arbitrarily contain an additive or the like, or may have a configuration in which these materials are dispersed in a polymer material (binder resin) or an inorganic material.

As the phosphor material constituting the phosphor layers 52 and 53, a known phosphor material can be used. Such a phosphor material can be classified into an organic phosphor material and an inorganic phosphor material.

Specific examples of those compounds will be described below, but the present embodiment is not limited to the materials.

Examples of the organic phosphor material include blue fluorescent dyes that convert ultraviolet excitation light into blue emitted light, for example, stilbenzene-based dyes such as 1,4-bis(2-methylstylyl)benzene, and trans-4,4′-diphenylstilbenzene; coumarin-based dyes such as 7-hydroxy-4-methylcoumarin, ethyl 2,3,6,7-tetrahydro-11-oxo-1H,5H,11H-[1]benzopyrano[6,7,8-ij]quinolizine-10-carboxylate (coumarin 314), and 10-acetyl-2,3,6,7-tetrahydro-1H,5H,11H-[1]benzopyrano[6,7,8-ij]quinolizine-11-one (coumarin 334); and anthracene-based dyes such as 9,10 bis(phenylethynyl)anthracene, and perylene.

Examples of the organic phosphor material include green fluorescent dyes that convert excitation light of violet and blue into green emitted light, for example, coumarine-based dyes such as 2,3,5,6-1H,4H-tetrahydro-8-trifluomethylquinolizine(9,9a,1-gh)coumarine (coumarine 153), 3-(2′-benzothiazolyl)-7-diethylaminocoumarine (coumarine 6), 3-(2′-benzoimidazolyl)-7-N,N-diethylaminocoumarine (coumarine 7), 10-(benzothiazole-2-yl)-2,3,6,7-tetrahydro-1H,5H,11H-[1]benzopyrazo[6,7,8-ij]quinolizine-11-one (coumarine 545), coumarine 545, and coumarine 545P; naphthalimide-based dyes such as Basic Yellow 51, Solvent Yellow 11, Solvent Yellow 98, Solvent Yellow 116, Solvent Yellow 43, and Solvent Yellow 44; and Perylene-based dyes such as Lumogen Yellow, Lumogen Green, Solvent Green 5, a fluorescein-based dye, an azo-based dye, a phthalocyanine-based dye, an anthraquinone-based dye, a quinacridone-based dye, an isoindolinone-based dye, a thioindigo-based dye, and a dioxazine-based dye.

Examples of the organic phosphor material include red fluorescent dyes that convert ultraviolet and blue excitation light into red emitted light, for example, cyanine-based dyes such as 4-dicyanomethylene-2-methyl-6-(p-dimethylaminostylyl)-4H-pyrazo; pyridine-based dyes such as 1-ethyl-2-[4-(p-dimethylaminophenyl)-1,3-butadienyl]-pyridinium perchlorate (pyridine 1); xanthene dyes such as Rhodamine B, Rhodamine 6G, Rhodamine 3B, Rhodamine 101, Rhodamine 110, Basic Violet 11, Sulforhodamine 101, Basic Violet 11, and Basic Red 2; and Perylene-based dyes such as Lumogen Orange, Lumogen Pink, Lumogen Red, Solvent Orange 55, an oxazine-based dye, a chrysene-based dye, a thioflavin-based dye, a pyrene-based dye, an anthracene-based dye, an acridone-based dye, an acridine-based dye, a fluorene-based dye, a terphenyl-based dye, an ethene-based dye, a butadiene-based dye, a hexatriene-based dye, an oxazole-based dye, a coumarine-based dye, a stilbene-based dye, a di- and triphenylmethane-based dye, a thiazole-based dye, a thiazine-based dye, a naphthalimide-based dye, and an anthraquinone-based dye.

In a case where organic phosphor materials are used as respective colors of phosphors, it is desired to use dyes which are unlikely to be deteriorated by blue light, ultraviolet light, or external light of backlight. From this viewpoint, it is particularly preferable to use a perylene-based dye having excellent light resistance and a high quantum yield.

Examples of the inorganic phosphor material include blue phosphors that convert ultraviolet excitation light into blue emitted light such as Sr₂P₂O₇:Sn⁴⁺, Sr₄Al₁₄O₂₅:Eu²⁺, BaMgAl₁₀O₁₇:Eu²⁺, SrGa₂S₄:Ce³⁺, CaGa₂S₄:Ce³⁺, (Ba,Sr)(Mg,Mn)Al₁₀O₁₇:Eu²⁺, (Sr,Ca,Ba₂,Omg)₁₀(PO₄)₆Cl₂:Eu²⁺, BaAl₂SiO₈:Eu²⁺, Sr₂P₂O₇:Eu²⁺, Sr₅(PO₄)₃Cl:Eu²⁺, (Sr,Ca,Ba)₅(PO₄)₃Cl:Eu²⁺, BaMg₂Al₁₆O₂₇:Eu²⁺, (Ba,Ca)₅(PO₄)₃Cl:Eu²⁺, Ba₃MgSi₂O₈:Eu²⁺, and Sr₃MgSi₂O₈:Eu²⁺.

Examples of the inorganic phosphor material include green phosphors that convert ultraviolet and blue excitation light into green emitted light such as (BaMg)Al₁₆O₂₇:Eu²⁺, Mn²⁺, Sr₄Al₁₄O₂₅:Eu²⁺, (SrBa) Al₁₂Si₂O₈:Eu²⁺, (BaMg)₂SiO₄:Eu²⁺, Y₂SiO₅:Ce³⁺, Tb³⁺, Sr₂P₂O₇—Sr₂B₂O₅:Eu²⁺, (BaCaMg)₅(PO₄)₃Cl:Eu²⁺, Sr₂Si₃O₈—₂SrCl₂:Eu²⁺, Zr₂SiO₄, MgAl₁₁O₁₉:Ce³⁺, Tb³⁺, Ba₂SiO₄:Eu²⁺, Sr₂SiO₄:Eu²⁺, and (BaSr)SiO₄:Eu2⁺.

Examples of the inorganic phosphor material include red phosphors that convert ultraviolet and blue excitation light into red emitted light such as Y₂O₂S:Eu³⁺, YAlO₃:Eu³⁺, Ca₂Y₂ (SiO₄)₆:Eu³⁺, LiY₉ (SiO₄)₆O₂:Eu³⁺, YVO₄:Eu³⁺, CaS:Eu³⁺, Gd₂O₃:Eu³⁺, Gd₂O₂S:Eu³⁺, Y(P,V)O₄:Eu³⁺, Mg₄GeO_{5.5}F:Mn⁴⁺, Mg₄GeO₆:Mn⁴⁺, K₅Eu_{2.5}(WO₄)_{6.25}, Na₅Eu_{2.5}(WO₄)_{6.25}, K₅Eu_{2.5}(MoO₄)_{6.25}, and Na₅Eu_{2.5} (MoO₄)_{6.25}.

In addition, the inorganic phosphor material may be subjected to a surface modification treatment if necessary.

As a method of the surface modification treatment, a method of carrying out a chemical treatment such as a silane coupling agent, a method of carrying out a physical treatment by adding microparticles or the like of submicron order, and a method of combining these method can be used.

Further, in consideration of deterioration due to excitation light and stability of deterioration or the like due to light emission, it is preferable to use an inorganic phosphor material.

In the case of using an inorganic phosphor material, it is preferable that an average particle diameter (d₅₀) is in the range of 0.5 μm to 50 μm. When the average particle diameter of the inorganic phosphor material is less than 0.5 μm, light emission efficiency of a phosphor is drastically decreased. Further, when the average particle diameter of the inorganic phosphor material exceeds 50 μm, formation of a planarizing film becomes extremely difficult, gaps are formed between the excitation light source 51 and the phosphor layers 52 and 53 (gaps (refractive index: 1.0) between the excitation light source 51 and the phosphor layers 52 and 53 (refractive index: approximately 2.3)), and thus a problem in that light emission efficiency of the phosphor layers 52 and 53 is decreased without light from the excitation light source 51 efficiently reaching the phosphor layers 52 and 53 is generated. Further, a problem in that planarizing of the phosphor layers 52 and 53 is difficult and formation of a liquid crystal layer becomes impossible (since the distance between electrodes interposing the liquid crystal layer becomes nonuniform and an electrical field is not uniformly applied or since the liquid crystal layer is not uniformly operated) is generated.

Examples of the method of forming the phosphor layers 52 and 53 include a coating method such as a spin coating method, a dipping method, a doctor blade method, an ejection coating method, or a spray coating method; a known wet process using a printing method such as an inkjet method, a letterpress printing method, an intaglio printing method, a screen printing method, or a micro gravure coating method; a known dry process such as a resistance heating vapor deposition method, an electron beam (EB) vapor deposition method, a molecular beam epitaxy (MBE) method, a sputtering method, or an organic vapor phase deposition (OVPD); and a forming method such as a laser transfer method.

Further, the phosphor layers 52 and 53 can be patterned according to a photolithography method using a photosensitive resin as a polymer resin. Here, as the photo sensitive resin, a mixture of one or plural kinds of photosensitive resins (photocurable resist material) having a reactive vinyl group such as an acrylic acid resin, a methacrylic acid resin, a polyvinyl cinnamic acid resin, or a hard rubber resin can be used.

A phosphor material can be directly patterned using a wet process such as an inkjet method, a letterpress printing method, an intaglio printing method, a screen printing method, or a dispenser method; a known dry process such as a resistance heating vapor deposition method using a shadow mask, an electron beam (EB) vapor deposition method, a molecular beam epitaxy (MBE) method, a sputtering method, or an organic vapor phase deposition (OVPD); or a laser transfer method.

As the binder resin material, a transparent resin is preferable. In addition, examples of the resin material include an acrylic resin, a melamine resin, a polyester resin, a polyurethane resin, an alkyd resin, an epoxy resin, a butyral resin, a polysilicon resin, a polyamide resin, a polyimide resin, a melamine resin, a phenol resin, polyvinyl alcohol, polyvinyl hydrin, hydroxy ethyl cellulose, carboxy methyl cellulose, an aromatic sulfone amide resin, a urea resin, a benzoguanamine resin, triacetyl cellulose (TAC), polyether sulfone, polyether ketone, nylon, polystyrene, melamine beads, polycarbonate, polyvinyl chloride, polyvinylidene chloride, polyvinyl acetate, polyethylene, polymethyl methacrylate, polyMBS, medium density polyethylene, high density polyethylene, tetrafluoroethylene, polyethylene chloride trifluoride, and polytetrafluoroethylene.

The film thickness of the phosphor layers 52 and 53 is generally in the range of about 100 nm to 100 μm and preferably in the range of 1 μm to 100 μm. When the film thickness is less than 100 nm, since light emitted from the excitation light source 51 cannot be sufficiently absorbed, a problem in that light emission efficiency is decreased and color purity is degraded by blue transmitted light being mixed to a required color is generated. In addition, in order to increase the absorption of light emitted from the excitation light source 11 and to decrease blue transmitted light to the extent of not adversely affecting the color purity, the film thickness is preferably 1 μm or greater. In addition, when the film thickness is greater than 100 μm, since the blue light emitted from the excitation light source 11 is sufficiently absorbed already, the efficiency is not increased, the material is only consumed, and this leads to an increase in the material cost.

Since it is necessary for light emitted from the phosphor layers 52 and 53 to be extracted to the outside, the substrate 57 is required to transmit the emitted light in a light emitting region of a phosphor and examples of the substrate include an inorganic material substrate formed of glass and quartz and a plastic substrate formed of polyethylene terephthalate, polycarbazole, and polyimide. However, the present embodiment is not limited thereto.

In addition, from a viewpoint that a curved portion or a bent portion can be formed without generating stress, it is preferable to use a plastic substrate as the substrate. Further, from a viewpoint of capability of improving gas barrier properties, a substrate formed by coating a plastic substrate with an inorganic material is more preferable. In this manner, it is possible to resolve deterioration of an organic EL element due to transmission of moisture (it is known that an organic EL element is deteriorated even due to a small amount of moisture) which is the biggest problem in a case where a plastic substrate is used as a substrate of an organic EL element.

Light emission of the light emitting device 60 will be described below with reference to FIG. 6.

In the light emitting device 50, when excitation light is respectively incident on the first phosphor layer 52 and the second phosphor layer 53 from the excitation light source 51, light with isotropic energy, that is, energy equivalent with respect to all directions, is radiated from a phosphor. Meanwhile, as described above in regard to the scatterer layer 56, in a case where the excitation light 51 is incident to the scatterer layer 56, most light is incident to the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer layer 56 and the substrate 57 and between the substrate 57 and the outside. In the present embodiment, since the refractive index of the gap 33 constituting the scatterer layer 56 is around 1.0, the substrate 57 is interposed between the gap 33 having a refractive index of around 1.0 and the outside having a refractive index of around 1.0.

In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside. For example, in a case where scattering light proceeding to the substrate 57 is totally reflected on the interface between the substrate 57 and the outside, there is a possibility that the scattering light which is totally reflected is incident on the phosphor layers 52 and 53 adjacent to each other, and a phosphor in the phosphor layers 52 and 53 is excited by the scattering light (excitation light) and emits light. In such a case, there is a problem in that light emitted from each layer is mixed so that the display quality is degraded. Further, in a case of the present configuration, it is important for a light distribution profile of scattering light to be extracted to the outside from the scatterer layer 56 to match a light distribution profile of a phosphor to be extracted to the outside from the phosphor layers 52 and 53.

In the scatterer layer 56 in the present embodiment, the scattering light which is scattered by the non-light emitting particles 54 and proceeds to the direction of the substrate 57 is incident on the substrate 57 through the gap 55 having a refractive index of around 1.0 and is extracted to the outside having a refractive index of around 1.0. That is, a light distribution profile of scattering light scattered by the non-light emitting particles is extracted to the outside without changing the shape thereof. Accordingly, a different light distribution profile can be allowed to match the above-described light distribution profile by adjusting a scattering intensity parameter determining scattering characteristics to correspond to the light distribution profile of fluorescence to be extracted to the outside from the phosphor layers 52 and 53. As a result, a light emitting device whose color is not changed even when viewed from any direction can be obtained.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

### (4) Fourth Embodiment

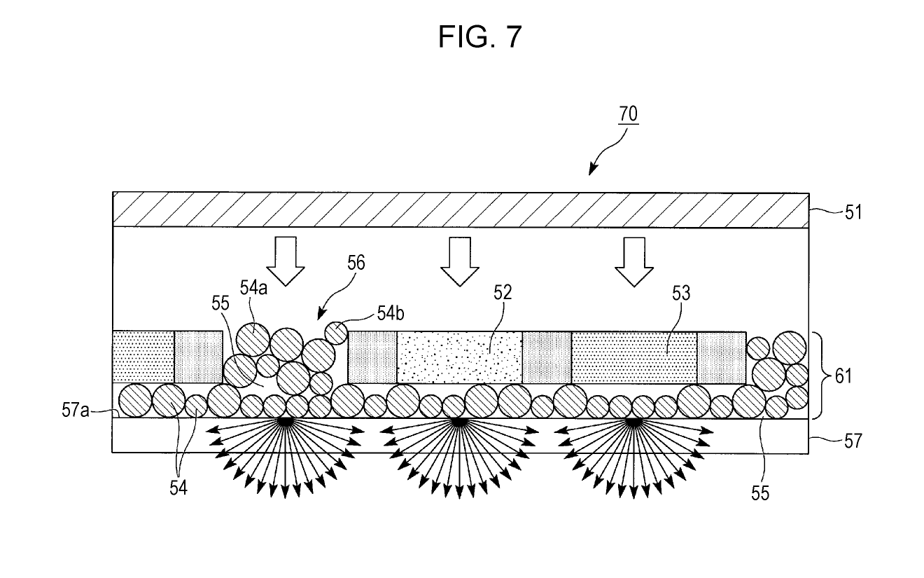

FIG. 7 is a sectional view schematically illustrating a light emitting device according to a fifth embodiment. In FIG. 7, constituent elements which are the same as those of a light emitting device 60 illustrated in FIG. 6 are denoted by the same reference numerals and the description thereof will not be repeated. A light emitting device 70 is configured of an excitation light source 51 which emits excitation light; a first phosphor layer 52 which is disposed so as to face the excitation light source 51, is excited by the excitation light, and emits fluorescence; a second phosphor layer 53; non-light emitting particles 54 which are provided between the first phosphor layer 52 and the second phosphor layer 53, formed so as to expand on the phosphor layers 52 and 53, and change the traveling direction of light emitted from the excitation light source 51; and a substrate 57 on which a scatterer film 61 formed of gaps 55 which are formed between the particles 54 and one surface 57 of the substrate 57 is formed.

Light emission of the light emitting device 70 will be described below with reference to FIG. 7.

In the light emitting device 70, when excitation light is respectively incident on the first phosphor layer 52 and the second phosphor layer 53 from the excitation light source 51, light with isotropic energy, that is, energy equivalent with respect to all directions is radiated from a phosphor in the phosphor layers 52 and 53. Meanwhile, as described above in regard to the scatterer film 61, in a case where the excitation light 51 is incident on the scatterer film 61, most light is incident on the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer film 61 and the substrate 57 and between the substrate 57 and the outside.

In the present embodiment, since the refractive index of the gap 33 constituting the scatterer film 61 is around 1.0, the substrate 57 is interposed between the gap 33 having a refractive index of around 1.0 and the outside having a refractive index of around 1.0. In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside. For example, in a case where scattering light proceeding to the substrate 57 is totally reflected on the interface between the substrate 57 and the outside, there is a possibility that the scattering light which is totally reflected is incident on the phosphor layers 52 and 53 adjacent to each other, and a phosphor in the phosphor layers 52 and 53 is excited by the scattering light (excitation light) and emits light. In such a case, there is a problem in that light emitted from each layer is mixed so that the display quality is degraded.

Further, in a case of the present configuration, it is important for a light distribution profile of scattering light to be extracted to the outside from the scatterer layer 56 to match a light distribution profile of a phosphor to be extracted to the outside from the phosphor layers 52 and 53. In the scatterer layer 61 in the present embodiment, the scattering light which is scattered by the non-light emitting particles 54 and proceeds to the direction of the substrate 57 is incident on the substrate 57 through the gap 55 having a refractive index of around 1.0 and is extracted to the outside having a refractive index of around 1.0. That is, a light distribution profile of scattering light scattered by the non-light emitting particles is extracted to the outside without changing the shape thereof. Accordingly, a different light distribution profile can be allowed to match the above-described light distribution profile by adjusting a scattering intensity parameter determining scattering characteristics to correspond to the light distribution profile of fluorescence to be extracted to the outside from the phosphor layers 52 and 53. As a result, a light emitting device whose color is not changed even when viewed from any direction can be obtained.

In such a configuration, since the scatterer film 61 is formed between the phosphor layers 52 and 53 and the substrate 57, and the fluorescent component incident on the scatterer film 61 among fluorescent components emitted from the phosphor layers 52 and 53 is incident on the substrate 57 after passing through the gap 55 having a refractive index of around 1.0, the fluorescence incident on the substrate 57 is not totally reflected on the interface between the substrate 57 and the outside and most of the fluorescence can be extracted to the outside. For example, in a case where fluorescence proceeding to the substrate 57 is totally reflected on the interface between the substrate 57 and the outside, there is a possibility that the fluorescence which is totally reflected is incident on the phosphor layers adjacent to each other, and a phosphor in the phosphor layers is excited by the fluorescence and emits light or a possibility that fluorescence which is totally reflected is incident on the scatterer layers adjacent to each other, back-scattered by the non-light emitting particles in the scatterer layers, and extracted to the outside through the substrate 57 from the scatterer layer. In such a case, there is a problem in that light emitted from each layer is mixed so that the display quality is degraded.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

### (5) Fifth Embodiment

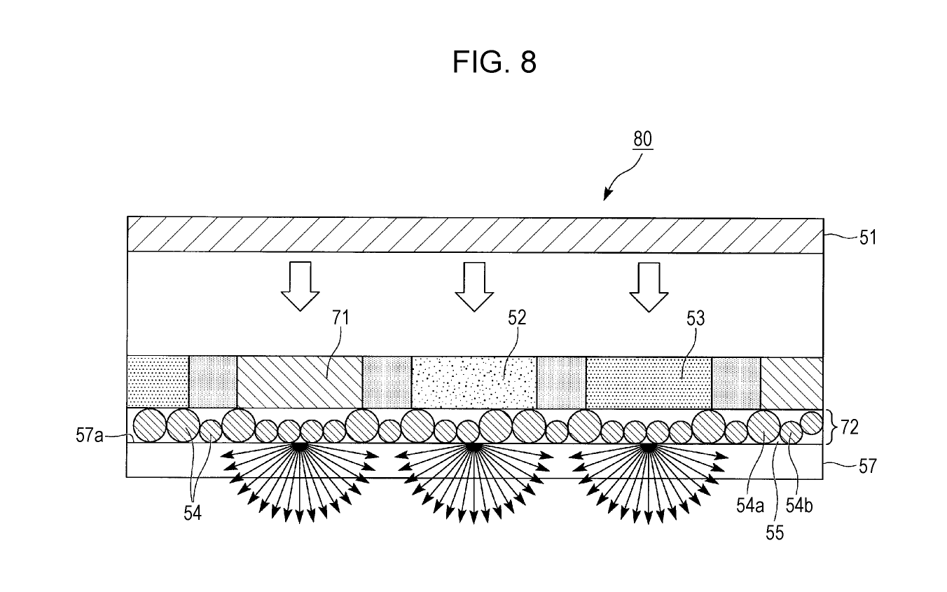

FIG. 8 is a sectional view schematically illustrating a light emitting device according to a fifth embodiment. In FIG. 8, constituent elements which are the same as the light emitting device 60 illustrated in FIG. 6 are denoted by the same reference numerals and the description thereof will not be repeated. A light emitting device 80 is configured of an excitation light source 51 which emits excitation light; a first phosphor layer 52 which is disposed so as to face the excitation light source, is excited by the excitation light, and emits fluorescence; a second phosphor layer 53; a third phosphor layer 71; non-light emitting particles 54 which are formed so as to expand on the phosphor layers 52, 53, and 71, and change the traveling direction of light emitted from the excitation light source 51; and a substrate 57 on which a scatterer film 72 formed of gaps 55 which are formed between the particles 54 and one surface 57a of the substrate 57 is formed.

Light emission of the light emitting device 80 will be described below with reference to FIG. 8.

In the light emitting device 70, when excitation light is respectively incident on the first phosphor layer 52, the second phosphor layer 53, and the third phosphor layer 71 from the excitation light source 51, light with isotropic energy, that is, energy equivalent with respect to all directions is radiated from a phosphor in the phosphor layers 52, 53, and 71.

However, the light distribution profile of fluorescence to be extracted to the outside from a phosphor layer varies depending on the kind of phosphor in most cases. For example, in a case where the refractive index of a phosphor material or a resin material constituting a phosphor layer varies for each phosphor layer, the refraction angle in which the fluorescence to be extracted to the outside is refracted on the interface between the phosphor layer and the outside varies depending on the phosphor layer. That is, the light distribution profile of fluorescence to be extracted to the outside varies for each phosphor layer. In addition, for example, in a case where the phosphor layer is configured of an inorganic phosphor material, the light emitting characteristics vary due to the particles or the shape of the phosphor particles.

That is, the light distribution profile to be extracted outside varies for each phosphor layer. However, a part of the fluorescent component proceeding to the direction of the substrate 57 in fluorescence emitted by the phosphor layers 52 and 53 is incident on the scatterer film 72. Most light of the fluorescent component incident on the scatterer film 72 is incident on the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer film 72 and the substrate 57 and between the substrate 57 and the outside. In the present embodiment, since the refractive index of the gap 33 constituting the scatterer film 72 is around 1.0, the substrate 57 is interposed between the gap 33 having a refractive index of around 1.0 and the outside having a refractive index of around 1.0.

In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside. In a case where a scatterer film having the present configuration is not present between the phosphor layer and the substrate, since a phosphor in a phosphor layer is generally melted or dispersed in a resin having a refractive index of 1.0 or greater, a part of the fluorescent component incident on the substrate from the phosphor layer is totally reflected on the refractive index interface between the substrate and the outside. In such as case, there is a possibility that the fluorescence which is totally reflected is incident on the phosphor layers adjacent to each other and a phosphor in the phosphor layers is excited by the fluorescence. In such a case, there is a problem in that light emitted from each layer is mixed so that the display quality is degraded.

Further, in the present configuration, when a fluorescent component having a different light distribution profile is include on the scatterer layer 56 and scattered by non-light emitting particles in the scatterer layer 56, it is possible for a light distribution profile of a fluorescent component to be extracted to the outside to match the light distribution profile described above. As a result, a light emitting device whose color is not changed even when viewed from any direction can be obtained.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

### (6) Sixth Embodiment

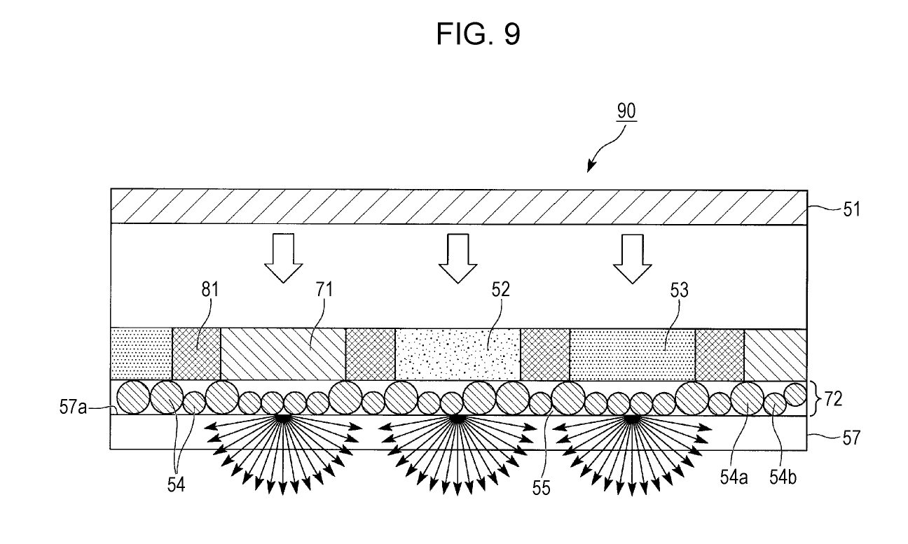

FIG. 9 is a sectional view schematically illustrating a light emitting device according to a sixth embodiment. In FIG. 9, constituent elements which are the same as the light emitting device 60 illustrated in FIG. 6 are denoted by the same reference numerals and the description thereof will not be repeated. A light emitting device 90 is configured of an excitation light source 51 which emits excitation light; a first phosphor layer 52 which is disposed so as to face the excitation light source, is excited by the excitation light, and emits fluorescence; a second phosphor layer 53; a third phosphor layer 71; non-light emitting particles 54 which are formed so as to expand on the phosphor layers 52, 53, and 71, and change the traveling direction of light emitted from the excitation light source 51; a substrate 57 on which a scatterer film 72 formed of gaps 55 which are formed between the particles 54 and one surface 57 of the substrate 57 is formed; and a light-reflective partition wall 81 formed on at least one side surface of the phosphor layers 52, 53, and 71 along the lamination direction with the substrate 57.

Light emission of the light emitting device 90 will be described below with reference to FIG. 9.

In the light emitting device 90, when excitation light is respectively incident on the first phosphor layer 52, the second phosphor layer 53, and the third phosphor layer 71 from the excitation light source 51, light with isotropic energy, that is, energy equivalent with respect to all directions is radiated from a phosphor in the phosphor layers 52, 53, and 71.

However, the light distribution profile of fluorescence to be extracted to the outside from a phosphor layer varies depending on the kind of phosphor in most cases. For example, in a case where the refractive index of a phosphor material or a resin material constituting a phosphor layer varies for each phosphor layer, the refraction angle in which the fluorescence to be extracted to the outside is refracted on the interface between the phosphor layer and the outside varies depending on the phosphor layer. That is, the light distribution profile of fluorescence to be extracted to the outside varies for each phosphor layer. In addition, for example, in a case where the phosphor layer is configured of an inorganic phosphor material, the light emitting characteristics vary due to the particles or the shape of the phosphor particles.

That is, the light distribution profile to be extracted outside varies for each phosphor layer. However, a part of the fluorescent component proceeding to the direction of the substrate 57 in fluorescence emitted by the phosphor layers 52 and 53 is incident on the scatterer film 72. Most light of the fluorescent component incident on the scatterer film 72 is incident on the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer film 72 and the substrate 57 and between the substrate 57 and the outside.

In the present embodiment, since the refractive index of the gap 33 constituting the scatterer film 72 is around 1.0, the substrate 57 is interposed between the gap 33 having a refractive index of around 1.0 and the outside having a refractive index of around 1.0. In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside. In a case where a scatterer film having the present configuration is not present between the phosphor layer and the substrate, since a phosphor in a phosphor layer is generally melted or dispersed in a resin having a refractive index of 1.0 or greater, a part of the fluorescent component incident on the substrate from the phosphor layer is totally reflected on the refractive index interface between the substrate and the outside. In such as case, there is a possibility that the fluorescence which is totally reflected is incident on the phosphor layers adjacent to each other and a phosphor in the phosphor layers is excited by the fluorescence. In such a case, there is a problem in that light emitted from each layer is mixed so that the display quality is degraded.

Further, in the present configuration, when a fluorescent component having a different light distribution profile is include on the scatterer layer 56 and scattered by non-light emitting particles in the scatterer layer 56, it is possible for a light distribution profile of a fluorescent component to be extracted to the outside to match the light distribution profile described above. As a result, a light emitting device whose color is not changed even when viewed from any direction can be obtained.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

In addition, in the present configuration, since the light-reflective partition wall 81 is provided on the side surface of the scatterer layers 52, 53, and 71, a fluorescent component incident on side surfaces of the scatterer layers 52, 53, and 71, among fluorescent components of fluorescence emitted from the phosphor layers 52, 53, and 71, reflected on the interface of the substrate 57 or the interface of the scatterer film 72 is reflected on the light-reflective partition wall 81 and can be recycled to a component which can be extracted to the substrate 57 side again. That is, the fluorescent component emitted from the phosphor layers 52, 53, and 71 can be efficiently extracted to the outside by providing the partition wall 81 having light reflectivity on the side surfaces of the scatterer layers 52, 53, and 71.

### (7) Seventh Embodiment

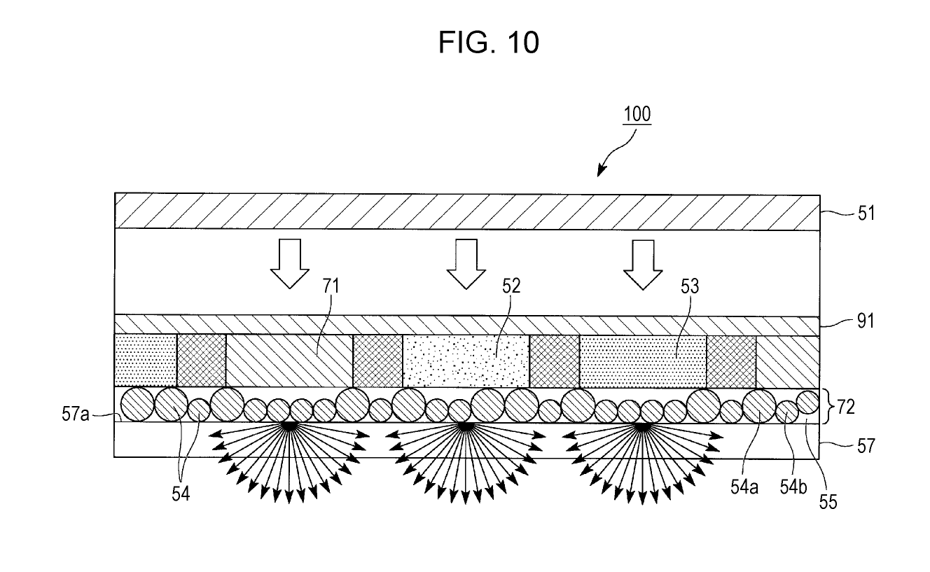

FIG. 10 is a sectional view schematically illustrating a light emitting device according to a seventh embodiment. In FIG. 10, constituent elements which are the same as the light emitting device 60 illustrated in FIG. 6 are denoted by the same reference numerals and the description thereof will not be repeated. A light emitting device 100 is configured of an excitation light source 51 which emits excitation light; a first phosphor layer 52 which is disposed so as to face the excitation light source, is excited by the excitation light, and emits fluorescence; a second phosphor layer 53; a third phosphor layer 71; non-light emitting particles 54 which are formed so as to expand on the phosphor layers 52, 53, and 71, and change the traveling direction of light emitted from the excitation light source 51; a substrate 57 on which a scatterer film 72 formed of gaps 55 which are formed between the particles 54 and one surface 57 of the substrate 57 is formed; a light-reflective partition wall 81 formed on at least one side surface of the phosphor layers 52, 53, and 71 along the lamination direction with the substrate 57; and a wavelength selection transmission reflective layer 91 in the phosphor layers 52, 53, and 71 which is formed on an incident surface side on which excitation light is incident.

That is, the wavelength selection transmission reflective layer 91 is a layer which is provided on the surfaces of the phosphor layers 52, 53, and 71 on which excitation light is incident and on the upper surface of the partition wall 81, transmits at least light having a peak wavelength of the excitation light emitted from the excitation light source 51, and reflects at least light having a light emission peak wavelength of the phosphor layers 52, 53, and 71.

A fluorescent component proceeding to the rear surface side of the light emitting device 90, in fluorescence isotropically emitted light with respect to all directions from the phosphor layers 52, 53, and 71, can be efficiently reflected to the front surface direction using the wavelength selection transmission reflective layer 91 which is provided on the incident surface of the phosphor layers 52, 53, and 71 and thus the light emission efficiency can be improved.

Examples of the wavelength selection transmission reflective layer 91 include an inorganic material substrate formed of a dielectric multilayer film, metal thin film glass, and quarts; and a plastic substrate formed of polyethylene terephthalate, polycarbazole, and polyimide. However, the present embodiment is not limited to these substrates.

Light emission of the light emitting device 100 will be described below with reference to FIG. 10.

In the light emitting device 100, when excitation light is respectively incident on the first phosphor layer 52, the second phosphor layer 53, and the third phosphor layer 71 from the excitation light source 51, light with isotropic energy, that is, energy equivalent with respect to all directions is radiated from a phosphor in the phosphor layers 52, 53, and 71. However, the light distribution profile of fluorescence to be extracted to the outside from a phosphor layer varies depending on the kind of phosphor in most cases. For example, in a case where the refractive index of a phosphor material or a resin material constituting a phosphor layer varies for each phosphor layer, the refraction angle in which the fluorescence to be extracted to the outside is refracted on the interface between the phosphor layer and the outside varies depending on the phosphor layer. That is, the light distribution profile of fluorescence to be extracted to the outside varies for each phosphor layer. In addition, for example, in a case where the phosphor layer is configured of an inorganic phosphor material, the light emitting characteristics vary due to the particles or the shape of the phosphor particles.

That is, the light distribution profile to be extracted outside varies for each phosphor layer. However, a part of the fluorescent component proceeding to the direction of the substrate 57 in fluorescence emitted by the phosphor layers 52 and 53 is incident on the scatterer film 72. Most light of the fluorescent component incident on the scatterer film 72 is incident on the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer film 72 and the substrate 57 and between the substrate 57 and the outside. In the present embodiment, since the refractive index of the gap 33 constituting the scatterer film 72 is around 1.0, the substrate 57 is interposed between the gap 33 having a refractive index of around 1.0 and the outside having a refractive index of around 1.0.

In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside. In a case where a scatterer film having the present configuration is not present between the phosphor layer and the substrate, since a phosphor in a phosphor layer is generally melted or dispersed in a resin having a refractive index of 1.0 or greater, a part of the fluorescent component incident on the substrate from the phosphor layer is totally reflected on the refractive index interface between the substrate and the outside. In such as case, there is a possibility that the fluorescence which is totally reflected is incident on the phosphor layers adjacent to each other and a phosphor in the phosphor layers is excited by the fluorescence. In such a case, there is a problem in that light emitted from each layer is mixed so that the display quality is degraded.

Further, in the present configuration, when a fluorescent component having a different light distribution profile is include on the scatterer layer 56 and scattered by non-light emitting particles in the scatterer layer 56, it is possible for a light distribution profile of a fluorescent component to be extracted to the outside to match the light distribution profile described above. As a result, a light emitting device whose color is not changed even when viewed from any direction can be obtained.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

In addition, in the present configuration, since the light-reflective partition wall 81 is provided on the side surface of the scatterer layers 52, 53, and 71, a fluorescent component incident on side surfaces of the scatterer layers 52, 53, and 71, among fluorescent components of fluorescence emitted from the phosphor layers 52, 53, and 71, reflected on the interface of the substrate 57 or the interface of the scatterer film 72 is reflected on the light-reflective partition wall 81 and can be recycled to a component which can be extracted to the substrate 57 side again. That is, the fluorescent component emitted from the phosphor layers 52, 53, and 71 can be efficiently extracted to the outside by providing the partition wall 81 having light reflectivity on the side surfaces of the scatterer layers 52, 53, and 71.

In addition, in the present configuration, since the wavelength selection transmission reflective layer 91 is provided on the incident surface side of the phosphor layers 52, 53, and 71 on which excitation light is incident, a fluorescent component to be emitted to the side (rear surface side) opposite to the light extraction side of the phosphor layers 52, 53, and 71 is reflected on the interface between the phosphor layers 52, 53, and 71 and the wavelength selection transmission reflective layer 91 and can be effectively extracted to the light extraction side and to the outside as fluorescence. That is, the fluorescent component emitted from the phosphor layers 52, 53, and 71 can be exceedingly efficiently extracted to the outside by providing the wavelength selection transmission reflective layer 91 on the incident surfaces of the phosphor layers 52, 53, and 71, on which excitation light is incident.

### (8) Eighth Embodiment

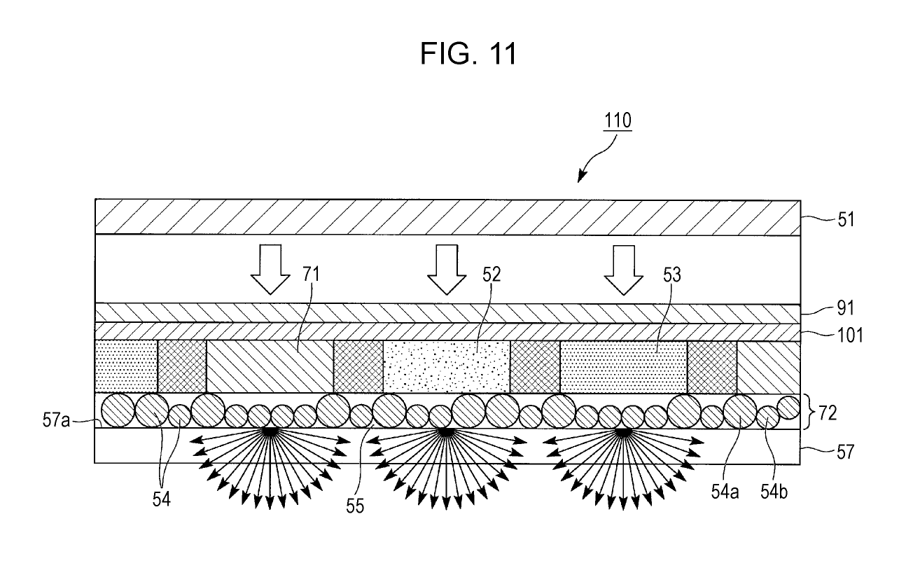

FIG. 11 is a sectional view schematically illustrating a light emitting device according to an eighth embodiment. In FIG. 11, constituent elements which are the same as the light emitting device 60 illustrated in FIG. 6 are denoted by the same reference numerals and the description thereof will not be repeated. A light emitting device 110 is configured of an excitation light source 51 which emits excitation light; a first phosphor layer 52 which is disposed so as to face the excitation light source, is excited by the excitation light, and emits fluorescence; a second phosphor layer 53; a third phosphor layer 71; non-light emitting particles 54 which are formed so as to expand on the phosphor layers 52, 53, and 71, and change the traveling direction of light emitted from the excitation light source 51; a substrate 57 on which a scatterer film 72 formed of gaps 55 which are formed between the particles 54 and one surface 57a of the substrate 57 is formed; a light-reflective partition wall 81 formed on at least one side surface of the phosphor layers 52, 53, and 71 along the lamination direction with the substrate 57; a wavelength selection transmission reflective layer 91 which is formed on an incident surface side of the phosphor layers 52, 53, and 71 on which excitation light is incident; and a low refractive index layer 101 which is formed between the phosphor layers 52, 53, and 71, and the wavelength selection transmission reflective layer 91 and has a refractive index smaller than those of the phosphor layers 52, 53, and 71.

That is, the low refractive index layer 101 is a layer which is provided between the phosphor layers 52, 53, and 71, and the wavelength selection transmission reflective layer 91 and reflects at least fluorescence, in the fluorescence emitted from the phosphor layers, which is incident on an interface at a critical angle or larger of the interface between the phosphor layers and the low refractive index layer.

A fluorescent component proceeding to the rear surface side of the light emitting device 100 in the fluorescence to be isotropically emitted in all directions from the phosphor layers 52, 53, and 71 can be efficiently reflected to the front surface direction by the low refractive index layer 101 provided between the phosphor layers 52, 53, 71, and the wavelength selection transmission reflective layer 91 and thus light emission efficiency can be improved.

Examples of the low refractive index layer 101 include a fluorine resin having a refractive index of approximately 1.35 to 1.4; a silicone resin having a refractive index of approximately 1.4 to 1.5; silica aerogel having a refractive index of approximately 1.003 to 1.3; and porous silica having a refractive index of approximately 1.2 to 1.3, but the present embodiment is not limited to these materials.

It is preferable that the refractive index of the low refractive index layer 71 is as low as possible and more preferable that the low refractive index layer 71 is formed of silica aerogel or porous silica from viewpoints of reducing the refractive index thereof and allowing holes or gaps to be present in the low refractive index layer 71. Silica aerogel is particularly preferable because the refractive index thereof is extremely low.

As disclosed in, for example, U.S. Pat. No. 4,402,827, Japanese Patent No. 4279971, Japanese Unexamined Patent Application Publication No. 2001-202827, and others, silica aerogel is produced by drying a gelatinous compound, in a wet state which is formed of silica skeletons obtained by carrying out hydrolysis and a polymerization reaction on alkoxysilane, in a supercritical state with a critical point or greater of a solvent in the presence of the solvent of alcohol or carbon dioxide.

In addition, it is preferable that the low refractive index layer 101 is formed of a gas. It is preferable that the refractive index of the low refractive index layer 71 is as low as possible, but the lower limit of the refractive index is approximately 1.003 when the low refractive index layer 71 is formed of a material such as a solid, a liquid, or a gel as disclosed in U.S. Pat. No. 4,402,827, Japanese Patent No. 4279971, Japanese Unexamined Patent Application Publication No. 2001-202827, and others. Meanwhile, when the low refractive index layer 101 is a gas layer formed of a gas such as an oxygen or nitrogen, the refractive index can be set as 1.0 and fluorescence can be extremely efficiently extracted to the outside.

Light emission of the light emitting device 110 will be described below with reference to FIG. 11.

In the light emitting device 110, when excitation light is respectively incident on the first phosphor layer 52, the second phosphor layer 53, and the third phosphor layer 71 from the excitation light source 51, light with isotropic energy, that is, energy equivalent with respect to all directions is radiated from a phosphor in the phosphor layers 52, 53, and 71. However, the light distribution profile of fluorescence to be extracted to the outside from a phosphor layer varies depending on the kind of phosphor in most cases. For example, in a case where the refractive index of a phosphor material or a resin material constituting a phosphor layer varies for each phosphor layer, the refraction angle in which the fluorescence to be extracted to the outside is refracted on the interface between the phosphor layer and the outside varies depending on the phosphor layer. That is, the light distribution profile of fluorescence to be extracted to the outside varies for each phosphor layer. In addition, for example, in a case where the phosphor layer is configured of an inorganic phosphor material, the light emitting characteristics vary due to the particles or the shape of the phosphor particles.

That is, the light distribution profile to be extracted outside varies for each phosphor layer. However, a part of the fluorescent component proceeding to the direction of the substrate 57 in fluorescence emitted by the phosphor layers 52 and 53 is incident on the scatterer film 72. Most light of the fluorescent component incident on the scatterer film 72 is incident on the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer film 72 and the substrate 57 and between the substrate 57 and the outside. In the present embodiment, since the refractive index of the gap 33 constituting the scatterer film 72 is around 1.0, the substrate 57 is interposed between the gap 33 having a refractive index of around 1.0 and the outside having a refractive index of around 1.0. In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside.

In a case where a scatterer film having the present configuration is not present between the phosphor layer and the substrate, since a phosphor in a phosphor layer is generally melted or dispersed in a resin having a refractive index of 1.0 or greater, a part of the fluorescent component incident on the substrate from the phosphor layer is totally reflected on the refractive index interface between the substrate and the outside. In such as case, there is a possibility that the fluorescence which is totally reflected is incident on the phosphor layers adjacent to each other and a phosphor in the phosphor layers is excited by the fluorescence. In such a case, there is a problem in that light emitted from each layer is mixed so that the display quality is degraded. Further, in the present configuration, when a fluorescent component having a different light distribution profile is include on the scatterer layer 56 and scattered by non-light emitting particles in the scatterer layer 56, it is possible for a light distribution profile of a fluorescent component to be extracted to the outside to match the light distribution profile described above. As a result, a light emitting device whose color is not changed even when viewed from any direction can be obtained.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

In addition, in the present configuration, since the light-reflective partition wall 81 is provided on the side surface of the scatterer layers 52, 53, and 71, a fluorescent component incident on side surfaces of the scatterer layers 52, 53, and 71, among fluorescent components of fluorescence emitted from the phosphor layers 52, 53, and 71, reflected on the interface of the substrate 57 or the interface of the scatterer film 72 is reflected on the light-reflective partition wall 81 and can be recycled to a component which can be extracted to the substrate 57 side again. That is, the fluorescent component emitted from the phosphor layers 52, 53, and 71 can be efficiently extracted to the outside by providing the partition wall 81 having light reflectivity on the side surfaces of the scatterer layers 52, 53, and 71.

In addition, in the present configuration, since the wavelength selection transmission reflective layer 91 is provided on the incident surface side of the phosphor layers 52, 53, and 71 on which excitation light is incident, a fluorescent component to be emitted to the side (rear surface side) opposite to the light extraction side of the phosphor layers 52, 53, and 71 is reflected on the interface between the phosphor layers 52, 53, and 71 and the wavelength selection transmission reflective layer 91 and can be effectively extracted to the light extraction side and to the outside as fluorescence. That is, the fluorescent component emitted from the phosphor layers 52, 53, and 71 can be exceedingly efficiently extracted to the outside by providing the wavelength selection transmission reflective layer 91 on the incident surfaces of the phosphor layers 52, 53, and 71, on which excitation light is incident.

In addition, in the present configuration, since the low refractive index layer 101 is provided between the phosphor layers 52, 53, and 71 and the wavelength selection transmission reflective layer 91, fluorescence, among fluorescent components to be emitted to the side (rear surface side) opposite to the light extraction side of the phosphor layers 52, 53, and 71, to be emitted to an interface at a critical angle or larger of the interface of the phosphor layers and the low refractive index layer is reflected and can be effectively extracted to the light extraction side and to the outside as fluorescence. In general, since the wavelength selection transmission reflective layer 91 has a characteristic in which the reflectance of light incident at a shallow angle with respect to the incident surface is decreased, the light incident at a shallow angle is reliably reflected and can be recycled by combining the wavelength selection transmission reflective layer 91 and the low refractive index layer 101. That is, when the low refractive index layer 101 is provided between the phosphor layers 52, 53, 71, and the wavelength selection transmission reflective layer 91, the fluorescent component emitted from the phosphor layers 52, 53, and 71 can be exceedingly efficiently extracted to the outside.

### (9) Ninth Embodiment

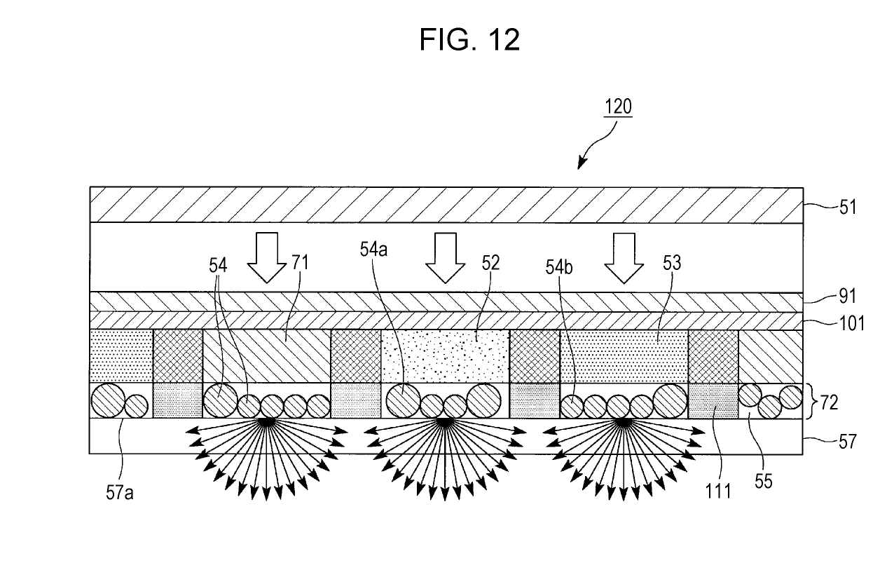

FIG. 12 is a sectional view schematically illustrating a light emitting device according to a ninth embodiment. In FIG. 12, constituent elements which are the same as the light emitting device 60 illustrated in FIG. 6 are denoted by the same reference numerals and the description thereof will not be repeated. A light emitting device 120 is configured of an excitation light source 51 which emits excitation light; a first phosphor layer 52 which is disposed so as to face the excitation light source, is excited by the excitation light, and emits fluorescence; a second phosphor layer 53; a third phosphor layer 71; non-light emitting particles 54 which are formed so as to expand on the phosphor layers 52, 53, and 71, and change the traveling direction of light emitted from the excitation light source 51; a substrate 57 on which a scatterer film 72 formed of gaps 55 which are formed between the particles 54 and one surface 57a of the substrate 57 is formed; a light-reflective partition wall 81 formed on at least one side surface of the phosphor layers 52, 53, and 71 along the lamination direction with the substrate 57; a wavelength selection transmission reflective layer 91 which is formed on an incident surface side of the phosphor layers 52, 53, and 71 on which excitation light is incident; a low refractive index layer 101 which is formed between the phosphor layers 52, 53, and 71, and the wavelength selection transmission reflective layer 91 and has a refractive index smaller than those of the phosphor layers 52, 53, and 71; and a light absorbing layer 111 which is formed between the substrate 57 and the partition wall 81.

The light absorbing layer 111 is formed of a material having light absorbing properties and formed so as to correspond to a region between pixels adjacent to each other. The contrast of a display can be improved by the light absorbing layer 111.

The film thickness of the light absorbing layer 111 is generally in the range of about 100 nm to 100 μm and preferably in the range of 100 nm to 10 μm. In addition, in order to efficiently extract emitted light to the side surfaces of the phosphor layers 52, 53, and 71, it is preferable that the film thickness of the light absorbing layer 111 is thinner than the film thicknesses of the phosphor layers 52, 53, and 71.

Light emission of the light emitting device 120 will be described below with reference to FIG. 12.

In the light emitting device 120, when excitation light is respectively incident on the first phosphor layer 52, the second phosphor layer 53, and the third phosphor layer 71 from the excitation light source 51, light with isotropic energy, that is, energy equivalent with respect to all directions is radiated from a phosphor in the phosphor layers 52, 53, and 71. However, the light distribution profile of fluorescence to be extracted to the outside from a phosphor layer varies depending on the kind of phosphor in most cases. For example, in a case where the refractive index of a phosphor material or a resin material constituting a phosphor layer varies for each phosphor layer, the refraction angle in which the fluorescence to be extracted to the outside is refracted on the interface between the phosphor layer and the outside varies depending on the phosphor layer. That is, the light distribution profile of fluorescence to be extracted to the outside varies for each phosphor layer. In addition, for example, in a case where the phosphor layer is configured of an inorganic phosphor material, the light emitting characteristics vary due to the particles or the shape of the phosphor particles.

That is, the light distribution profile to be extracted outside varies for each phosphor layer. However, a part of the fluorescent component proceeding to the direction of the substrate 57 in fluorescence emitted by the phosphor layers 52 and 53 is incident on the scatterer film 72. Most light of the fluorescent component incident on the scatterer film 72 is incident on the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer film 72 and the substrate 57 and between the substrate 57 and the outside. In the present embodiment, since the refractive index of the gap 33 constituting the scatterer film 72 is around 1.0, the substrate 57 is interposed between the gap 33 having a refractive index of around 1.0 and the outside having a refractive index of around 1.0. In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside.

In a case where a scatterer film having the present configuration is not present between the phosphor layer and the substrate, since a phosphor in a phosphor layer is generally melted or dispersed in a resin having a refractive index of 1.0 or greater, a part of the fluorescent component incident on the substrate from the phosphor layer is totally reflected on the refractive index interface between the substrate and the outside. In such as case, there is a possibility that the fluorescence which is totally reflected is incident on the phosphor layers adjacent to each other and a phosphor in the phosphor layers is excited by the fluorescence. In such a case, there is a problem in that light emitted from each layer is mixed so that the display quality is degraded.

Further, in the present configuration, when a fluorescent component having a different light distribution profile is include on the scatterer layer 56 and scattered by non-light emitting particles in the scatterer layer 56, it is possible for a light distribution profile of a fluorescent component to be extracted to the outside to match the light distribution profile described above. As a result, a light emitting device whose color is not changed even when viewed from any direction can be obtained.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

In addition, in the present configuration, since the light-reflective partition wall 81 is provided on the side surface of the scatterer layers 52, 53, and 71, a fluorescent component incident on side surfaces of the scatterer layers 52, 53, and 71, among fluorescent components of fluorescence emitted from the phosphor layers 52, 53, and 71, reflected on the interface of the substrate 57 or the interface of the scatterer film 72 is reflected on the light-reflective partition wall 81 and can be recycled to a component which can be extracted to the substrate 57 side again. That is, the fluorescent component emitted from the phosphor layers 52, 53, and 71 can be efficiently extracted to the outside by providing the partition wall 81 having light reflectivity on the side surfaces of the scatterer layers 52, 53, and 71.

In addition, in the present configuration, since the wavelength selection transmission reflective layer 91 is provided on the incident surface side of the phosphor layers 52, 53, and 71 on which excitation light is incident, a fluorescent component to be emitted to the side (rear surface side) opposite to the light extraction side of the phosphor layers 52, 53, and 71 is reflected on the interface between the phosphor layers 52, 53, and 71 and the wavelength selection transmission reflective layer 91 and can be effectively extracted to the light extraction side and to the outside as fluorescence. That is, the fluorescent component emitted from the phosphor layers 52, 53, and 71 can be exceedingly efficiently extracted to the outside by providing the wavelength selection transmission reflective layer 91 on the incident surfaces of the phosphor layers 52, 53, and 71, on which excitation light is incident.

In addition, in the present configuration, since the low refractive index layer 101 is provided between the phosphor layers 52, 53, and 71 and the wavelength selection transmission reflective layer 91, fluorescence, among fluorescent components to be emitted to the side (rear surface side) opposite to the light extraction side of the phosphor layers 52, 53, and 71, to be emitted to an interface at a critical angle or larger of the interface of the phosphor layers and the low refractive index layer is reflected and can be effectively extracted to the light extraction side and to the outside as fluorescence. In general, since the wavelength selection transmission reflective layer 91 has a characteristic in which the reflectance of light incident at a shallow angle with respect to the incident surface is decreased, the light incident at a shallow angle is reliably reflected and can be recycled by combining the wavelength selection transmission reflective layer 91 and the low refractive index layer 101. That is, when the low refractive index layer 101 is provided between the phosphor layers 52, 53, 71, and the wavelength selection transmission reflective layer 91, the fluorescent component emitted from the phosphor layers 52, 53, and 71 can be exceedingly efficiently extracted to the outside.

Moreover, in the present configuration, since the light absorbing layers 111 respectively formed between the phosphor layers adjacent to each other and between the substrate 57 and the partition wall 81, intrusion of fluorescence emitted from the phosphor layers 52, 53, and 71 into the phosphor layers can be prevented by absorbing light and thus the contrast of a display can be improved.

### (10) Tenth Embodiment

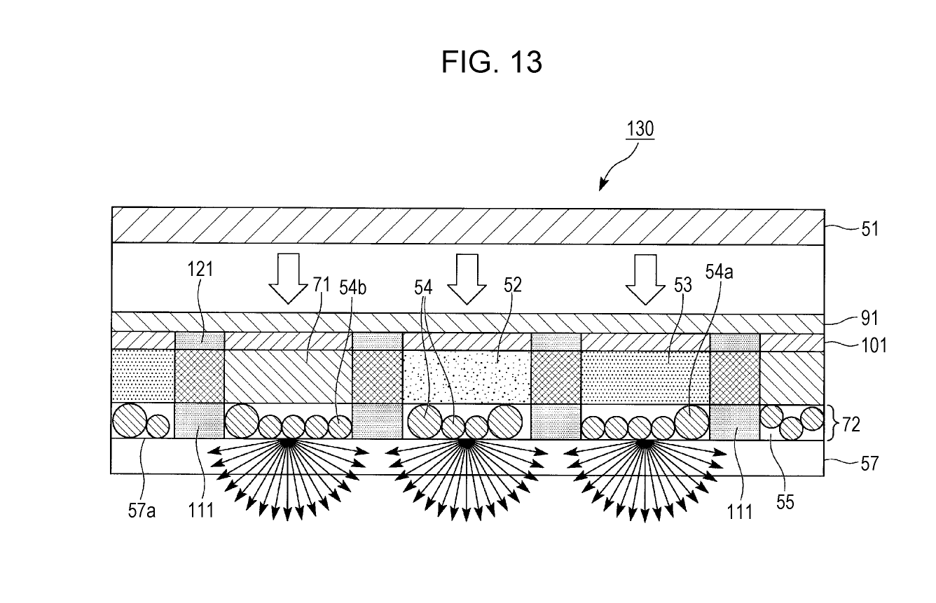

FIG. 13 is a sectional view schematically illustrating a light emitting device according to a tenth embodiment. In FIG. 13, constituent elements which are the same as the light emitting device 60 illustrated in FIG. 6 are denoted by the same reference numerals and the description thereof will not be repeated. A light emitting device 130 is configured of an excitation light source 51 which emits excitation light; a first phosphor layer 52 which is disposed so as to face the excitation light source, is excited by the excitation light, and emits fluorescence; a second phosphor layer 53; a third phosphor layer 71; non-light emitting particles 54 which are formed so as to expand on the phosphor layers 52, 53, and 71, and change the traveling direction of light emitted from the excitation light source 51; a substrate 57 on which a scatterer film 72 formed of gaps 55 which are formed between the particles 54 and one surface 57a of the substrate 57 is formed; a light-reflective partition wall 81 formed on at least one side surface of the phosphor layers 52, 53, and 71 along the lamination direction with the substrate 57; a wavelength selection transmission reflective layer 91 which is formed on an incident surface side of the phosphor layers 52, 53, and 71 on which excitation light is incident; a low refractive index layer 101 which is formed between the phosphor layers 52, 53, and 71, and the wavelength selection transmission reflective layer 91 and has a refractive index smaller than those of the phosphor layers 52, 53, and 71; a light absorbing layer 111 which is formed between the substrate 57 and the partition wall 81, and a second light absorbing layer 121 formed on the incident surface of the partition wall 81 on which the excitation light is incident.

Light emission of the light emitting device 130 will be described below with reference to FIG. 13.

In the light emitting device 130, when excitation light is respectively incident on the first phosphor layer 52, the second phosphor layer 53, and the third phosphor layer 71 from the excitation light source 51, light with isotropic energy, that is, energy equivalent with respect to all directions is radiated from a phosphor in the phosphor layers 52, 53, and 71. However, the light distribution profile of fluorescence to be extracted to the outside from a phosphor layer varies depending on the kind of phosphor in most cases. For example, in a case where the refractive index of a phosphor material or a resin material constituting a phosphor layer varies for each phosphor layer, the refraction angle in which the fluorescence to be extracted to the outside is refracted on the interface between the phosphor layer and the outside varies depending on the phosphor layer. That is, the light distribution profile of fluorescence to be extracted to the outside varies for each phosphor layer. In addition, for example, in a case where the phosphor layer is configured of an inorganic phosphor material, the light emitting characteristics vary due to the particles or the shape of the phosphor particles.

That is, the light distribution profile to be extracted outside varies for each phosphor layer. However, a part of the fluorescent component proceeding to the direction of the substrate 57 in fluorescence emitted by the phosphor layers 52 and 53 is incident on the scatterer film 72. Most light of the fluorescent component incident on the scatterer film 72 is incident on the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer film 72 and the substrate 57 and between the substrate 57 and the outside. In the present embodiment, since the refractive index of the gap 33 constituting the scatterer film 72 is around 1.0, the substrate 57 is interposed between the gap 33 having a refractive index of around 1.0 and the outside having a refractive index of around 1.0.

In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside. In a case where a scatterer film having the present configuration is not present between the phosphor layer and the substrate, since a phosphor in a phosphor layer is generally melted or dispersed in a resin having a refractive index of 1.0 or greater, a part of the fluorescent component incident on the substrate from the phosphor layer is totally reflected on the refractive index interface between the substrate and the outside. In such as case, there is a possibility that the fluorescence which is totally reflected is incident on the phosphor layers adjacent to each other and a phosphor in the phosphor layers is excited by the fluorescence. In such a case, there is a problem in that light emitted from each layer is mixed so that the display quality is degraded.

Further, in the present configuration, when a fluorescent component having a different light distribution profile is include on the scatterer layer 56 and scattered by non-light emitting particles in the scatterer layer 56, it is possible for a light distribution profile of a fluorescent component to be extracted to the outside to match the light distribution profile described above. As a result, a light emitting device whose color is not changed even when viewed from any direction can be obtained.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

In addition, in the present configuration, since the light-reflective partition wall 81 is provided on the side surface of the scatterer layers 52, 53, and 71, a fluorescent component incident on side surfaces of the scatterer layers 52, 53, and 71, among fluorescent components of fluorescence emitted from the phosphor layers 52, 53, and 71, reflected on the interface of the substrate 57 or the interface of the scatterer film 72 is reflected on the light-reflective partition wall 81 and can be recycled to a component which can be extracted to the substrate 57 side again. That is, the fluorescent component emitted from the phosphor layers 52, 53, and 71 can be efficiently extracted to the outside by providing the partition wall 81 having light reflectivity on the side surfaces of the scatterer layers 52, 53, and 71.

In addition, in the present configuration, since the wavelength selection transmission reflective layer 91 is provided on the incident surface side of the phosphor layers 52, 53, and 71 on which excitation light is incident, a fluorescent component to be emitted to the side (rear surface side) opposite to the light extraction side of the phosphor layers 52, 53, and 71 is reflected on the interface between the phosphor layers 52, 53, and 71 and the wavelength selection transmission reflective layer 91 and can be effectively extracted to the light extraction side and to the outside as fluorescence. That is, the fluorescent component emitted from the phosphor layers 52, 53, and 71 can be exceedingly efficiently extracted to the outside by providing the wavelength selection transmission reflective layer 91 on the incident surfaces of the phosphor layers 52, 53, and 71, on which excitation light is incident.

In addition, in the present configuration, since the low refractive index layer 101 is provided between the phosphor layers 52, 53, and 71 and the wavelength selection transmission reflective layer 91, fluorescence, among fluorescent components to be emitted to the side (rear surface side) opposite to the light extraction side of the phosphor layers 52, 53, and 71, to be emitted to an interface at a critical angle or larger of the interface of the phosphor layers and the low refractive index layer is reflected and can be effectively extracted to the light extraction side and to the outside as fluorescence. In general, since the wavelength selection transmission reflective layer 91 has a characteristic in which the reflectance of light incident at a shallow angle with respect to the incident surface is decreased, the light incident at a shallow angle is reliably reflected and can be recycled by combining the wavelength selection transmission reflective layer 91 and the low refractive index layer 101. That is, when the low refractive index layer 101 is provided between the phosphor layers 52, 53, 71, and the wavelength selection transmission reflective layer 91, the fluorescent component emitted from the phosphor layers 52, 53, and 71 can be exceedingly efficiently extracted to the outside.

Moreover, in the present configuration, since the light absorbing layers 111 respectively formed between the phosphor layers adjacent to each other and between the substrate 57 and the partition wall 81, intrusion of fluorescence emitted from the phosphor layers 52, 53, and 71 into the phosphor layers can be prevented by absorbing light and thus the contrast of a display can be improved.

Further, in the present configuration, since the second light absorbing layer 121 formed on the incident surface of the partition wall 81 on which excitation light is incident is provided, the excitation light is reflected after reaching the bottom surface of the partition wall 81 without being incident on the phosphor layers and intrusion of the excitation light into the phosphor layers adjacent to each other can be prevented by absorbing light and thus a decrease in the contrast of a display can be prevented.

### (11) Eleventh Embodiment

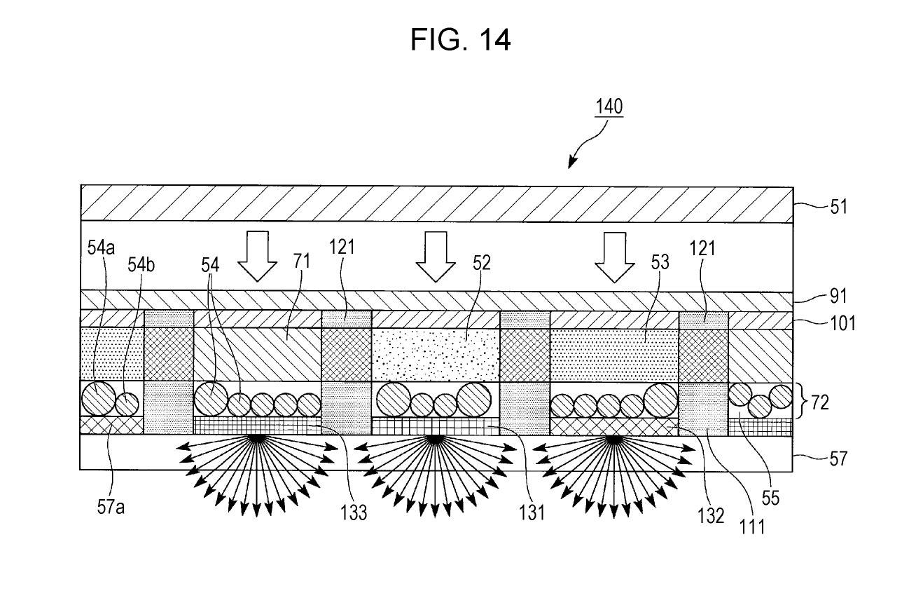

FIG. 14 is a sectional view schematically illustrating a light emitting device according to an eleventh embodiment. In FIG. 14, constituent elements which are the same as the light emitting device 60 illustrated in FIG. 6 are denoted by the same reference numerals and the description thereof will not be repeated. A light emitting device 140 is configured of an excitation light source 51 which emits excitation light; a first phosphor layer 52 which is disposed so as to face the excitation light source, is excited by the excitation light, and emits fluorescence; a second phosphor layer 53; a third phosphor layer 71; non-light emitting particles 54 which are formed so as to expand on the phosphor layers 52, 53, and 71, and change the traveling direction of light emitted from the excitation light source 51; a substrate 57 on which a scatterer film 72 formed of gaps 55 which are formed between the particles 54 and one surface 57a of the substrate 57 is formed; a light-reflective partition wall 81 formed on at least one side surface of the phosphor layers 52, 53, and 71 along the lamination direction with the substrate 57; a wavelength selection transmission reflective layer 91 which is formed on an incident surface side of the phosphor layers 52, 53, and 71 on which excitation light is incident; a low refractive index layer 101 which is formed between the phosphor layers 52, 53, and 71, and the wavelength selection transmission reflective layer 91 and has a refractive index smaller than those of the phosphor layers 52, 53, and 71; a light absorbing layer 111 which is formed between the substrate 57 and the partition wall 81; a second light absorbing layer 121 formed on the incident surface of the partition wall 81 on which the excitation light is incident; a first color filter 131 which is formed between the substrate 57 and the first phosphor layer 52; a second color filter 132 which is formed between the substrate 57 and the second phosphor layer 132; and a third color filter 133 which is formed between the substrate 57 and the third phosphor layer 71.

Color filters in the related art can be used as the color filters. When color filters are provided, the color purity of fluorescence emitted from the phosphor layers can be increased and a color reproduction region can be widened. In addition, since color filters provided on the respective phosphor layers absorb excitation light components contained in external light, light emission of the phosphor layers due to the external light can be reduced or prevented and thus a decrease in the contrast can be reduced or prevented.

Light emission of the light emitting device 140 will be described below with reference to FIG. 14.

In the light emitting device 140, when excitation light is respectively incident on the first phosphor layer 52, the second phosphor layer 53, and the third phosphor layer 71 from the excitation light source 51, light with isotropic energy, that is, energy equivalent with respect to all directions is radiated from a phosphor in the phosphor layers 52, 53, and 71. However, the light distribution profile of fluorescence to be extracted to the outside from a phosphor layer varies depending on the kind of phosphor in most cases. For example, in a case where the refractive index of a phosphor material or a resin material constituting a phosphor layer varies for each phosphor layer, the refraction angle in which the fluorescence to be extracted to the outside is refracted on the interface between the phosphor layer and the outside varies depending on the phosphor layer. That is, the light distribution profile of fluorescence to be extracted to the outside varies for each phosphor layer. In addition, for example, in a case where the phosphor layer is configured of an inorganic phosphor material, the light emitting characteristics vary due to the particles or the shape of the phosphor particles.

That is, the light distribution profile to be extracted outside varies for each phosphor layer. However, a part of the fluorescent component proceeding to the direction of the substrate 57 in fluorescence emitted by the phosphor layers 52 and 53 is incident on the scatterer film 72. Most light of the fluorescent component incident on the scatterer film 72 is incident on the non-light emitting particles 54 through the gaps 55 and becomes scattering light. In the scattering light, a component proceeding to the substrate 57 side, a component proceeding to the excitation light source 51 side, and a component incident on other non-light emitting particles 54 again through the gaps 55 are present. Here, refractive index interfaces due to refractive index differences of respective layers are present between the scatterer film 72 and the substrate 57 and between the substrate 57 and the outside. In the present embodiment, since the refractive index of the gap 33 constituting the scatterer film 72 is around 1.0, the substrate 57 is interposed between the gap 33 having a refractive index of around 1.0 and the outside having a refractive index of around 1.0.

In such a configuration, since scattering light proceeding to the substrate 57 side among scattering light scattered by the non-light emitting particles 54 is incident on the substrate 57 after passing through the gap 55 having a refractive index of around 1.0, the scattering light incident on the substrate 57 is not totally reflected on the interface between the substrate 57 and the outside and most of the scattering light can be extracted to the outside. In a case where a scatterer film having the present configuration is not present between the phosphor layer and the substrate, since a phosphor in a phosphor layer is generally melted or dispersed in a resin having a refractive index of 1.0 or greater, a part of the fluorescent component incident on the substrate from the phosphor layer is totally reflected on the refractive index interface between the substrate and the outside. In such as case, there is a possibility that the fluorescence which is totally reflected is incident on the phosphor layers adjacent to each other and a phosphor in the phosphor layers is excited by the fluorescence. In such a case, there is a problem in that light emitted from each layer is mixed so that the display quality is degraded.

Further, in the present configuration, when a fluorescent component having a different light distribution profile is include on the scatterer layer 56 and scattered by non-light emitting particles in the scatterer layer 56, it is possible for a light distribution profile of a fluorescent component to be extracted to the outside to match the light distribution profile described above. As a result, a light emitting device whose color is not changed even when viewed from any direction can be obtained.

In general, a scattering intensity parameter determining scattering characteristics of particles is represented by a relationship among a difference between the refractive index of the particles and the refractive index of the environment surrounding the particles; a particle diameter parameter α (α=πD/λ, [D: particle diameter of the particle, λ: wavelength of light]); and a scattering angle θ (angle between incident light incident on the particles and the scattering light scattering after reaching the particles). Here, the particle diameter parameter α largely affects the scattering characteristics. In a case of “α<1,” the scattering intensity distribution becomes a so-called Rayleigh scattering region in which forward scattering (θ=around 0°) and the back-scattering (θ=around 180°) become dominant and scattering almost does not occur on the side (θ=around 90°).

Further, in a case of “α≈1,” the scattering intensity distribution becomes a so-called Mie scattering region in which forward scattering and side scattering become dominant and scattering almost does not occur on the backside. Further, in a case of “α>>1,” the scattering intensity distribution becomes a diffraction scattering region based on geometrical optics in which forward scattering becomes dominant and scattering almost does not occur on the side and the backside. That is, the particle diameter parameter α is determined by the particle diameter of particles and the wavelength of light incident on the particles, that is, the wavelength of fluorescence to be emitted from a phosphor layer. For example, in a case where the fluorescence having a wavelength of 600 nm is not allowed to be scattered by particles on the front side and on the side, the particle diameter of the particles may be set such that a relationship of “particle diameter parameter α≈1” is satisfied.

In addition, in the present configuration, since the light-reflective partition wall 81 is provided on the side surface of the scatterer layers 52, 53, and 71, a fluorescent component incident on side surfaces of the scatterer layers 52, 53, and 71, among fluorescent components of fluorescence emitted from the phosphor layers 52, 53, and 71, reflected on the interface of the substrate 57 or the interface of the scatterer film 72 is reflected on the light-reflective partition wall 81 and can be recycled to a component which can be extracted to the substrate 57 side again. That is, the fluorescent component emitted from the phosphor layers 52, 53, and 71 can be efficiently extracted to the outside by providing the partition wall 81 having light reflectivity on the side surfaces of the scatterer layers 52, 53, and 71.

In addition, in the present configuration, since the wavelength selection transmission reflective layer 91 is provided on the incident surface side of the phosphor layers 52, 53, and 71 on which excitation light is incident, a fluorescent component to be emitted to the side (rear surface side) opposite to the light extraction side of the phosphor layers 52, 53, and 71 is reflected on the interface between the phosphor layers 52, 53, and 71 and the wavelength selection transmission reflective layer 91 and can be effectively extracted to the light extraction side and to the outside as fluorescence. That is, the fluorescent component emitted from the phosphor layers 52, 53, and 71 can be exceedingly efficiently extracted to the outside by providing the wavelength selection transmission reflective layer 91 on the incident surfaces of the phosphor layers 52, 53, and 71, on which excitation light is incident.

In addition, in the present configuration, since the low refractive index layer 101 is provided between the phosphor layers 52, 53, and 71 and the wavelength selection transmission reflective layer 91, fluorescence, among fluorescent components to be emitted to the side (rear surface side) opposite to the light extraction side of the phosphor layers 52, 53, and 71, to be emitted to an interface at a critical angle or larger of the interface of the phosphor layers and the low refractive index layer is reflected and can be effectively extracted to the light extraction side and to the outside as fluorescence. In general, since the wavelength selection transmission reflective layer 91 has a characteristic in which the reflectance of light incident at a shallow angle with respect to the incident surface is decreased, the light incident at a shallow angle is reliably reflected and can be recycled by combining the wavelength selection transmission reflective layer 91 and the low refractive index layer 101. That is, when the low refractive index layer 101 is provided between the phosphor layers 52, 53, 71, and the wavelength selection transmission reflective layer 91, the fluorescent component emitted from the phosphor layers 52, 53, and 71 can be exceedingly efficiently extracted to the outside.

Moreover, in the present configuration, since the light absorbing layers 111 respectively formed between the phosphor layers adjacent to each other and between the substrate 57 and the partition wall 81, intrusion of fluorescence emitted from the phosphor layers 52, 53, and 71 into the phosphor layers can be prevented by absorbing light and thus the contrast of a display can be improved.

Further, in the present configuration, since the second light absorbing layer 121 formed on the incident surface of the partition wall 81 on which excitation light is incident is provided, the excitation light is reflected after reaching the bottom surface of the partition wall 81 without being incident on the phosphor layers and intrusion of the excitation light into the phosphor layers adjacent to each other can be prevented by absorbing light and thus a decrease in the contrast of a display can be prevented.

Further, since the first color filter 131 which is formed between the substrate 57 and the first phosphor layer 52; the second color filter 132 which is formed between the substrate 57 and the second phosphor layer 53; and the third color filter 133 which is formed between the substrate 57 and the third phosphor layer 71 are provided, the color purity of fluorescence emitted from the phosphor layers can be increased and a color reproduction region can be widened.

In addition, since the color filters provided on the respective phosphor layers absorb excitation light components contained in external light, light emission of the phosphor layers due to the external light can be reduced or prevented and thus a decrease in the contrast can be reduced or prevented. Further, since it is possible to prevent the excitation light, which is to be transmitted, from being leaked to the outside without being absorbed by the phosphor layers, a decrease in the color purity caused by light emission from the phosphor layers and color mixture due to the excitation light can be prevented.

### [Display Device]

Next, the specification of an embodiment of a display device configured of the scatterer substrate and the light source will be described.

In the display device including the fluorescent substrate of the this embodiment, the scatterer substrate is a substrate on which a scatterer film, a fluorescent layer, a partition wall, a light absorptive layer, and the like of the light emitting device according to the first embodiment to the eleventh embodiment described above, which are formed of non-light emitting particles that change a traveling direction of light, and voids formed between the particles and one surface of the substrate, are formed. In addition, in the display device of this embodiment, a light source is a substrate (a light emitting element substrate) on which an excitation light source of the light emitting device according to the first embodiment to the eleventh embodiment described above is formed.

In the display device of this embodiment, as the light source, a known ultraviolet LED, a blue LED, a ultraviolet light emitting inorganic EL element, a blue light emitting inorganic EL element, a ultraviolet light emitting organic EL element, a blue light emitting organic EL element, and the like are included, but this embodiment is not limited to these light sources, and a light source which is manufactured by a known material, and a known manufacturing method is able to be used.

Here, as the ultraviolet light, light emission of which a main light emitting peak is 360 nm to 410 nm is preferable, and as the blue light, light emission of which a main light emitting peak is 410 nm to 470 nm is preferable.

### (1) First Embodiment

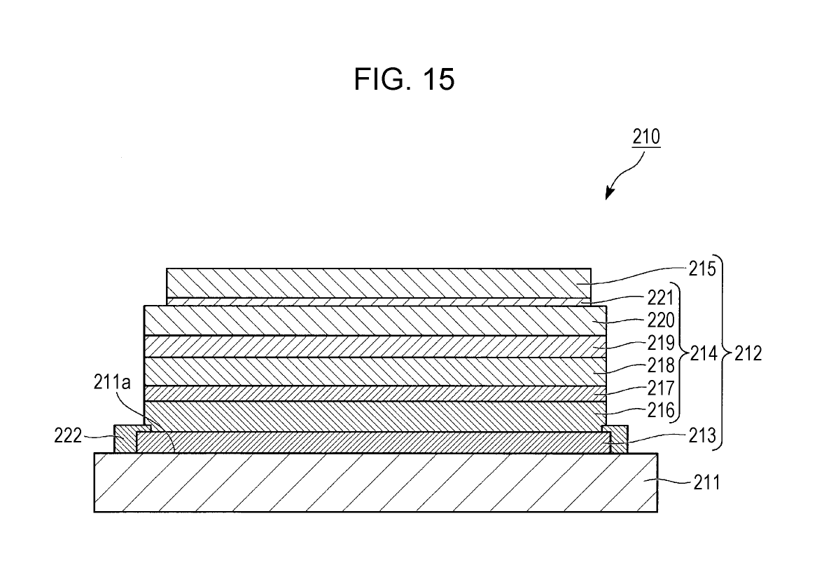

FIG. 15 is a schematic sectional view illustrating an organic EL element substrate configuring a display device according to a first embodiment.

The display device of this embodiment is schematically configured of the fluorescent substrate formed of a substrate on which the fluorescent layer, the particles having light scattering properties, the partition wall, the light absorptive layer, and the like of the light emitting device according to the first embodiment to the eleventh embodiment described above are formed, and an organic EL element substrate (a light source) 210 which is bonded to the fluorescent substrate with a planarizing film or the like in between.

The organic EL element substrate (a display device) 210 is schematically configured of a substrate 211, and an organic EL element 212 which is disposed on one surface 211a of the substrate 211.

The organic EL element 212 is schematically configured of a first electrode 213, an organic EL layer 214, and a second electrode 215 which are disposed on the one surface 211a of the substrate 211 in this order. That is, the organic EL element 212 includes a pair of electrodes configured of the first electrode 213 and the second electrode 215, and the organic EL layer 214 which is interposed between the pair of electrodes, on the one surface 211a of the substrate 211.

The first electrode 213 and the second electrode 215 function as a positive electrode or a negative electrode of the organic EL element 212 in pairs.

An optical distance between the first electrode 213 and the second electrode 215 is adjusted to configure a microresonator structure (a microcavity structure).

The organic EL layer 214 is configured of a hole injection layer 216, a hole transport layer 217, a light emitting layer 218, a hole prevention layer 219, an electron transport layer 220, and an electron injection layer 221 which are laminated from the first electrode 213 side towards the second electrode 215 side in this order.

Each of the hole injection layer 216, the hole transport layer 217, the light emitting layer 218, the hole prevention layer 219, the electron transport layer 220, and the electron injection layer 221 may have either a single-layer structure or a multi-layer structure. In addition, each of the hole injection layer 216, the hole transport layer 217, the light emitting layer 218, the hole prevention layer 219, the electron transport layer 220, and the electron injection layer 221 may be either an organic thin film or an inorganic thin film.

The hole injection layer 216 efficiently injects a hole from the first electrode 213. The hole transport layer 217 efficiently transports the hole to the light emitting layer 218. The electron transport layer 220 efficiently transports an electron to the light emitting layer 218. The electron injection layer 221 efficiently injects the electron from the second electrode 215. The hole injection layer 216, the hole transport layer 217, the electron transport layer 220, and the electron injection layer 221 correspond to a carrier injection transport layer.

Furthermore, the organic EL element 212 is not limited to the configuration described above, and the organic EL layer 214 may have a single-layer structure of the light emitting layer, or may have a multi-layer structure of the light emitting layer and the carrier injection transport layer. Specifically, as the configuration of the organic EL element 212, (1) a configuration in which only the light emitting layer is disposed between the first electrode 213 and the second electrode 215, (2) a configuration in which the hole transport layer and the light emitting layer are laminated from the first electrode 213 side towards the second electrode 215 side in this order, (3) a configuration in which the light emitting layer and the electron transport layer are laminated from the first electrode 213 side towards the second electrode 215 side in this order, (4) a configuration in which the hole transport layer, the light emitting layer, and the electron transport layer are laminated from the first electrode 213 side towards the second electrode 215 side in this order, (5) a configuration in which the hole injection layer, the hole transport layer, the light emitting layer, and the electron transport layer are laminated from the first electrode 213 side towards the second electrode 215 side in this order, (6) a configuration in which the hole injection layer, the hole transport layer, the light emitting layer, the electron transport layer, and the electron injection layer are laminated from the first electrode 213 side towards the second electrode 215 side in this order, (7) a configuration in which the hole injection layer, the hole transport layer, the light emitting layer, the hole prevention layer, and the electron transport layer are laminated from the first electrode 213 side towards the second electrode 215 side in this order, (8) a configuration in which the hole injection layer, the hole transport layer, the light emitting layer, the hole prevention layer, the electron transport layer, and the electron injection layer are laminated from the first electrode 213 side towards the second electrode 215 side in this order, and (9) a configuration in which the hole injection layer, the hole transport layer, the electron prevention layer, the light emitting layer, the hole prevention layer, the electron transport layer, and the electron injection layer are laminated from the first electrode 213 side towards the second electrode 215 side in this order are included. Each of the light emitting layer, the hole injection layer, the hole transport layer, the hole prevention layer, the electron prevention layer, the electron transport layer, and the electron injection layer may have either a single-layer structure or a multi-layer structure. In addition, each of the light emitting layer, the hole injection layer, the hole transport layer, the hole prevention layer, the electron prevention layer, the electron transport layer, and the electron injection layer may be either an organic thin film or an inorganic thin film.

In addition, an edge cover 222 is formed to cover an end surface of the first electrode 213. That is, the edge cover 222 is disposed to cover the edge portion of the first electrode 213 formed on the one surface 211a of the substrate 211 between the first electrode 213 and the second electrode 215 in order to prevent leakage between the first electrode 213 and the second electrode 215.

Hereinafter, each configuration member configuring the organic EL element substrate (the display device) 210 and a forming method thereof will be specifically described, but this embodiment is not limited to the configuration member and the forming method.

As the substrate 211, for example, an insulating substrate such as an inorganic material substrate formed of glass, quartz, or the like, a plastic substrate formed of a polyethylene terephthalate, a polycarbazole, a polyimide, or the like, and a ceramic substrate formed of an alumina or the like, a metal substrate formed of aluminum (Al), iron (Fe), or the like, a substrate of which a front surface is coated with an insulator formed of an organic insulating material or the like, a substrate subjected to an insulation treatment by using a method or the like in which a front surface of a metal substrate formed of silicon oxide (SiO₂), aluminum, or the like is subjected to positive electrode oxidation, or the like is included, but this embodiment is not limited to these substrates. Among the substrates, it is preferable to use the plastic substrate or the metal substrate since the plastic substrate or the metal substrate is able to form a bent portion and a folded portion without a stress.

Further, a substrate in which an inorganic material is applied onto a plastic substrate, and a substrate in which an inorganic insulating material is applied onto a metal substrate are preferable. By using such a substrate coated with an inorganic material, it is possible to solve degradation of the organic EL due to transmission of moisture which becomes the biggest problem when the plastic substrate is used as a substrate of the organic EL element substrate (it is known that the organic EL is degraded with respect to a particularly small amount of moisture). In addition, it is possible to solve leakage (short circuit) due to a protrusion of the metal substrate which becomes the biggest problem when the metal substrate is used as a substrate of the organic EL element substrate (it is known that a film thickness of the organic EL layer is extremely thin by approximately 100 nm to 200 nm, and thus leakage (short circuit) remarkably occurs in a current in a pixel portion due to the protrusion).

In addition, when a TFT is formed, as the substrate 211, a substrate which is not melted at a temperature of lower than or equal to 500° C. and is not deformed is preferably used. In addition, a general metal substrate has a thermal expansion rate different from that of glass, and thus it is difficult to form the TFT on the metal substrate in a production apparatus of the related art, but a metal substrate of an iron-nickel alloy of which a linear expansion coefficient is less than or equal to 1×10⁻⁵/° C. is used, and thus it is possible to form the TFT on the metal substrate in the production apparatus of the related art at a low price by matching the linear expansion coefficient to that of glass.

In addition, since the plastic substrate has extremely a low heat resistant temperature, the TFT is formed on the glass substrate, then the TFT on the glass substrate is transferred to the plastic substrate, and thus it is possible to transfer and form the TFT onto the plastic substrate.

Further, when emitted light from the organic EL layer 214 is extracted from a side opposite to the substrate 211, there is no restriction on the substrate, but when the emitted light from the organic EL layer 214 is extracted from the substrate 211 side, it is necessary that a transparent substrate or a semi-transparent substrate is used in order to extract the emitted light from the organic EL layer 214 to the outside.

The TFT formed on the substrate 211 is formed on the one surface 211a of the substrate 211 in advance before the organic EL element 212 is formed, and functions as an element for switching a pixel and an element driving an organic EL element.

As the TFT of this embodiment, a known TFT is included. In addition, instead of the TFT, a metal-insulating body-metal (MIM) diode is able to be used.

The TFT which is able to be used in an active driving type organic EL display device and an organic EL display device is able to be formed by using a known material, a known structure, and a known forming method.

As the material of an active layer configuring the TFT, for example, an inorganic semiconductor material such as amorphous silicon, multi-crystal silicon (polysilicon), fine crystal silicon, and cadmium selenide, an oxide semiconductor material such as zinc oxide, and indium oxide-gallium oxide-zinc oxide, or an organic semiconductor material such as a polythiophene derivative, a thiophene oligomer, a poly(p-phenylenevinylene) derivative, naphthacene, and pentacene is included. In addition, as the structure of the TFT, for example, a staggered type TFT, a reverse staggered type TFT, a top gate type TFT, a coplanar type TFT, and the like are included.

As the forming method of the active layer configuring the TFT, (1) a method in which amorphous silicon which is formed by a plasma induced chemical vapor deposition (PECVD) method is ion-doped with impurities, (2) a method in which amorphous silicon is formed by a depressurization chemical vapor deposition (LPCVD) method using silane (SiH₄) gas, the amorphous silicon is crystallized by a solid phase growth method, and thus a polysilicon is obtained, and then is ion-doped by an ion implantation method, (3) a method in which amorphous silicon is formed by a LPCVD method using Si₂H₆ gas or PECVD method using SiH₄ gas, is annealed by laser such as excimer laser, the amorphous silicon is crystallized, and thus polysilicon is obtained, and then is ion-doped (a low temperature process), (4) a method in which a polysilicon layer is formed by a LPCVD method or a PECVD method, a gate insulating film is formed by performing thermal oxidation at a temperature of higher than or equal to 1000° C., a gate electrode of n⁺ polysilicon is formed thereon, and then is ion-doped (a high temperature process), (5) a method in which an organic semiconductor material is formed by an ink jet method or the like, (6) a method in which a single-crystal film of an organic semiconductor material is obtained, and the like are included.

A gate insulating film configuring the TFT of this embodiment is able to be formed by using a known material. As the gate insulating film, for example, an insulating film formed of SiO₂ which is formed by a PECVD method, a LPCVD method, or the like, SiO₂ which is obtained by thermally oxidizing a polysilicon film, or the like is included.

In addition, a signal electrode line, a scanning electrode line, a common electrode line, a first driving electrode, and a second driving electrode of the TFT of this embodiment are able to be formed by using a known material. As the material of the signal electrode line, the scanning electrode line, the common electrode line, the first driving electrode, and the second driving electrode, for example, tantalum (Ta), aluminum (Al), copper (Cu), and the like are included. The TFT of the organic EL element substrate 210 is able to be configured as described above, but this embodiment is not limited to the material, the structure, and the forming method.

An insulating interlayer which is able to be used in the active driving type organic EL display device and the organic EL display device is able to be formed by using a known material. As the material of the insulating interlayer, for example, an inorganic material such as silicon oxide (SiO₂), silicon nitride (SiN or Si₂N₄), and tantalum oxide (TaO or Ta₂O₅), an organic material such as an acrylic resin, and a resist material, or the like is included.

In addition, as the forming method of the insulating interlayer, a dry process such as a chemical vapor deposition (CVD) method, and a vacuum vapor deposition method, and a wet process such as a spin coat method are included. In addition, as necessary, the insulating interlayer is able to be patterned by a photolithography method or the like.

When the emitted light from the organic EL element 212 is extracted from a side (the second electrode 215 side) opposite to the substrate 211, outside light is incident on the TFT formed on the one surface 211a of the substrate 211, and thus it is preferable that a light shielding insulating film having light shielding properties is formed in order to prevent a change from occurring in properties of the TFT. In addition, the insulating interlayer described above and the light shielding insulating film are able to be combined. As the material of the light shielding insulating film, for example, a material in which a dye or a colorant such as phthalocyanine, and quinacridone is dispersed in a high molecular resin such as a polyimide, a color resist, black matrix material, an inorganic insulating material such as NiₓZn_{y}Fe₂O₄, and the like are included, but this embodiment is not limited to the material and the forming method.

In the active driving type organic EL display device, when the TFT or the like is formed on the one surface 211a of the substrate 211, concavities and convexities are formed in the front surface, and a defect in the organic EL element 212 (for example, a deficit in the pixel electrode, a deficit in the organic EL layer, disconnection of the second electrode, short circuit between the first electrode and the second electrode, a decrease in pressure resistance, or the like), or the like occurs due to the concavities and convexities. In order to prevent these defects, a planarizing film may be disposed on the insulating interlayer.

The planarizing film is able to be formed by using a known material. As the material of the planarizing film, for example, an inorganic material such as silicon oxide, silicon nitride, and tantalum oxide, an organic material such as a polyimide, an acrylic resin, and a resist material, and the like are included. As the forming method of the planarizing film, for example, a dry process such as a CVD method, and a vacuum vapor deposition, a wet process such as a spin coat method, and the like are included, but this embodiment is not limited to the material and the forming method. In addition, the planarizing film may have either a single-layer structure or a multi-layer structure.

The first electrode 213 and the second electrode 215 function as the positive electrode or the negative electrode of the organic EL element 212 in pairs. That is, when the first electrode 213 is the positive electrode, the second electrode 215 is the negative electrode, and when the first electrode 213 is the negative electrode, the second electrode 215 is the positive electrode.

As an electrode material forming the first electrode 213 and the second electrode 215, a known electrode material is able to be used. As an electrode material forming the positive electrode, metal such as gold (Au), platinum (Pt), and nickel (Ni) of which a work function is greater than or equal to 4.5 eV, and a transparent electrode material such as oxide (ITO) formed of indium (In) and tin (Sn), oxide (SnO₂) of tin (Sn), and oxide (IZO) formed of indium (In) and zinc (Zn), and the like are included, from a viewpoint of more efficiently injecting a hole to the organic EL layer 214.

In addition, as an electrode material forming the negative electrode, metal such as lithium (Li), calcium (Ca), cerium (Ce), barium (Ba), and aluminum (Al) of which a work function is less than or equal to 4.5 eV, or an alloy such as a Mg:Ag alloy, a Li:Al alloy, or the like containing these metals is included, from a viewpoint of more efficiently injecting a hole to the organic EL layer 214.

The first electrode 213 and the second electrode 215 are able to be formed by using the material described above and by using a known method such as an EB deposition method, a sputtering method, an ion plating method, a resistive heating deposition method, but this embodiment is not limited to the forming method. In addition, as necessary, the formed electrode is able to be patterned by a photolithography method, and a laser peeling method, and a directly patterned electrode is able to be formed by being combined with a shadow mask.

It is preferable that a film thickness of the first electrode 213 and the second electrode 215 is greater than or equal to 50 nm.

When the film thickness is less than 50 nm, wiring resistance increases, and a driving voltage increases.

In a case where a microcavity effect is used in order to improve color purity of the display device, to improve light emitting efficiency, and to improve front luminance, when the emitted light from the organic EL layer 214 is extracted from the first electrode 213 side or the second electrode 215 side, it is preferable that a semi-transparent electrode is used as the first electrode 213 or the second electrode 215.

As the material of the semi-transparent electrode, a metal semi-transparent electrode single body, or a combination of a metal semi-transparent electrode and the transparent electrode material are able to be used. In particular, as the material of the semi-transparent electrode, silver is preferable from a viewpoint of a reflectance ratio and a transmission factor.

It is preferable that a film thickness of the semi-transparent electrode is 5 nm to 30 nm. When the film thickness of the semi-transparent electrode is less than 5 nm, the light is not sufficiently reflected, and an interference effect is not able to be sufficiently obtained. In addition, when the film thickness of the semi-transparent electrode is greater than 30 nm, the transmission factor of the light rapidly decreases, and thus luminance and light emitting efficiency of the display device decrease.

In addition, it is preferable that an electrode having a high reflectance ratio of reflecting the light is used as the first electrode 213 or the second electrode 215. As the electrode having a high reflectance ratio, for example, a reflective metal electrode (a reflective electrode) formed of aluminum, silver, gold, an aluminum-lithium alloy, an aluminum-neodymium alloy, an aluminum-silicon alloy, and the like, an electrode in which the reflective metal electrode and a transparent electrode are combined, and the like are included.

A charge injection transport layer is classified into a charge injection layer (the hole injection layer 216, and the electron injection layer 221) and a charge transport layer (the hole transport layer 217, and the electron transport layer 220) in order to efficiently inject a charge (a hole, and an electron) from the electrode and to efficiently transport (inject) the charge (the hole, and the electron) to the light emitting layer, and may be configured of only the following charge injection transport material, may arbitrarily include an additive agent (a donor, an acceptor, or the like), or may have a configuration in which the material is disposed in a high molecular material (a binder resin) or in an inorganic material.

As the charge injection transport material, a known charge injection transport material for an organic EL element, and a known charge injection transport material for an organic photoconductor are able to be used. The charge injection transport material is classified into a hole injection transport material and an electron injection transport material, and a specific compound thereof will be exemplified later, but this embodiment is not limited to the material.

As the material of the hole injection layer 216 and the hole transport layer 217, a known material is used, and for example, oxide such as vanadium oxide (V₂O₅), and molybdenum oxide (MoO₂) or an inorganic p-type semiconductor material; an aromatic tertiary amine compound such as a porphyrin compound, N,N′-bis(3-methylphenyl)-N,N′-bis(phenyl)-benzidine (TPD), N,N′-di(naphthalene-1-yl)-N,N′-diphenyl-benzidine (α-NPD), 4,4′,4″-tris(carbazole-9-yl)triphenylamine (TCTA), N,N-dicarbazolyl-3,5-benzene (m-CP), 4,4′-(cyclohexane-1,1-diyl)bis(N,N-di-p-tolyl aniline) (TAPC), 2,2′-bis(N,N-diphenylamine)-9,9′-spirobifluorene (DPAS), N1,N1′-(biphenyl-4,4′-diyl)bis(N1-phenyl-N4,N4-di-m-tolyl benzene-1,4-diamine) (DNTPD), N3,N3,N3′″, N3′″-tetra-p-tolyl-[1,1′:2′,1″:2″,1′″-quarter phenyl]-3,3′″-diamine (BTPD), 4,4′-(diphenylsilane diyl)bis(N,N-di-p-tolyl aniline) (DTASi), and 2,2-bis(4-carbazole-9-yl phenyl) adamantine (Ad-Cz); a low molecular nitrogen containing compound such as a hydrazone compound, a quinacridone compound, and a styryl amine compound; a high molecular compound such as polyaniline (PANI), polyaniline-camphor sulfonic acid (PANI-CSA), 3,4-polyethylene dioxythiophene/polystyrene sulfoxide (PEDOT/PSS), a poly(triphenylamine) derivative (Poly-TPD), polyvinyl carbazole (PVCz), poly(p-phenylene vinylene)(PPV), and poly(p-naphthalenevinylene)(PNV); an aromatic hydrocarbon compound such as 2-methyl-9,10-bis(naphthalene-2-yl) anthracene (MADN), and the like are included.

As the material of the hole injection layer 216, a material of which an energy level on the highest occupied molecular orbital (HOMO) is lower than that of the material of the hole transport layer 217 is preferably used from a viewpoint of efficiently performing injection and transport with respect to the hole from the positive electrode. In addition, as the material of the hole transport layer 217, a material of which mobility of the hole is higher than that of the material of the hole injection layer 216 is preferable used.

The hole injection layer 216 and the hole transport layer 217 may arbitrarily include an additive agent (a donor, an acceptor, or the like).

Then, in order to further improve injection properties and the transport properties of the hole, it is preferable that the hole injection layer 216 and the hole transport layer 217 include an acceptor. As the acceptor, a known acceptor material for an organic EL element is able to be used. A specific compound thereof will be exemplified later, but this embodiment is not limited to the material.

The acceptor may be either an inorganic material or an organic material.

As the inorganic material, gold (Au), platinum (Pt), tungsten (W), iridium (Ir), phosphorus oxychloride (POCl₃), arsenic hexafluoride ion (AsF₆⁻), chlorine (Cl), bromine (Br), iodine (I), vanadium oxide (V₂O₅), molybdenum oxide (MoO₂), and the like are included.

As the organic material, a compound having a cyano group such as 7,7,8,8,-tetracyanoquinodimethane (TCNQ), tetrafluoro tetracyanoquinodimethane (TCNQF₄), tetracyanoethylene (TCNE), hexacyanobutadiene (HCNB), and dicyclodicyanobenzoquinone (DDQ); a compound having a nitro group such as trinitrofluorenone (TNF), and dinitrofluorenone (DNF); fluoranil; chloranil; bromanil, and the like are included.

Among them, a compound having a cyano group such as TCNQ, TCNQF₄, TCNE, HCNB, and DDQ is preferably used since an effect of increasing a hole concentration is higher.

As the material of the hole prevention layer 219, the electron transport layer 220, and the electron injection layer 221, a known material is used, and an inorganic material which is an n-type semiconductor; an oxadiazole derivative such as 1,3-bis[2-(2,2′-bipyridine-6-yl)-1,3,4-oxadiazo-5-yl]benzene (Bpy-OXD), and 1,3-bis(5-(4-(tert-butyl)phenyl)-1,3,4-oxadiazole-2-yl)benzene (OXD7); a triazole derivative such as 3-(4-biphenyl)-4-phenyl-5-tert-butyl phenyl-1,2,4-triazole (TAZ); a thiopyrazine dioxide derivative; a benzoquinone derivative; a naphthoquinone derivative; an anthraquinone derivative; a diphenoquinone derivative; a fluorenone derivative; a benzodifuran derivative; a quinoline derivative such as 8-hydroxyquinolinolate-lithium (Liq); a fluorene derivative such as 2,7-bis[2-(2,2′-bipyridine-6-yl)-1,3,4-oxadiazo-5-yl]-9,9-dimethyl fluorene (Bpy-FOXD); a benzene derivative such as 1,3,5-tri[(3-pyridyl)-phene-3-yl]benzene (TmPyPB), and 1,3,5-tri[(3-pyridyl)-phene-3-yl]benzene (TpPyPB); a benzoimidazole derivative such as 2,2′,2″-(1,3,5-benzene triyl)-tris(1-phenyl-1-H-benzoimidazole) (TPBI); a pyridine derivative such as 3,5-di(pylene-1-yl)pyridine (PY1); a biphenyl derivative such as 3,3′,5,5′-tetra[(m-pyridyl)-phene-3-yl]biphenyl (BP4mPy); a phenanthroline derivative such as 4,7-diphenyl-1,10-phenanthroline (BPhen), and 2,9-dimethyl-4,7-diphenyl-1,10-phenanthroline (BCP); a triphenyl borane derivative such as tris(2,4,6-trimethyl-3-(pyridine-3-yl)phenyl) borane (3TPYMB); a tetraphenyl silane derivative such as diphenyl bis(4-(pyridine-3-yl)phenyl) silane (DPPS); poly(oxadiazole) (Poly-OXZ), a polystyrene derivative (PSS), and the like are included when the material is a low molecular material. In particular, as the material of the electron injection layer 221, fluoride such as lithium fluoride (LiF), barium fluoride (BaF₂); oxide such as lithium oxide (Li₂O), and the like are included.

As the material of the electron injection layer 221, a material of which an energy level on the lowest occupied molecular orbital (LUMO) is higher than that of the material of the electron transport layer 220 is preferably used from a viewpoint of efficiently performing injection and transport with respect to the electron from the negative electrode. In addition, as the material of the electron transport layer 220, a material of which mobility of the electron is higher than that of the material of the electron injection layer 221 is preferably used.

The electron transport layer 220 and the electron injection layer 221 may arbitrarily include an additive agent (a donor, an acceptor, or the like).

Then, in order to further improve injection properties and the transport properties of the electron, it is preferable that the electron transport layer 220 and the electron injection layer 221 include a donor. As the donor, a known donor material for an organic EL element is able to be used. A specific compound thereof will be exemplified later, but this embodiment is not limited to the material.

The donor may be either an inorganic material or an organic material. As the inorganic material, alkali metal such as lithium, sodium, and potassium; alkali earth metal such as magnesium, and calcium; a rare earth element; aluminum (Al); silver (Ag); copper (Cu); indium (In), and the like are included.

As the organic material, a compound having an aromatic tertiary amine skeleton, a polycyclic condensed compound which may have a substituent such as phenanthrene, pylene, perylene, anthracene, tetracene, and pentacene, tetrathiafulvalenes (TTF), dibenzofuran, phenothiazine, carbazole, and the like are included.

As the compound having an aromatic tertiary amine skeleton, anilines; phenylene diamines; benzidines such as N,N,N′,N′-tetraphenyl benzidine, N,N′-bis-(3-methylphenyl)-N,N′-bis-(phenyl)-benzidine, and N,N′-di(naphthalene-1-yl)-N,N′-diphenyl-benzidine; triphenylamines such as triphenylamine, 4,4′4″-tris(N,N-diphenyl-amino)-triphenylamine, 4,4′4″-tris(N-3-methylphenyl-N-phenyl-amino)-triphenylamine, and 4,4′4″-tris(N-(1-naphthyl)-N-phenyl-amino)-triphenylamine; triphenyldiamines such as N,N′-di-(4-methyl-phenyl)-N,N′-diphenyl-1,4-phenylene diamine, and the like are included.

“The polycyclic condensed compound has a substituent” indicates that one or more hydrogen atoms in a polycyclic condensed compound is substituted by a group (a substituent) other than a hydrogen atom, the number of substituents is not particularly limited, and all of the hydrogen atoms may be substituted by a substituent. Then, the position of the substituent is not particularly limited.

As the substituent, an alkyl group having carbon atoms of 1 to 10, an alkoxy group having carbon atoms of 1 to 10, an alkenyl group having carbon atoms of 2 to 10, an alkenyl oxy group having carbon atoms of 2 to 10, an aryl group having carbon atoms of 6 to 15, an aryl oxy group having carbon atoms of 6 to 15, a hydroxyl group, a halogen atom, and the like are included.

The alkyl group may be in any shape of a straight chain, a branched chain, or a circle.

As the alkyl group in the shape of a straight chain or a branched chain, a methyl group, an ethyl group, an n-propyl group, an isopropyl group, an n-butyl group, an isobutyl group, a sec-butyl group, a tert-butyl group, an n-pentyl group, an isopentyl group, a neopentyl group, a tert-pentyl group, a 1-methylbutyl group, an n-hexyl group, a 2-methylpentyl group, a 3-methylpentyl group, a 2,2-dimethylbutyl group, a 2,3-dimethylbutyl group, an n-heptyl group, a 2-methylhexyl group, a 3-methylhexyl group, a 2,2-dimethyl pentyl group, a 2,3-dimethyl pentyl group, a 2,4-dimethyl pentyl group, a 3,3-dimethyl pentyl group, a 3-ethyl pentyl group, a 2,2,3-trimethylbutyl group, an n-octyl group, an isooctyl group, a nonyl group, a decyl group, and the like are included.

The alkyl group in the shape of a circle may be in the shape of either a single-circle or a multi-circle, a cyclopropyl group, a cyclobutyl group, a cyclopentyl group, a cyclohexyl group, a cycloheptyl group, a cyclooctyl group, a cyclononyl group, a cyclodecyl group, a norbornyl group, isobornyl group, a 1-adamantyl group, a 2-adamantyl group, a tricyclodecyl group, and the like are included.

As the alkoxy group, a monovalent group is included in which an alkyl group is bonded to an oxygen atom.

As the alkenyl group, an alkenyl group is included in which one single-bond (C—C) between carbon atoms is substituted by a double bond (C═C) in the alkyl group having carbon atoms of 2 to 10. As the alkenyl oxy group, a monovalent group is included in which an alkenyl group is bonded to an oxygen atom.

The aryl group may be in the shape of either a single-circle or a multi-circle, but the number of circles is not particularly limited, and a phenyl group, a 1-naphthyl group, a 2-naphthyl group, and the like are preferably included. As the aryl oxy group, a monovalent group is included in which an aryl group is bonded to an oxygen atom. As the halogen atom, a fluorine atom, a chlorine atom, a bromine atom, an iodine atom, and the like are included.

Among them, as the donor, the compound having an aromatic tertiary amine skeleton, the polycyclic condensed compound which may have a substituent, and the alkali metal are preferable since an effect of increasing electron concentration is higher.

The light emitting layer 218 may be configured of only the following organic light emitting material, may be configured by combining a light emitting dopant and a host material, or may arbitrarily include a hole transport material, an electron transport material, an additive agent (a donor, an acceptor, or the like), and the like. In addition, each of these materials may be dispersed in a high molecular material (a binder resin) or an inorganic material. From a viewpoint of light emitting efficiency and durability, it is preferable that the material of the light emitting layer 218 is a material in which the light emitting dopant is dispersed in the host material.

As the organic light emitting material, a known light emitting material for an organic EL element is able to be used.

The light emitting material is classified into a low molecular light emitting material, a high molecular light emitting material, or the like, and a specific compound will be exemplified later, but this embodiment is not limited to the material.

As the low molecular light emitting material (including the host material) used in the light emitting layer 218, an aromatic dimethylidene compound such as 4,4′-bis(2,2′-diphenyl vinyl)-biphenyl (DPVBi); an oxazole compound such as 5-methyl-2-[2-[4-(5-methyl-2-benzooxazolyl)phenyl]vinyl]benzoxazole; a triazole derivative such as 3-(4-biphenyl)-4-phenyl-5-t-butyl phenyl-1,2,4-triazole (TAZ); a styryl benzene compound such as 1,4-bis(2-methylstyryl)benzene; a fluorescent organic material such as a thiopyrazine dioxide derivative, a benzoquinone derivative, a naphthoquinone derivative, an anthraquinone derivative, a diphenoquinone derivative, and a fluorenone derivative; a fluorescent light emitting organic metal complex such as an azomethine zinc complex, and a (θ-hydroxyquinolinato) aluminum complex (Alq₃); a BeBq(bis(benzoquinolinolato) beryllium complex); 4,4′-bis-(2,2-di-p-tolyl-vinyl)-biphenyl (DTVBi); tris(1,3-diphenyl-1,3-propanedione) (monophenanthroline) Eu(III) (Eu(DBM)₃(Phen)); a diphenylethylene derivative; a triphenylamine derivative such as tris[4-(9-phenylfluorene-9-yl)phenyl]amine (TFTPA); a diaminocarbazole derivative; a bisstyryl derivative; an aromatic diamine derivative; a quinacridone-based compound; a perylene-based compound; a coumarin-based compound; a distyryl arylene derivative (DPVBi); oligothiophene derivative (BMA-3T); a silane derivative such as 4,4′-di(triphenyl silyl)-biphenyl(BSB), diphenyl-di(o-tolyl) silane (UGH1), 1,4-bistriphenyl silyl benzene (UGH2), 1,3-bis(triphenyl silyl)benzene (UGH3), and triphenyl-(4-(9-phenyl-9H-fluorene-9-yl)phenyl) silane (TPSi—F); a carbazole derivative such as 9,9-di(4-dicarbazole-benzyl) fluorene (CPF), 3,6-bis(triphenylsilyl) carbazole (mCP), 4,4′-bis(carbazole-9-yl) biphenyl (CBP), 4,4′-bis(carbazole-9-yl)-2,2′-dimethyl biphenyl (CDBP), N,N-dicarbazolyl-3,5-benzene (m-CP), 3-(diphenyl phosphoryl)-9-phenyl-9H-carbazole (PPO1), 3,6-di(9-carbazolyl)-9-(2-ethyl hexyl) carbazole (TCz1), 9,9′-(5-(triphenyl silyl)-1,3-phenylene)bis(9H-carbazole) (SimCP), bis(3,5-di(9H-carbazole-9-yl)phenyl)diphenyl silane (SimCP2), 3-(diphenyl phosphoryl)-9-(4-diphenyl phosphoryl)phenyl)-9H-carbazole (PPO21), 2,2-bis(4-carbazolyl phenyl)-1,1-biphenyl (4CzPBP), 3,6-bis(diphenyl phosphoryl)-9-phenyl-9H-carbazole (PPO2), 9-(4-tert-butyl phenyl)-3,6-bis(triphenyl silyl)-9H-carbazole (CzSi), 3,6-bis[(3,5-diphenyl)phenyl]-9-phenyl-carbazole (CzTP), 9-(4-tert-butyl phenyl)-3,6-ditrityl-9H-carbazole (CzC), 9-(4-tert-butyl phenyl)-3,6-bis(9-(4-methoxy phenyl)-9H-fluorene-9-yl)-9H-carbazole (DFC), 2,2′-bis(4-carbazole-9-yl)phenyl)-biphenyl (BCBP), and 9,9′-((2,6-diphenylbenzo[1,2-b:4,5-b′]difuran-3,7-diyl)bis(4,1-phenylene))bis(9H-carbazole) (CZBDF); an aniline derivative such as 4-(diphenyl phosphoyl)-N,N-diphenyl aniline (HM-A1); a fluorene derivative such as 1,3-bis(9-phenyl-9H-fluorene-9-yl)benzene (mDPFB), 1,4-bis(9-phenyl-9H-fluorene-9-yl)benzene (pDPFB), 2,7-bis(carbazole-9-yl)-9,9-dimethyl fluorene (DMFL-CBP), 2-[9,9-di(4-methylphenyl)-fluorene-2-yl]-9,9-di(4-methylphenyl) fluorene (BDAF), 2-(9,9-spirobifluorene-2-yl)-9,9-spirobifluorene (BSBF), 9,9-bis[4-(pyrenyl)phenyl]-9H-fluorene (BPPF), 2,2′-dipyrenyl-9,9-spirobifluorene (Spiro-Pye), 2,7-dipyrenyl-9,9-spirobifluorene (2,2′-Spiro-Pye), 2,7-bis[9,9-di(4-methyl phenyl)-fluorene-2-yl]-9,9-di(4-methyl phenyl) fluorene (TDAF), 2,7-bis(9,9-spirobifluorene-2-yl)-9,9-spirobifluorene (TSBF), and 9,9-spirobifluorene-2-yl-diphenyl-phosphine oxide (SPPO1); a pylene derivative such as 1,3-di(pylene-1-yl)benzene (m-Bpye); a benzoate derivative such as propane-2,2′-diylbis(4,1-phenylene)dibenzoate (MMA1); a phosphine oxide derivative such as 4,4′-bis(diphenyl phosphine oxide)biphenyl (PO1), 2,8-bis(diphenyl phosphoryl)dibenzo[b,d]thiophene (PPT); a terphenyl derivative such as 4,4″-di(triphenyl silyl)-p-terphenyl (BST); a triazine derivative such as 2,4-bis(phenoxy)-6-(3-methyldiphenylamino)-1,3,5-triazine (BPMT), and the like are included.

As the high molecular light emitting material used in the light emitting layer 218, a polyphenylene vinylene derivative such as poly(2-decyl oxy-1,4-phenylene) (DO-PPP), poly[2,5-bis-[2-(N,N,N-triethyl ammonium)ethoxy]-1,4-phenyl-altho-1,4-phenylene]dibromide (PPP-NEt³⁺), poly[2-(2′-ethyl hexyl oxy)-5-methoxy-1,4-phenylene vinylene] (MEH-PPV), poly[5-methoxy-(2-propaneoxy sulfonide)-1,4-phenylene vinylene] (MPS-PPV), and poly[2,5-bis-(hexyl oxy)-1,4-phenylene-(1-cyanovinylene)] (CN-PPV); a polyspiro derivative such as poly(9,9-dioctyl fluorene) (PDAF); a carbazole derivative such as poly(N-vinyl carbazole) (PVK), and the like are included.

It is preferable that the organic light emitting material is the low molecular light emitting material, and it is preferable to use a phosphorescent material having high light emitting efficiency from a viewpoint of low power consumption.

As the light emitting dopant used in the light emitting layer 218, a known dopant for an organic EL element is able to be used. As the dopant, a fluorescent light emitting material such as p-quarter phenyl, 3,5,3,5-tetra-tert-butyl sexyphenyl, and 3,5,3,5-tetra-tert-butyl-p-quinqphenyl, and the like are included when the material is a ultraviolet light emitting material. In addition, a fluorescent light emitting material such as a styryl derivative; a phosphorescent light emitting organic metal complex such as bis[(4,6-difluoro phenyl)-pyridinato-N,C2′] picolinate iridium (III) (FIrpic), and bis(4′,6′-difluoro phenylpolydinato)tetrakis(1-pyrazole) borate iridium (III)(FIr6), and the like are included when the material is a blue light emitting material. In addition, a phosphorescent light emitting organic metal complex such as tris(2-phenyl pyridinate) iridium (Ir(ppy)₃), and the like are included when the material is a green light emitting material.

Furthermore, the material of each layer configuring the organic EL layer 214 is described, and for example, the host material is also able to be used as the hole transport material or the electron transport material, and the hole transport material and the electron transport material are also able to be used as the host material.

As the forming method of each of the hole injection layer 216, the hole transport layer 217, the light emitting layer 218, the hole prevention layer 219, the electron transport layer 220, and the electron injection layer 221, a known wet process, a known dry process, and a known laser transfer method, and the like are used.

As the wet process, a coating method such as a spin coating method, a dipping method, a doctor blade method, a discharge coat method, and a spray coat method; a printing method such as an ink jet method, a letterpress printing method, an intaglio printing method, a screen printing method, and a microgravure coat method, and the like which use a liquid dissolved or dispersed in the material configuring each layer described above are included.

The liquid used in the coating method or the printing method may include an additive agent for adjusting physical properties of the liquid such as a leveling agent, and a viscosity adjusting agent.

As the dry process, a resistive heating deposition method, an electron beam (EB) deposition method, a molecular beam epitaxy (MBE) method, a sputtering method, an organic vapor deposition (OVPD) method, and the like are used which use the material configuring each layer described above.

The film thickness of each of the hole injection layer 216, the hole transport layer 217, the light emitting layer 218, the hole prevention layer 219, the electron transport layer 220, and the electron injection layer 221 is approximately 1 nm to 1000 nm, and it is preferable that the thickness is 10 nm to 200 nm. When the film thickness is less than 10 nm, physical properties (injection properties, transport properties, and confinement properties of the charge) which are originally required are not obtained. In addition, a pixel defect due to foreign substances such as dust occurs. In contrast, when the film thickness is greater than 200 nm, a driving voltage is increased by a resistance component of the organic EL layer 214, and as a result thereof, power consumption increases.

The edge cover 222 is able to be formed by a known method such as an EB deposition method, a sputtering method, an ion plating method, and a resistive heating deposition method using an insulating material, is able to be patterned by using a photolithography method of a known dry method or a known wet method, but this embodiment is not limited to the forming method.

In addition, as the insulating material configuring the edge cover 222, a known material is used, and in this embodiment, the insulating material is not particularly limited.

It is necessary that the edge cover 222 transmits the light, and thus as the insulating material configuring the edge cover 222, for example, SiO, SiON, SiN, SiOC, SiC, HfSiON, ZrO, HfO, LaO, and the like are included.

It is preferable that a film thickness of the edge cover 222 is 100 nm to 2000 nm. When the film thickness is less than 100 nm, insulating properties are not sufficient, leakage occurs between the first electrode 213 and the second electrode 215, and thus an increase in power consumption and non-light emission are caused. In contrast, when the film thickness is greater than 2000 nm, it take a long time for a film forming process, and thus a decrease in productive efficiency and disconnection of the second electrode 215 due to the edge cover 222 are caused.

Here, it is preferable that the organic EL element 212 has a microcavity structure (an optical microresonator structure) due to an interference effect between the first electrode 213 and the second electrode 215, or a microcavity structure (an optical microresonator structure) due to a dielectric multi-layer film. When the microresonator structure is configured by the first electrode 213 and the second electrode 215, the emitted light of the organic EL layer 214 is able to be focused in a front direction (a light extraction direction) due to the interference effect between the first electrode 213 and the second electrode 215. At this time, the emitted light of the organic EL layer 214 is able to have directional properties, and thus it is possible to decrease light emission loss which escapes to the surroundings, and it is possible to increase light emitting efficiency thereof. Accordingly, it is possible to more efficiently propagate light emitting energy generated by the organic EL layer 214 to the fluorescent layer, and it is possible to increase front luminance of the display device.

In addition, a light emitting spectrum of the organic EL layer 214 is able to be adjusted by the interference effect between the first electrode 213 and the second electrode 215, and is able to be adjusted to be a desired light emitting peak wavelength and a desired half-value width. Accordingly, it is possible to control the light emitting spectrum of the organic EL layer 214 such that the light emitting spectrum is a spectrum which is effectively excited by a red fluorescent body and a green fluorescent body, and it is possible to improve color purity of a blue pixel.

In addition, the display device of this embodiment is electrically connected to an external driving circuit (a scanning line electrode circuit, a data signal electrode circuit, a power source circuit).

Here, as the substrate 211 configuring the organic EL element substrate 210, a substrate is used in which an insulating material is applied onto a glass substrate, a substrate is more preferably used in which an insulating material is applied on to a metal substrate or a plastic substrate, and a substrate is further preferably used in which an insulating material is applied onto a metal substrate or a plastic substrate.

In addition, the display device of this embodiment may drive the organic EL element substrate 210 by directly connecting to an external circuit, or may a switching circuit such as a TFT may be arranged in a pixel and an external driving circuit for driving the organic EL element substrate 210 (a scanning line electrode circuit (a source driver), a data signal electrode circuit (a gate driver), and a power source circuit) may be electrically connected to wiring to which TFT or the like is connected.

In this embodiment, it is preferable that a color filter is disposed between the fluorescent substrate and the organic EL element substrate 210. As the color filter, a color filter of the related art is able to be used.

Thus, by disposing the color filter, it is possible to increase color purity of a red pixel, a green pixel, and a blue pixel, and it is possible to widen a color reproduction range of the display device. In addition, a blue color filter formed on a blue fluorescent layer, a green color filter formed on a green fluorescent layer, and a red color filter formed on a red fluorescent layer absorb an excited light component included in the outside light, and thus it is possible to reduce or prevent the light emission of the fluorescent layer due to the outside light, and it is possible to reduce or prevent a decrease in contrast.

Further, it is possible to prevent the excited light which is not absorbed by the fluorescent layer and is transmitted from being leaked to the outside by the blue color filter formed on the blue fluorescent layer, the green color filter formed on the green fluorescent layer, and the red color filter formed on the red fluorescent layer, and thus it is possible to prevent a decrease in color purity of the display due to a mixed color of the emitted light from the fluorescent layer and the excited light.

According to the display device of this embodiment, it is possible to realize an excellent display device in which brightness is not changed in any viewing direction, color is not changed in any viewing direction, and low power consumption is able to be obtained.

### (2) Second Embodiment

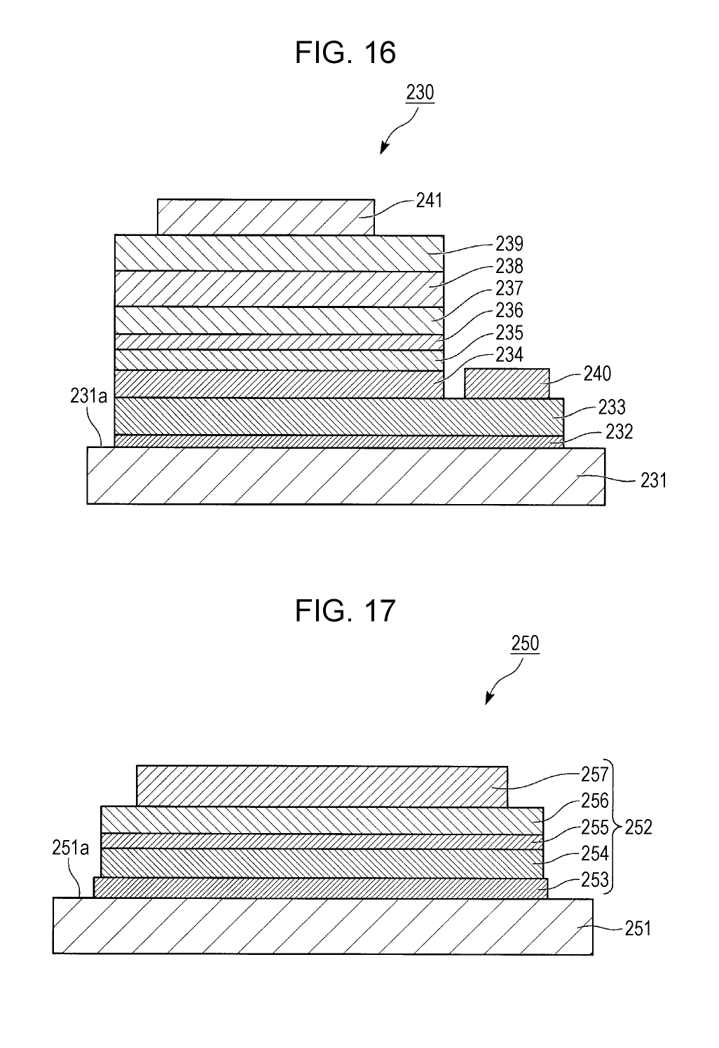

FIG. 16 us a schematic sectional view illustrating a LED element substrate configuring a display device according to a second embodiment.

The display device of this embodiment is schematically configured of the fluorescent substrate formed of a substrate on which the fluorescent layer, the particles having light scattering properties, the partition wall, the light absorptive layer, and the like of the light emitting device according to the first embodiment to the eleventh embodiment described above are formed, and a LED substrate (a light source) 230 which is bonded to the fluorescent substrate with a planarizing film or the like in between.

The LED substrate 230 is schematically configured of a substrate 231, a first buffer layer 232, an n-type contact layer 233, a second n-type clad layer 234, a first n-type clad layer 235, an active layer 236, a first p-type clad layer 237, a second p-type clad layer 238, and a second buffer layer 239 which are laminated on the one surface 211a of the substrate 211 in this order, a negative electrode 240 formed on the n-type contact layer 233, and a positive electrode 241 formed on the second buffer layer 239.

Furthermore, as the LED, other known LEDs, for example, a ultraviolet light emitting inorganic LED, a blue light emitting inorganic LED, and the like are able to be used, a specific configuration is not limited to that described above.

Hereinafter, each constituent of the LED substrate 230 will be specifically described.

The active layer 236 is a layer performing light emission by recoupling of an electron and a hole, and as an active layer material, a known active layer material for a LED is able to be used. As the active layer material, for example, as the ultraviolet active layer material, AlGaN, InAlN, InₐAl_{b}Ga_{1-a-b}N (0≦a, 0≦b, a+b≦1) is included, and as the blue active layer material, In_{z}Ga_{1-z}N (0<z<1) or the like is included, but this embodiment is not limited thereto.

In addition, as the active layer 236, an active layer having a single quantum well structure or a multiple quantum well structure is used. The active layer having a quantum well structure may be either an n-type active layer or a p-type active layer, and in particular, it is preferable to use a non-doped (free of impurities) active layer since a half-value width of a light emitting wavelength is narrowed due to interband light emission, and emitted light having excellent color purity is able to be obtained.

In addition, the active layer 236 may be doped with at least one of donor impurities or acceptor impurities. When crystalline properties of the active layer which is doped with the donor impurities are identical to those of the active layer which is not doped with the donor impurities, it is possible to further increase interband light emitting intensity by doping the active layer with the donor impurities compared to the non-doped active layer. When the active layer is doped with the acceptor impurities, it is possible to shift a peak wavelength to a low energy side by approximately 0.5 eV compared to a peak wavelength of the interband light emission, but the half-value width is widened. When the active layer is doped with both of the acceptor impurities and the donor impurities, it is possible to further increase light emitting intensity compared to the light emitting intensity of the active layer which is doped with only the acceptor impurities. In particular, when the active layer doped with the acceptor impurities is formed, it is preferable that conductivity of the active layer is n-type conductivity by doping the active layer with the donor impurities such as Si.

As the second n-type clad layer 234 and the first n-type clad layer 235, a known n-type clad layer material for a LED is able to be used, and the second n-type clad layer 234 and the first n-type clad layer 235 may have a single-layer configuration or a multi-layer configuration. When the second n-type clad layer 234 and the first n-type clad layer 235 are configured of an n-type semiconductor of which bandgap energy is greater than that of the active layer 236, a potential partition wall with respect to a hole is able to be formed between the second n-type clad layer 234 and the first n-type clad layer 235, and the active layer 236, and it is possible to confine the hole to the active layer 236. For example, it is possible to form the second n-type clad layer 234 and the first n-type clad layer 235 by n-type InₓGa₁₋ₓN (0≦x<1), but this embodiment is not limited thereto.

As the first p-type clad layer 237 and the second p-type clad layer 238, a known p-type clad layer material for a LED is able to be used, and the first p-type clad layer 237 and the second p-type clad layer 238 may have a single-layer configuration or a multi-layer configuration. When the first p-type clad layer 237 and the second p-type clad layer 238 are configured of a p-type semiconductor of which bandgap energy is greater than that of the active layer 236, a potential partition wall with respect to an electron is able to be formed between the first p-type clad layer 237 and the second p-type clad layer 238, and the active layer 236, and it is possible to confine the electron to the active layer 236. For example, it is possible to form the first p-type clad layer 237 and the second p-type clad layer 238 by Al_{y}Ga_{1-y}N (0≦y≦1), but this embodiment is not limited thereto.

As the n-type contact layer 233, a known contact layer material for a LED is able to be used, and for example, as a layer forming an electrode in contact with the second n-type clad layer 234 and the first n-type clad layer 235, the n-type contact layer 233 of n-type GaN is able to be formed. In addition, as a layer forming an electrode in contact with the first p-type clad layer 237 and the second p-type clad layer 238, a p-type contact layer of p-type GaN is able to be formed. However, when the second n-type clad layer 234, and the second p-type clad layer 238 are formed of GaN, it is not particularly necessary to form the p-type contact layer, and it is possible to form the second clad layer (the second n-type clad layer 234, and the second p-type clad layer 238) as the contact layer.

As the forming method of each layer described above which is used in this embodiment, a known film forming process for a LED is able to be used, but this embodiment is not particularly limited thereto. For example, each layer is able to be formed on a substrate of, for example, sapphire (including a C surface, an A surface, and an R surface), SiC (including 6H—SiC and 4H—SiC), spinel (MgAl₂O₄, in particular, a (111) surface thereof), ZnO, Si, GaAs, or other oxide single-crystal substrates (NGO or the like) by using a vapor phase growth method such as an organic metal vapor phase growth method (MOVPE), a molecular beam vapor phase growth method (MBE), and a hybrid vapor phase growth method (HDVPE).

According to the display device of this embodiment, it is possible to realize an excellent display device in which brightness is not changed in any viewing direction, color is not changed in any viewing direction, and low power consumption is able to be obtained.

### (3) Third Embodiment

FIG. 17 is a schematic sectional view illustrating an inorganic EL element substrate configuring a display device according to a third embodiment.

The display device of this embodiment is schematically configured of the fluorescent substrate formed of a substrate on which the fluorescent layer, the particles having light scattering properties, the partition wall, the light absorptive layer, and the like of the light emitting device according to the first embodiment to the eleventh embodiment described above are formed, and an inorganic EL element substrate (a light source) 250 which is bonded to the fluorescent substrate with a planarizing film or the like in between.

The inorganic EL element substrate 250 is schematically configured of a substrate 251, and an inorganic EL element 252 formed on one surface 251a of the substrate 251.

The inorganic EL element 252 is configured of a first electrode 253, a first dielectric layer 254, a light emitting layer 255, a second dielectric layer 256, and a second electrode 257 which are laminated on the one surface 251a of the substrate 251 in this order.

The first electrode 253 and the second electrode 257 function as a positive electrode or a negative electrode of the inorganic EL element 252 in pairs.

Furthermore, as the inorganic EL element 252, a known inorganic EL element, for example, a ultraviolet light emitting inorganic EL element, a blue light emitting inorganic EL element, and the like are able to be used, but a specific configuration is not limited to that described above.

Hereinafter, each configuration member configuring the inorganic EL element substrate 250 and a forming method thereof is specifically described, but this embodiment is not limited to the configuration member and the forming method.

As the substrate 251, a substrate identical to the substrate 211 configuring the organic EL element substrate 210 described above is used.

The first electrode 253 and the second electrode 257 function as a positive electrode or a negative electrode of the inorganic EL element 252 in pairs. That is, when the first electrode 253 is the positive electrode, the second electrode 257 is the negative electrode, and when the first electrode 253 is the negative electrode, the second electrode 257 is the positive electrode.

As the first electrode 253 and the second electrode 257, metal such as aluminum (Al), gold (Au), platinum (Pt), and oxide (ITO) formed of nickel (Ni), indium (In), and tin (Sn), oxide (SnO₂) of tin (Sn), oxide (IZO) formed of indium (In) and zinc (Zn), and the like are included as a transparent electrode material, but this embodiment is not limited to the material. The electrode on a light extraction side may be a transparent electrode of ITO, and it is preferable that a reflective electrode formed of aluminum or the like is used as the electrode on a side opposite to a light extraction direction.

The first electrode 253 and the second electrode 257 are able to be formed by using the material described above, and by using a known method such as an EB deposition method, a sputtering method, an ion plating method, and a resistive heating deposition method, but this embodiment is not limited to the forming method. In addition, as necessary, the formed electrode is able to be patterned by a photolithography method, and a laser peeling method, and the patterned electrode is able to be formed by being combined with a shadow mask.

It is preferable that a film thickness of the first electrode 253 and the second electrode 257 is greater than or equal to 50 nm.

When the film thickness is less than 50 nm, wiring resistance increases, and a driving voltage increases.

As the first dielectric layer 254 and the second dielectric layer 256, a known dielectric material for an inorganic EL element is able to be used. As the dielectric material, for example, tantalum pentoxide (Ta₂O₅), silicon oxide (SiO₂), silicon nitride (Si₃N₄), aluminum oxide (Al₂O₃), aluminum titanate (AlTiO₃), barium titanate (BaTiO₃), strontium titanate (SrTiO₃), and the like are included, but this embodiment is not limited to the dielectric material.

In addition, the first dielectric layer 254 and the second dielectric layer 256 may have a single-layer structure formed of one selected from the dielectric materials described above, or may have a multi-layer structure in which two or more thereof are laminated.

In addition, it is preferable that a film thickness of the first dielectric layer 254 and the second dielectric layer 256 is approximately 200 nm to 500 nm.

As the light emitting layer 255, a known light emitting material for an inorganic EL element is able to be used. As the light emitting material, for example, ZnF₂:Gd is included, as a ultraviolet light emitting material, BaAl₂S₄:Eu is included, and as a blue light emitting material, CaAl₂S₄:Eu, znAl₂S₄:Eu, Ba₂SiS₄:Ce, ZnS:Tm, SrS:Ce, SrS:Cu, CaS:Pb, (Ba,Mg) Al₂S₄:Eu, and the like are included, but this embodiment is not limited to the light emitting material.

In addition, it is preferable that a film thickness of the light emitting layer 255 is approximately 300 nm to 1000 nm.

According to the display device of this embodiment, it is possible to realize an excellent display device in which brightness is not changed in any viewing direction, color is not changed in any viewing direction, and low power consumption is able to be obtained.

Furthermore, as the configuration of the light source, the organic EL element substrate is exemplified in the first embodiment described above, the LED substrate is exemplified in the second embodiment described above, and the inorganic EL element substrate is exemplified in the third embodiment described above. In the configuration example, it is preferable that a sealing film or a sealing substrate which seals the light emitting element such as the organic EL element, the LED, and the inorganic EL element is disposed.

The sealing film and the sealing substrate are able to be formed by a known sealing material and a known sealing method. Specifically, a front surface on a side opposite to the substrate configuring the light source is coated with a resin by using a spin coat method, an ODF, a laminating method, or the like, and thus the sealing film is able to be formed. Alternatively, an inorganic film of SiO, SiON, SiN, or the like is formed by using a plasma CVD method, an ion plating method, an ion beam method, a sputtering method, or the like, and then a resin is applied thereon by using a spin coat method, an ODF, a laminating method, or the like, and thus the sealing film is able to be formed, or the sealing substrate is able to be bonded.

It is possible to prevent oxygen or moisture from being mixed into the light emitting element from the outside by the sealing film or the sealing substrate, and thus lifetime of the light source is improved.

In addition, when the light source is adhered to the fluorescent substrate, the light source is able to be adhered to the fluorescent substrate by a general ultraviolet light curable resin, a thermally curable resin, or the like.

In addition, when the light source is directly formed on the fluorescent substrate, for example, a method is used in which inactive gas such as nitrogen gas, and argon gas is sealed with a glass plate, a metal plate, and the like. Further, when a moisture absorbent such as barium oxide is mixed into the sealed inactive gas, it is possible to more effectively reduce degradation of the organic EL element due to the moisture, and thus it is preferable.

However, this embodiment is not limited to the member or the forming method. In addition, when the light is extracted from a side opposite to the substrate, it is necessary that a light transmissive material is used along with the sealing film and the sealing substrate.

### (4) Fourth Embodiment

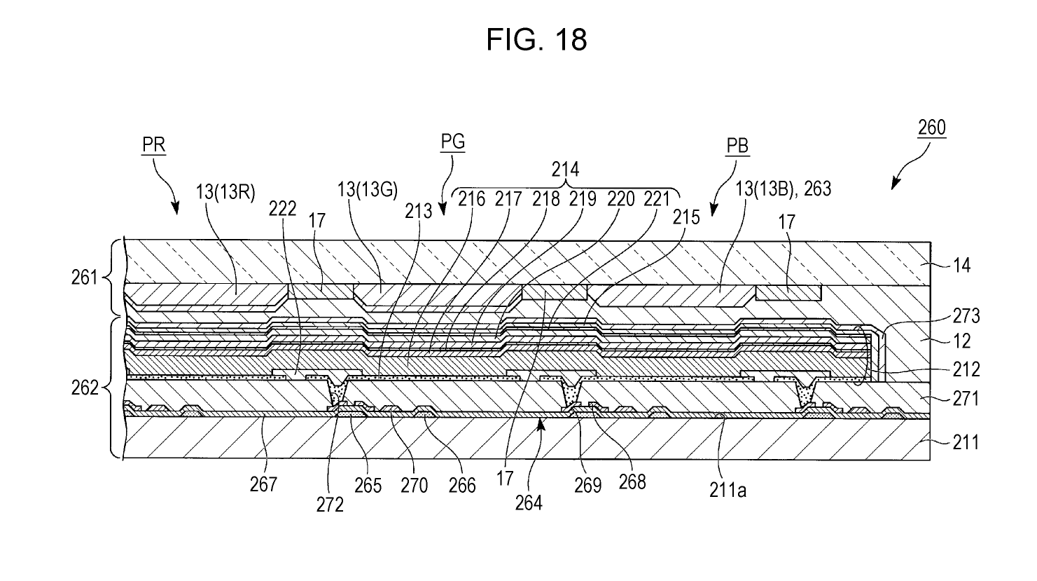

FIG. 18 is a schematic sectional view illustrating a display device according to a fourth embodiment. In FIG. 18, the same reference numerals are applied to the same constituents as that of the light emitting device 50 illustrated in FIG. 6 and the organic EL element substrate 210 illustrated in FIG. 15, and the description thereof will be omitted.

A display device of this embodiment 260 is schematically configured of a fluorescent substrate 261 having the same configuration as that of the substrate on which the fluorescent layer, the particles having light scattering properties, the partition wall, the light absorptive layer, and the like of the light emitting device according to the first embodiment to the eleventh embodiment described above are formed, and an active matrix driving organic EL element substrate (a light source) 262 which is bonded to the fluorescent substrate 261 with a planarizing film in between.

In the organic EL element substrate 262, as a unit which switches whether or not each of a red pixel PR, a green pixel PG, and a blue pixel PB is irradiated with light, an active matrix driving method using a TFT is used.

When the organic EL element substrate 262 emits blue light, the blue pixel PB includes a light scattering layer 263 which scatters the blue light.

### [Active Matrix Driving Organic EL Element Substrate]

Hereinafter, the active matrix driving organic EL element substrate 262 will be specifically described.

FIG. 18 is a schematic configuration diagram illustrating the display device which includes the organic EL element substrate. In the organic EL element substrate 262, a TFT (an active matrix driving element) 264 is formed on the one surface 211a of the substrate 211. That is, a gate electrode 265 and a gate line 266 are formed the one surface 211a of the substrate 211, and a gate insulating film 267 is formed on the one surface 211a of the substrate 211 in order to cover the gate electrode 265 and the gate line 266. An active layer (not illustrated) is formed on the gate insulating film 267, a source electrode 268, a drain electrode 269, and a data line 270 are formed on the active layer, and a planarizing film 271 is formed in order to cover the source electrode 268, the drain electrode 269, and the data line 270.

Furthermore, the planarizing film 271 may not have a single-layer structure, may have a configuration in which other insulating interlayers and the planarizing film are combined. In addition, a contact hole 272 which passes through the planarizing film 271 or the insulating interlayer and reaches the drain electrode 269 is formed, and a first electrode 213 of the organic EL element 212 which is electrically connected to the drain electrode 269 through the contact hole 272 is formed on the planarizing film 271. The configuration of the organic EL element 212 is identical to that of the first embodiment described above.

The TFT (the active matrix driving element) 264 is formed on the one surface 211a of the substrate 211 in advance before forming the organic EL element 212, and functions as an element for switching a pixel and an element driving an organic EL element.

As the TFT 264, a known TFT is included, and the TFT 264 is able to be formed by using a known material, a known structure, and a known forming method. In addition, in this embodiment, a metal-insulating body-metal (MIM) diode is able to be used instead of the TFT 264.

As the material of the active layer configuring the TFT 264, the same material as that of the first embodiment described above is used.

As the forming method of the active layer configuring the TFT 264, the same forming method as that of the first embodiment described above is used.

The gate insulating film 267 configuring the TFT 264 is able to be formed by using a known material. As the gate insulating film 267, for example, SiO₂ which is formed by using a PECVD method, a LPCVD method, or the like, SiO₂ which is obtained by thermally oxidizing a polysilicon film, and the like are included.

In addition, the data line 270, the gate line 266, the source electrode 268 and the drain electrode 269 configuring the TFT 264 are able to be formed by using a known conductive material. As the material of the data line 270, the gate line 266, the source electrode 268, and the drain electrode 269, for example, tantalum (Ta), aluminum (Al), copper (Cu), and the like are included.

The TFT 264 has the configuration as described above, but this embodiment is not limited to the material, the structure, and the forming method.

As the insulating interlayer used in this embodiment, the same insulating interlayer as that of the first embodiment described above is included. In addition, as the forming method of the insulating interlayer, the same method as that of the first embodiment described above is included.

When the emitted light from the organic EL element 212 is extracted from a side opposite to the substrate 211 (the second electrode 215 side), it is preferable to use a light shielding insulating film having light shielding properties in order to prevent a change from occurring in the electrical properties of the TFT 264 due to the outside light which is incident on the TFT 264 formed on the one surface 211a of the substrate 211. In addition, the insulating interlayer described above and the light shielding insulating film are able to be combined. As the material of the light shielding insulating film, the same material as that of the first embodiment described above is included.

In the display device 260, concavities and convexities are formed in the front surface of the substrate 211 due to the TFT 264 or various wirings, the electrode, and the like which are formed on the one surface 211a of the substrate 211, and a defect in the organic EL element 212 (for example, a deficit or disconnection in the first electrode 213 or the second electrode 215, a deficit in the organic EL layer 214, short circuit between the first electrode 213 and the second electrode 215, a decrease in pressure resistance, or the like) occurs due to the concavities and convexities. In order to prevent these defects, it is preferable that the planarizing film 271 is disposed on the insulating interlayer.

The planarizing film 271 is able to be formed by using a known material. As the material of the planarizing film 271, the same material as that of the first embodiment described above is included.

In addition, the planarizing film 271 may have either a single-layer structure or a multi-layer structure.

In addition, a sealing film 273 which seals the organic EL element 212 is disposed on a front surface of the organic EL element 212 (a surface facing the fluorescent substrate 261).

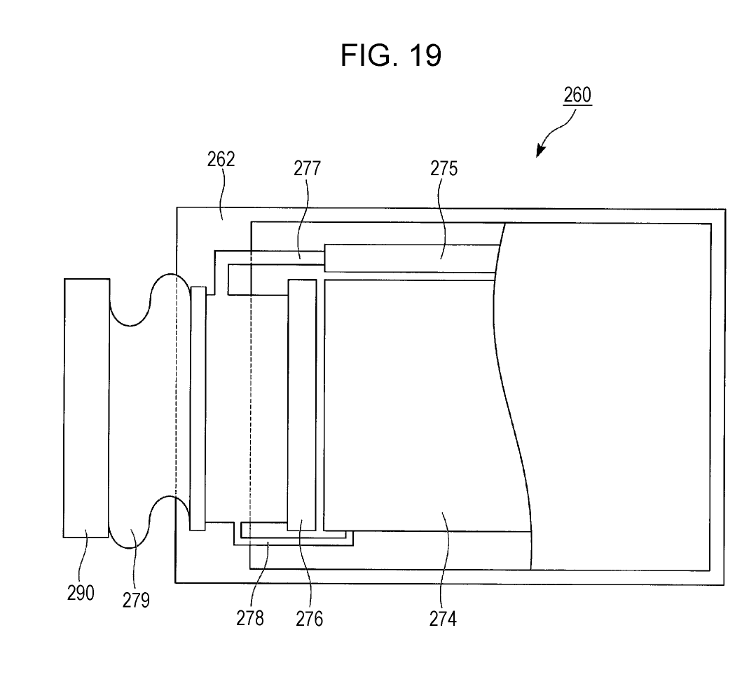

In addition, as illustrated in FIG. 19, the display device 260 includes a pixel portion 273 formed on the organic EL element substrate 262, a gate signal side driving circuit 274, a data signal side driving circuit 275, signal wiring 276 and a current supply line 277, and a flexible printed wiring plate (hereinafter, referred to as a “FPC”) 278 and an external driving circuit 290 which are connected to the organic EL element substrate 262.

The organic EL element substrate 262 is electrically connected to the external driving circuit 290 including a scanning line electrode circuit, a data signal electrode circuit, a power source circuit, and the like through the FPC 279 in order to drive the organic EL element 212. In this embodiment, a switching circuit such as the TFT 264 is arranged in a pixel portion 274, each of the data signal side driving circuit 276 and the gate signal side driving circuit 275 for driving the connected organic EL element 212 is connected to the wiring such as data line 270 and the gate line 266 to which the TFT 264 or the like, and the external driving circuit 290 is connected to the driving circuit through the signal wiring 267. A plurality of gate lines 266 and a plurality of data lines 270 are arranged in the pixel portion 274, and the TFT 264 is arranged in an intersection between the gate line 266 and the data line 270.

The organic EL element 212 is driven by a voltage driving digital gradation method, two TFTs of a TFT for switching and a TFT for driving are arranged for each pixel, and the TFT for driving is electrically connected to the first electrode 213 of the organic EL element 212 through the contact hole 272 formed in the planarizing film 271. In addition, a capacitor (not illustrated) for setting a gate potential of the TFT for driving to be a constant potential is arranged in one pixel to be connected to a gate electrode of the TFT for driving.

However, this embodiment is not particularly limited thereto, and the driving method may be the voltage driving digital gradation method described above, or may be a current driving analog gradation method. In addition, the number of TFTs is not particularly limited, the organic EL element 212 may be drive by the two TFTs described above, or the organic EL element 212 may be driven by using two or more TFTs in which a compensation circuit is embedded in the pixel in order to prevent a variation in properties of the TFT 264 (mobility, and a threshold voltage).

According to the display device of this embodiment, it is possible to realize an excellent display device in which brightness is not changed in any viewing direction, color is not changed in any viewing direction, and low power consumption is able to be obtained.

In particular, in this embodiment, the active matrix driving organic EL element substrate 262 is adopted, and thus a display device having excellent display quality is able to be realized. In addition, it is possible to increase light emitting time of the organic EL element 212 compared to passive driving, and it is possible to reduce a driving current for obtaining desired luminance, and thus low power consumption is able to be realized. Further, according to the configuration in which the light is extracted from a side opposite to the organic EL element substrate 262 (the fluorescent substrate 261 side), it is possible to widen a light emitting region regardless of a forming region of the TFT, various wirings, or the like, and it is possible to increase an aperture ratio of the pixel.

### (5) Fifth Embodiment

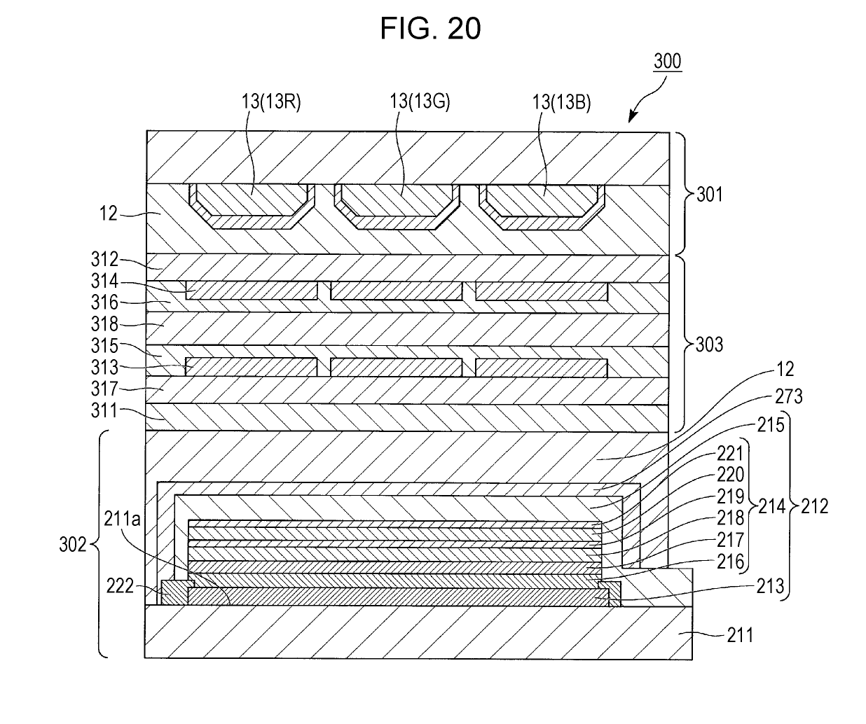

FIG. 20 is a schematic sectional view illustrating a display device according to a fifth embodiment. In FIG. 20, the same reference numerals are applied to the same constituents as that of the light emitting device 50 illustrated in FIG. 6, the organic EL element substrate 210 illustrated in FIG. 16, and the display device 260 illustrated in FIG. 19, and the description thereof will be omitted.

A display device of this embodiment 300 is schematically configured of a fluorescent substrate 301 having the same configuration as that of the substrate on which the fluorescent layer, the particles having light scattering properties, the partition wall, the light absorptive layer, and the like of the light emitting device according to the first embodiment to the eleventh embodiment described above are formed, an organic EL element substrate (a light source) 302, and a liquid crystal element 303.

The organic EL element 212 configuring the organic EL element substrate 302 is not divided for each pixel, and functions as a surface light source which is common in all of the pixels.

In addition, the liquid crystal element 303 is configured to be able to control a voltage applied to a liquid crystal layer by using a pair of electrodes for each pixel, and controls a transmission factor of the light emitted from the entire surface of the organic EL element 212 for each pixel. That is, the liquid crystal element 303 has a function as a light shutter which selectively transmits the light from the organic EL element substrate 302 for each pixel.

As the liquid crystal element 303, a known liquid crystal element is able to be used. The liquid crystal element 303, for example, includes a pair of polarizers 311 and 312, transparent electrodes 313 and 314, alignment films 315 and 316, and a substrate 317, and has a structure in which a liquid crystal 318 is interposed between the alignment films 315 and 316.

Further, an optical anisotropic layer may be disposed between a liquid crystal cell and any one of the polarizers 311 and 312, or the optical anisotropic layer may be disposed between the liquid crystal cell and both of the polarizers 311 and 312. In the display device 300, it is preferable that the polarizer is disposed on a light extraction side.

As the polarizers 311 and 312, a polarizer is able to be used in which a linear polarizer of the related art and a ?/4 plate are combined. By disposing the polarizers 311 and 312, it is possible to prevent the outside light from being reflected from the electrode of the display device 300 or to prevent the outside light from being reflected on the substrate or a front surface of a sealing substrate, and it is possible to improve contrast of the display device 300.

In addition, as the polarizers 311 and 312, it is preferable that a polarizer of which an extinction ratio is greater than or equal to 10000 at a wavelength of greater than or equal to 435 nm and less than or equal to 480 nm is used.

The type of the liquid crystal cell is not particularly limited, and the liquid crystal cell is able to be suitably selected according to the object. As the liquid crystal cell, for example, a TN mode, a VA mode, an OCB mode, an IPS mode, an ECB mode, and the like are included.

In addition, the liquid crystal element 303 may be passively driven, or may be actively driven by using a switching element such as a TFT.

According to the display device of this embodiment, it is possible to realize an excellent display device in which brightness is not changed in any viewing direction, color is not changed in any viewing direction, and low power consumption is able to be obtained.

In addition, in this embodiment, it is possible to further reduce power consumption by combining the switching of the pixel of the liquid crystal element 303 with the organic EL element substrate 302 which functions as the surface light source.

### (6) Sixth Embodiment

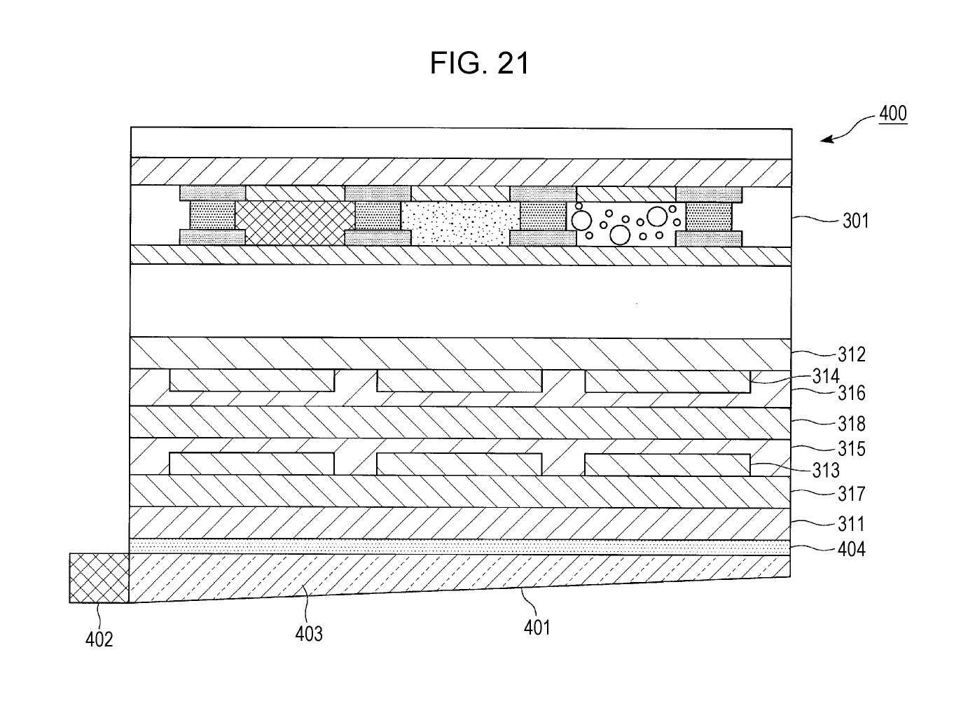

FIG. 21 is a schematic sectional view illustrating a sixth embodiment of the display device according to the present invention. In FIG. 21, the same reference numerals are applied to the same constituents as that of the light emitting device 50 illustrated in FIG. 6 and the liquid crystal element 303 illustrated in FIG. 20, and the description thereof will be omitted.

A display device of this embodiment 400 is schematically configured of a fluorescent substrate 301 having the same configuration as that of the substrate on which the fluorescent layer, the particles having light scattering properties, the partition wall, the light absorptive layer, and the like of the light emitting device according to the first embodiment to the eleventh embodiment described above are formed, a liquid crystal element 303, and a backlight unit 401.

In the backlight unit 401, a light source is arranged on a lower surface or a side surface of the backlight unit 401. When the light source is arranged on the side surface of the backlight unit 401, the backlight unit 401, for example, is configured of a reflective sheet, a light source, a light guide plate, a first diffusion sheet, a prism sheet, and a second diffusion sheet. In addition, a luminance improving film may be arranged between the backlight unit 401 and polarizer 311 on the backlight side.

Here, as the backlight unit 401, a backlight unit schematically configured of a light source 402 arranged on the side surface of the backlight unit 401, a light guide plate 403 which guides the light from the light source 402 to a surface direction of the liquid crystal element 303, and a luminance improving film 404 which allows the light to be efficiently incident on the liquid crystal element 303 from the light guide plate 403 is exemplified.

According to the display device 400, it is possible to realize an excellent display device in which brightness is not changed in any viewing direction, color is not changed in any viewing direction, and low power consumption is able to be obtained.

In addition, in this embodiment, it is possible to further reduce power consumption by combining the switching of the pixel of the liquid crystal element 303 with the backlight unit 401 which functions as the surface light source.

### [Mobile Phone]

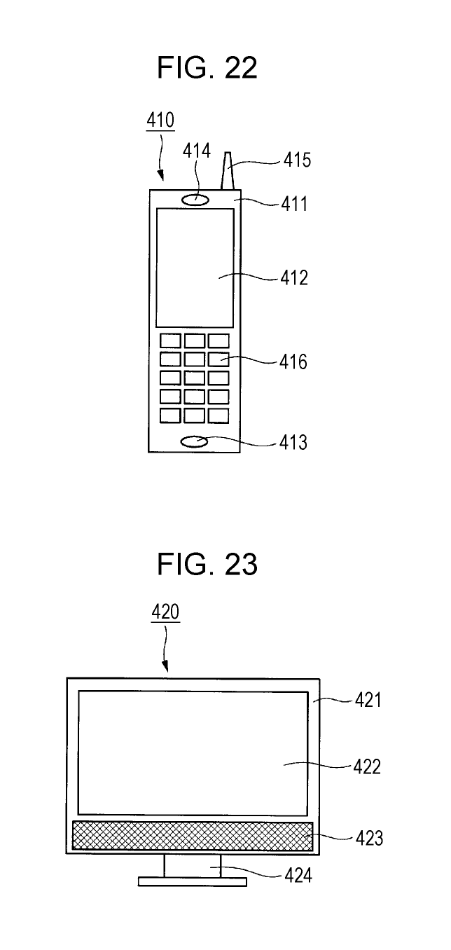

The display device according to the first embodiment to the sixth embodiment is able to be applied to, for example, a mobile phone illustrated in FIG. 22.

The mobile phone 410 includes a main body 411, a display unit 412, a voice input unit 413, a voice output unit 414, an antenna 415, an operation switch 416, and the like. Then, as the display unit 412, the display device of the first embodiment to the sixth embodiment described above is able to be suitably applied. By applying the display device of the first embodiment to the sixth embodiment described above to the display unit 412 of the mobile phone 410, it is possible to display an image having high luminance with low power consumption.

### [Thin-Screen Television]

The display device of the first embodiment to the sixth embodiment described above, for example, is able to be applied to a thin-screen television illustrated in FIG. 23.

The thin-screen television 420 includes a main body cabinet 421, a display unit 422, a speaker 423, a stand 424, and the like. Then, as the display unit 422, the display device of the first embodiment to the fifth embodiment described above is able to be suitably applied. By applying the display device of the first embodiment to the fifth embodiment described above to the display unit 422 of the thin-screen television 420, it is possible to realize an excellent display device in which brightness is not changed in any viewing direction, and color is not changed in any viewing direction with low power consumption.

[Illuminating Device]

### (1) First Embodiment

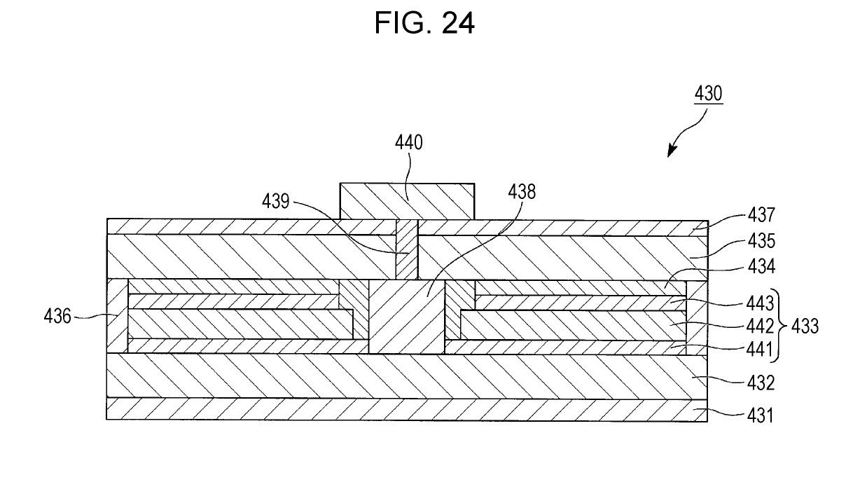

FIG. 24 is a schematic sectional view illustrating an illuminating device according to a first embodiment.

The illuminating device 430 of this embodiment is schematically configured of an optical film 431, a fluorescent substrate 432, an organic EL element 433, a heat diffusion sheet 434, a sealing substrate 435, a sealing resin 436, a heat dissipating material 437, a circuit for driving 438, wiring 439, and hook sealing 440.

The organic EL element 433 is schematically configured of a positive electrode 441, an organic EL layer 442, and a negative electrode 443.

Furthermore, a light distribution adjustment layer in the fluorescent substrate 422 may be formed between the substrate and the optical film, or may be formed on the optical film.

In the illuminating device 430, as the fluorescent substrate 432, a fluorescent substrate having the same configuration as that of the substrate is used on which the fluorescent layer, the light particles having scattering properties, the partition wall, the light absorptive layer, and the like of the light emitting device of the first embodiment to the twelfth embodiment described above are formed, and thus according to the display device of this embodiment, it is possible to realize an excellent illuminating device in which brightness is not changed in any viewing direction, and low power consumption is able to be obtained.

### (2) Second Embodiment

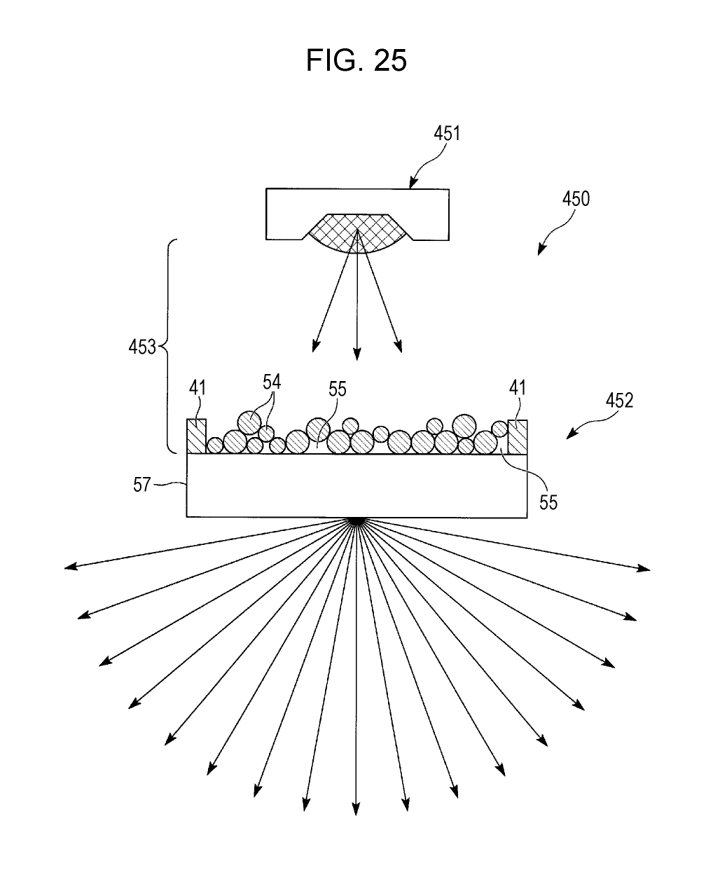

FIG. 25 is a schematic sectional view illustrating an illuminating device according to a second embodiment.

An illuminating device 450 includes an excitation light source 451 emitting excited light, and a light emitting device 453 schematically configured of a fluorescent substrate 452.

The fluorescent substrate 452 is schematically configured of an excitation light source emitting the excited light, a substrate 57 arranged to face the excitation light source on which a fluorescent layer of emitting fluorescent light by being excited by the excited light is formed, particles 54 having light scattering properties which change a traveling direction of the excited light, voids 55 formed between the particles 54 and one surface of the substrate 57, and a light-reflective partition wall 41 arranged on one or more side surfaces along a laminated direction of the substrate.

As the excitation light source, the same excitation light source as that of the light emitting device according to the first embodiment to the eleventh embodiment described above is included. As the substrate, the same substrate as that of the light emitting device according to the first embodiment to the eleventh embodiment described above is included.

As the fluorescent layer, the same fluorescent layer as that of the light emitting device according to the first embodiment to the eleventh embodiment described above is included. As the partition wall, the same partition wall as that of the light emitting device according to the first embodiment to the eleventh embodiment described above is included. As the light scattering layer, the same light scattering layer as that of the light emitting device according to the first embodiment to the eleventh embodiment described above is included. As the wavelength selective transmission reflection layer, the same wavelength selective transmission reflection layer as that of the light emitting device according to the first embodiment to the eleventh embodiment described above is included.

The light emission of the illuminating device 450 will be described with reference to FIG. 25.

In the illuminating device 450, when the light is incident on the scatterer layer from the outside, most of the light is incident on non-light emitting particles through the voids, and then becomes scattering light. In the scattering light, a component traveling to the substrate side, a component traveling to the light source side, or a component incident on other non-light emitting particles again exists through the voids. Here, a refraction index interface due to a refraction index difference in each layer exists between the scatterer layer and the substrate, and between the substrate and the outside. In this embodiment, a refraction index of the voids configuring the scatterer layer is around 1.0, and thus the substrate is interposed between the voids of which the refraction index is around 1.0 and the outside of which a refraction index is also around 1.0. In this configuration, the scattering light traveling to the substrate side among the scattering light rays scattered by the non-light emitting particles is incident on the substrate through the voids of which the refraction index is around 1.0, and thus almost all of the scattering light incident on the substrate is able to be extracted to the outside without totally reflected on the interface between the substrate and the outside. In addition, in this configuration, a light-reflective partition wall is disposed on the side surface of the scatterer layer, and thus the scattering light incident on a side surface portion of the scatterer layer among the scattering light rays scattered in the scatterer layer is reflected on a side surface of the light-reflective partition wall, and is recycled to a component which is able to be extracted to the substrate side.

That is, by disposing the partition wall having light reflectivity on the side surface of the scatterer layer, it is possible to efficiently extract the scattering light scattered in the scatterer layer to the outside. In addition, in a case where a portion, which is in contact with the scatterer layer, of the partition wall has light scattering properties, for example, when a scattering light component which is totally reflected on the substrate once is reflected on the partition wall and is incident on the substrate again, first, the scattering light component which is totally reflected on the substrate and is incident on the partition wall is reflected (scattered) on the partition wall at an angle different from an incident angle thereof, and is incident on the substrate at an angle different from the angle of the first incidence, and thus a probability that the light is totally reflected on the substrate again decreases, and it is possible to extract the light to the outside. That is, by disposing the partition wall having light scattering properties on the side surface of the scatterer layer, it is possible to more efficiently extract the scattering light scattered in the scatterer layer to the outside.

[Storage Container]

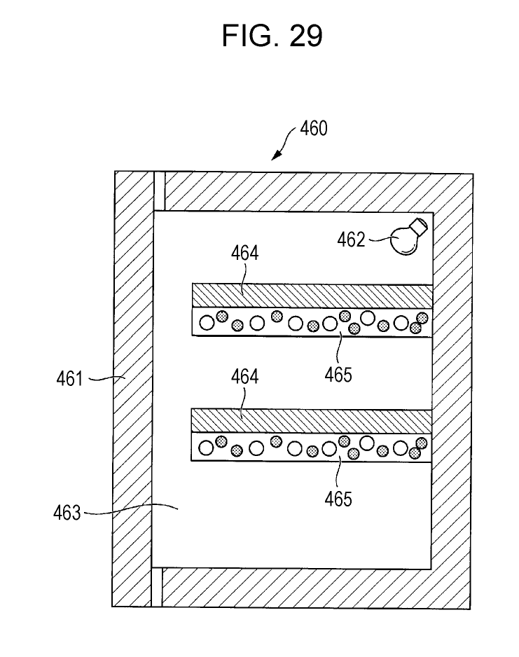

FIG. 29 is a schematic sectional view illustrating a storage container according to this embodiment.

A storage container 460 of this embodiment is schematically configured of an opening and closing door 461, a storage room 463, an internal light 462 illuminating the inside of the storage room 463, a shelf member 464, and a light scatterer film 465. The internal light 462 may be configured such that lighting and extinction are controlled in conjunction with the opening and closing of the opening and closing door 461. In the storage room 463, goods are stored at a predetermined temperature. The goods stored in the storage room 463 may be mounted on a flat portion of the shelf member 464. A light scatterer film 465 is formed on at least a part of the shelf member 464.

The internal light 462 may be selected according to the goods stored in the storage room 463, and is not particularly limited. For example, an illuminating device including a fluorescent lamp and a LED, an illuminating device including an inorganic EL element, an illuminating device including an organic EL, and the like are included.

As the light scatterer film 465, the same scatterer layer as the scatterer layers 34, 56, 61, and 72 of the light scatterer device of the first embodiment to the eleventh embodiment described above is included.

At least a part of the shelf member 464 includes a material which transmits the light emitted from the internal light 462. As the material transmitting the light, the same material as that of the substrate 35 described above is able to be used.

In the storage container 460, when the light incident on the light scatterer film 465 from the internal light 462 through the shelf member 464 reaches light scattering particles, as described above, the light is scattered in an arbitrary direction on the basis of a particle diameter of the particles, a refraction index, and the like. By a scattering effect of the light scatterer film 465, it is possible to scatter the light emitted from the internal light 462 in the entire storage room 463. Therefore, according to this embodiment, it is possible to provide a storage container which is able to maintain the inside of the storage room 463 brightly by efficiently using the light from the internal light 462.

### EXAMPLES

Hereinafter, the present invention is more specifically described with reference to Examples and Comparative Examples in the related art, but the present invention is not limited to the Examples below.

### Comparative Example 1

After a glass substrate having a thickness of 0.7 mm was washed, 10 minutes of pure water ultrasonic washing, 10 minutes of acetone ultrasonic washing, and 5 minutes of isopropyl alcohol steam washing were performed, and the resultant was dried at 100° C. for one hour.

Subsequently, a scatterer layer having a film thickness of 15 μm was formed on one surface of the glass substrate.

Here, in order to form a scatterer layer, 2.35 g of Techpolymer “SBX-4” having an average particle diameter of 4 μm which was manufactured by Sekisui Plastics Co., Ltd. was first added to 30 g of a resin “LuxPrint 8155” manufactured by Teijin DuPont Films Japan Limited, as a binder for dispersing light scattering particles. The resultant was mashed and mixed well for 30 minutes with an automatic mortar, and preliminarily stirred at the stirring speed of 3000 rpm in an open system and at room temperature for 15 minutes by using a dispersion stirring apparatus “Filmix 40-40 type” manufactured by Primix Corporation.

Subsequently, a scatterer layer having a film thickness of 20 μm was formed on one surface of the glass substrate by using a commercially available spin coater.

Subsequently, the resultant was heated and dried for 15 minutes in a vacuum oven (in the condition of 200° C.), and a light scatterer film was formed, so that a scatterer substrate of Comparative Example 1 including the glass substrate and the light scatterer film formed on one surface thereof was obtained.

Thereafter, as incident light, 460 nm of light from a blue directivity surface light source (back light) which was manufactured by the inventors and on which a commercially available blue LED was mounted was incident from a rear surface (film surface side) of a light scatterer substrate of a Comparative Example, and characteristics of the scattering light emitted from a front surface (glass surface side) of the light scatterer substrate were observed. At this point, it was confirmed that edge portions of a light emitting region and a non-light emitting region were indistinct, and it was confirmed that the intensity of the scattering light was drastically decreased with respect to the incident light.

In addition, when, as incident light, 460 nm of light from the blue directivity surface light source (back light/light emitting area: 2 mm×2 mm) was incident from the rear surface (film surface side) of the scatterer substrate of the Comparative Example, an observation area of the front surface luminance (light emitting area in which front surface luminance was observed) of scattering light extracted from the front surface (glass surface side) of the scatterer substrate at 25° C. was measured by using a commercially available luminance measuring device (HS-1000: manufactured by Otsuka Electronics Co., Ltd.). As a result, the light emitting observation area of the blue directivity surface light source as the incident light was almost 2 mm×2 mm, but, after the light passed through the scatterer substrate, the light emitting observation area was about 6 mm×6 mm or greater.

In addition, as the incident light, 460 nm of light from the blue directivity surface light source (back light) was incident from the rear surface (film surface side) of the scatterer substrate of the Comparative Example. At this point, luminance viewing angle characteristics of the scattering light extracted from the front surface (glass surface side) of the scatterer substrate at 25° C. were measured by using a commercially available luminance viewing angle measuring apparatus (Ez-contrast: manufactured by ELDIM S.A.). As a result, a relative luminance value (L₆₀/L₀) of the blue directivity surface light source as the incident light in the direction of a viewing angle 60° with respect to a luminance value at the viewing angle 0° (normal direction) was 0.03, but, after the light passed through the scatterer substrate, the relative luminance value was 0.49.

In addition, a total light beam transmittance ([the number of photons emitted from light scatterer substrate/the number of photons incident to light scatterer substrate]×100) when 460 nm of blue light was incident from the rear surface (film surface side) of the scatterer substrate of the Comparative Example was measured by using a commercially available total light beam measuring apparatus (integrating sphere) (HalfMoon: manufactured by Otsuka Electronics Co., Ltd.). As a result, a total light beam transmittance T was 58.8%.

### Comparative Example 2

In the same manner as in Comparative Example 1, after the glass substrate having a thickness of 0.7 mm was washed, 10 minutes of the pure water ultrasonic washing, 10 minutes of the acetone ultrasonic washing, and 5 minutes of the isopropyl alcohol steam washing were performed, and the resultant was dried at 100° C. for one hour.

Subsequently, a scatterer layer having a film thickness of 10 μm was formed on one surface of the glass substrate.

Here, in order to form the scatterer layer, 5.23 g of titanium oxide “R-25” having an average particle diameter of 200 nm which was manufactured by Sakai Chemical Industry Co., Ltd. was first added to 30 g of a resin “LuxPrint 8155” manufactured by Teijin DuPont Films Japan Limited, as a binder for dispersing light scattering particles. After the resultant was mashed and mixed well for 30 minutes with an automatic mortar, and preliminarily stirred at the stirring speed of 3000 rpm in an open system and at room temperature for 15 minutes by using a dispersion stirring apparatus “Filmix 40-40 type” manufactured by Primix Corporation.

Subsequently, a scatterer layer having a film thickness of 15 μm was formed on one surface of the glass substrate by using a commercially available spin coater.

Subsequently, the resultant was heated and dried for 15 minutes in a vacuum oven (in the condition of 200° C.), and a light scatterer film was formed, so as to obtain a scatterer substrate of Comparative Example 2 including the glass substrate and the light scatterer film formed on one surface thereof.

Thereafter, as the incident light, 460 nm of light from the blue directivity surface light source (back light) which was manufactured by the inventors and on which the commercially available blue LED was mounted was incident from the rear surface (film surface side) of the light scatterer substrate of the Comparative Example, and characteristics of the scattering light emitted from a front surface (glass surface side) of the light scatterer substrate were observed. At this point, it was confirmed that edge portions of the light emitting region and the non-light emitting region were indistinct, and it was confirmed that the intensity of the scattering light was drastically decreased with respect to the incident light.

In addition, when, as incident light, 460 nm of light from the blue directivity surface light source (back light/light emitting area: 2 mm×2 mm) was incident from the rear surface (film surface side) of the scatterer substrate of the Comparative Example, the observation area of the front surface luminance (light emitting area in which front surface luminance was observed) of the scattering light extracted from the front surface (glass surface side) of the scatterer substrate at 25° C. was measured by using the commercially available luminance measuring device (HS-1000: manufactured by Otsuka Electronics Co., Ltd.). As a result, the light emitting observation area of the blue directivity surface light source as the incident light was almost 2 mm×2 mm, but, after the light passed through the scatterer substrate, the light emitting observation area was about 6 mm×6 mm or greater.

In addition, as the incident light, 460 nm of light from the blue directivity surface light source (back light) was incident from the rear surface (film surface side) of the scatterer substrate of the Comparative Example. At this point, the luminance viewing angle characteristics of the scattering light extracted from the front surface (glass surface side) of the scatterer substrate at 25° C. were measured by using the commercially available luminance viewing angle measuring apparatus (Ez-contrast: manufactured by ELDIM S.A.). As a result, the relative luminance value (L₆₀/L₀) of the blue directivity surface light source as the incident light in the direction of a viewing angle 60° with respect to the luminance value at the viewing angle 0° (normal direction) was 0.03, but, after the light passed through the scatterer substrate, the relative luminance value was 0.81.

In addition, the total light beam transmittance ([the number of photons emitted from light scatterer substrate/the number of photons incident to light scatterer substrate]×100) when 460 nm of blue light was incident from the rear surface (film surface side) of the scatterer substrate of the Comparative Example was measured by using the commercially available total light beam measuring apparatus (integrating sphere) (HalfMoon: manufactured by Otsuka Electronics Co., Ltd.). As a result, the total light beam transmittance T was 13.8%.

### Example 1

In the same manner as in the Comparative Examples, after the glass substrate having a thickness of 0.7 mm was washed, 10 minutes of the pure water ultrasonic washing, 10 minutes of the acetone ultrasonic washing, and 5 minutes of the isopropyl alcohol steam washing were performed, and the resultant was dried at 100° C. for one hour.

Subsequently, a scatterer layer having a film thickness of 30 μm was formed on one surface of the glass substrate.

Here, in order to form the scatterer layer, 1 wt % of a barium nitrate solution was adjusted. Subsequently, a sedimentation tube was prepared, and the washed glass substrate was installed on the bottom surface portion of the sedimentation tube by using a fixing tool. Subsequently, 30 ml of the adjusted barium nitrate solution and 300 ml of pure water were poured into the sedimentation tube.

By using aluminum oxide “AX3-32” (average particle diameter: 1 μm to 4 μm/refractive index: 1.7) manufactured by Nippon Steel & Sumikin Materials Co., Ltd., as the scattering particles, 0.5 g of aluminum oxide was mixed into 50 ml of pure water. Subsequently, an ultrasonic dispersion treatment was performed on the aluminum oxide solution for about one minute. Subsequently, 50 ml of water glass stock solution used as a bonding material was mixed with 100 ml of pure water, and a water glass aqueous solution was obtained. Subsequently, the aluminum oxide solution subjected to the ultrasonic dispersion treatment and the water glass aqueous solution were quickly poured into the sedimentation tube. After being poured, the solution was left for about 30 minutes, and aluminum oxide particles settled in the glass substrate. Thereafter, the cock of the sedimentation tube was opened so that the aqueous solution in the sedimentation tube was discharged, and a scatterer substrate of Example 1 including the glass substrate and the scatterer layer which was formed on one surface thereof and formed of the aluminum oxide particles and the gaps was obtained.

Thereafter, as the incident light, 460 nm of light from the blue directivity surface light source (back light) which was manufactured by the inventors and on which the commercially available blue LED was mounted was incident from the rear surface (film surface side) of the scatterer substrate of Example 1, and characteristics of the light emitted from the front surface (glass surface side) of the scatterer substrate were observed. At this point, it was confirmed that edge portions of the light emitting region and the non-light emitting region were not indistinct (distinct), and it was confirmed that the intensity of the scattering light was not drastically decreased with respect to the incident light as was also done in the Comparative Examples.

In addition, when, as incident light, 460 nm of light from the blue directivity surface light source (back light/light emitting area: 2 mm×2 mm) was incident from the rear surface (film surface side) of the scatterer substrate of the Example 1, the observation area of the front surface luminance (light emitting area in which front surface luminance was observed) of the scattering light extracted from the front surface (glass surface side) of the scatterer substrate at 25° C. was measured by using the commercially available luminance measuring device (HS-1000: manufactured by Otsuka Electronics Co., Ltd.). As a result, the light emitting observation area of the blue directivity surface light source as the incident light was almost 2 mm×2 mm, but, after the light passed through the scatterer substrate, the light emitting observation area was about 2.5 mm×2.5 mm.

In addition, as the incident light, 460 nm of light from the blue directivity surface light source (back light) was incident from the rear surface (film surface side) of the scatterer substrate of Example 1. At this point, the luminance viewing angle characteristics of the scattering light extracted from the front surface (glass surface side) of the scatterer substrate at 25° C. were measured by using the commercially available luminance viewing angle measuring apparatus (Ez-contrast: manufactured by ELDIM S.A.). As a result, the relative luminance value (L₆₀/L₀) of the blue directivity surface light source as the incident light in the direction of a viewing angle 60° with respect to the luminance value at the viewing angle 0° (normal direction) was 0.03, but, after the light passed through the light scatterer substrate, the relative luminance value was 0.70.

In addition, the total light beam transmittance ([the number of photons emitted from scatterer substrate/the number of photons incident to scatterer substrate]×100) when 460 nm of blue light was incident from the rear surface (film surface side) of the light scatterer substrate of Example 1 was measured by using the commercially available total light beam measuring apparatus (integrating sphere) (HalfMoon: manufactured by Otsuka Electronics Co., Ltd.). As a result, the total light beam transmittance T was 34.3%.

### Example 2

In the same manner as in Example 1, after the glass substrate having a thickness of 0.7 mm was washed, 10 minutes of the pure water ultrasonic washing, 10 minutes of the acetone ultrasonic washing, and 5 minutes of the isopropyl alcohol steam washing were performed, and the resultant was dried at 100° C. for one hour.

Subsequently, a scatterer layer having a film thickness of 10 μm was formed on one surface of the glass substrate.

Here, in order to form the scatterer layer, 1 wt % of the barium nitrate solution was adjusted. Subsequently, a sedimentation tube was prepared, and the washed glass substrate was installed on the bottom surface portion of the sedimentation tube by using a fixing tool. Subsequently, 30 ml of the adjusted barium nitrate solution and 300 ml of pure water were poured into the sedimentation tube.

As scattering particles, titanium oxide “A-190” (average particle diameter: 150 nm/refractive index: 2.5) manufactured by Sakai Chemical Industry Co., Ltd. and silica “HS-301” (average particle diameter: 1 μm to 3 μm/refractive index: 1.5) manufactured by Nippon Steel & Sumikin Materials Co., Ltd. were used, and 0.1 g of titanium oxide and 0.3 g of silica were mixed with 50 ml of pure water.

Subsequently, the aqueous solution was subjected to the ultrasonic dispersion treatment for one minute. Subsequently, 50 ml of the water glass stock solution used as bonding material was mixed with 100 ml of pure water so as to adjust the water glass aqueous solution.

Subsequently, the aqueous solution subjected to the ultrasonic dispersion treatment and the water glass aqueous solution were quickly poured into the sedimentation tube. After being poured, the solution was left for about 30 minutes, and titanium oxide particles and silica particles settled in the glass substrate. Thereafter, the cock of the sedimentation tube was opened so that the aqueous solution in the sedimentation tube was discharged, and the scatterer substrate of Example 1 including the glass substrate and the scatterer layer which was formed on one surface thereof and formed of the titanium oxide particles, the silica particles, and the gaps was obtained.

Thereafter, as the incident light, 460 nm of light from the blue directivity surface light source (back light) which was manufactured by the inventors and on which the commercially available blue LED was mounted was incident from the rear surface (film surface side) of the light scatterer substrate of Example 2, and characteristics of the light emitted from the front surface (glass surface side) of the scatterer substrate were observed. At this point, it was confirmed that edge portions of the light emitting region and the non-light emitting region were not indistinct (distinct), and it was confirmed that the intensity of the scattering light was not drastically decreased with respect to the incident light as did in the Comparative Examples.

In addition, when, as the incident light, 460 nm of light from the blue directivity surface light source (back light/light emitting area: 2 mm×2 mm) was incident from the rear surface (film surface side) of the scatterer substrate of the Example 1, the observation area of the front surface luminance (light emitting area in which front surface luminance was observed) of the scattering light extracted from the front surface (glass surface side) of the scatterer substrate at 25° C. was measured by using the commercially available luminance measuring device (HS-1000: manufactured by Otsuka Electronics Co., Ltd.). As a result, the light emitting observation area of the blue directivity surface light source as the incident light was almost 2 mm×2 mm, but, after the light passed through the scatterer substrate, the light emitting observation area was about 2.5 mm×2.5 mm.

In addition, as the incident light, 460 nm of light from the blue directivity surface light source (back light) was incident from the rear surface (film surface side) of the scatterer substrate of Example 2. At this point, the luminance viewing angle characteristics of the scattering light extracted from the front surface (glass surface side) of the light scatterer substrate at 25° C. were measured by using the commercially available luminance viewing angle measuring apparatus (Ez-contrast: manufactured by ELDIM S.A.). As a result, the relative luminance value (L₆₀/L₀) of the blue directivity surface light source as the incident light in the direction of a viewing angle 60° with respect to the luminance value at the viewing angle 0° (normal direction) was 0.03, but, after the light passed through the scatterer substrate, the relative luminance value was 0.55.

In addition, the total light beam transmittance ([the number of photons emitted from scatterer substrate/the number of photons incident to scatterer substrate]×100) when 460 nm of blue light was incident from the rear surface (film surface side) of the scatterer substrate of Example 2 was measured by using the commercially available total light beam measuring apparatus (integrating sphere) (HalfMoon: manufactured by Otsuka Electronics Co., Ltd.). As a result, the total light beam transmittance T was 59.3%.

### Example 3

In the same manner as in Comparative Examples, after the glass substrate having a thickness of 0.7 mm was washed, 10 minutes of the pure water ultrasonic washing, 10 minutes of the acetone ultrasonic washing, and 5 minutes of the isopropyl alcohol steam washing were performed, and the resultant was dried at 100° C. for one hour.

Subsequently, a partition wall (light scattering film) was formed on the glass substrate. Hereinafter, the method of forming the partition wall is specifically described.

First, a photosensitive white composition including an epoxy-based resin (refractive index: 1.59), an acrylic resin (refractive index: 1.49), rutile-type titanium oxide (refractive index: 2.71, particle diameter: 250 nm), a photoinitiator, and an aromatic solvent was stirred and mixed, so as to prepare a negative resist.

Subsequently, a low refractive index material layer formed on one surface of the glass substrate was coated with the negative resist by a spin coating method.

Thereafter, the pre-baking was performed at 80° C. for 10 minutes, and a coating film having a film thickness of 50 μm was formed.

After the coating film was covered with a mask capable of causing a desired image pattern to be formed, the coating film was irradiated with the i ray (300 mJ/cm²), so as to be exposed.

Subsequently, the development was performed by using the alkali developing solution so as to obtain a pixel pattern-shaped structure in which partition walls were formed.

Subsequently, the post-baking was performed at 140° C. for 60 minutes by using a hot air circulation-type drying furnace so that partition walls that partition pixels were formed.

Subsequently, the inner side of the scatterer layer was formed in an opening portion surrounded by the partition walls.

Here, 3.2 g of aluminum oxide “AX3-32” (average particle diameter: 1 μm to 4 μm/refractive index: 1.7) of Example 1 which was manufactured by Nippon Steel & Sumikin Materials Co., Ltd. was added to 30 g of the 10 wt % aqueous solution of polyvinyl alcohol “Poval 500” manufactured by Kishida Chemical Co., Ltd. which was used as a binder. After the resultant was mashed and mixed well for 30 minutes with an automatic mortar, and preliminarily stirred at the stirring speed of 3000 rpm in an open system and at room temperature for 15 minutes by using a dispersion stirring apparatus “Filmix 40-40 type” manufactured by Primix Corporation.

Subsequently, a scatterer layer having a film thickness of 10 μm was formed on the inner side of the opening portion surrounded by the partition wall by the dispenser method. Thereafter, the binder was baked by being heated at 400° C. for 30 minutes, and the scatterer substrate of Example 3 including the glass substrate, the scatterer layer that was formed on one surface thereof and formed of the aluminum oxide and gaps formed between the aluminum oxide particles, and the partition walls was obtained.

Thereafter, as the incident light, 460 nm of light from the blue directivity surface light source (back light) which was manufactured by the inventors and on which the commercially available blue LED was mounted was incident from the rear surface (film surface side) of the light scatterer substrate of Example 3, and characteristics of the light emitted from the front surface (glass surface side) of the light scatterer substrate were observed. At this point, it was confirmed that edge portions of the light emitting region and the non-light emitting region were not indistinct (distinct), and it was confirmed that the intensity of the scattering light was not drastically decreased with respect to the incident light as did in the Comparative Examples.

In addition, as the incident light, 460 nm of light from the blue directivity surface light source (back light/light emitting area: 2 mm×2 mm) was incident from the rear surface (film surface side) of the scatterer substrate of the Example 3, the observation area of the front surface luminance (light emitting area in which front surface luminance was observed) of the scattering light extracted from the front surface (glass surface side) of the scatterer substrate at 25° C. was measured by using the commercially available luminance measuring device (HS-1000: manufactured by Otsuka Electronics Co., Ltd.). As a result, the light emitting observation area of the blue directivity surface light source as the incident light was almost 2 mm×2 mm, but, after the light passed through the scatterer substrate, the light emitting observation area was about 2.5 mm×2.5 mm.

In addition, as the incident light, 460 nm of light from the blue directivity surface light source (back light) was incident from the rear surface (film surface side) of the scatterer substrate of Example 3. At this point, the luminance viewing angle characteristics of the scattering light extracted from the front surface (glass surface side) of the scatterer substrate at 25° C. were measured by using the commercially available luminance viewing angle measuring apparatus (Ez-contrast: manufactured by ELDIM S.A.). As a result, the relative luminance value (L₆₀/L₀) of the blue directivity surface light source as the incident light in the direction of a viewing angle 60° with respect to the luminance value at the viewing angle 0° (normal direction) was 0.03, but, after the light passed through the scatterer substrate, the relative luminance value was 0.77.

In addition, the total light beam transmittance ([the number of photons emitted from scatterer substrate/the number of photons incident to scatterer substrate]×100) when 460 nm of blue light was incident from the rear surface (film surface side) of the scatterer substrate of Example 3 was measured by using the commercially available total light beam measuring apparatus (integrating sphere) (HalfMoon: manufactured by Otsuka Electronics Co., Ltd.). As a result, the total light beam transmittance T was 60.1%.

As described above, in the scatterer substrates of the Comparative Examples and Examples 1 to 3 described above in detail, light emitting observation areas of the front surface luminance, relative luminance ratios, total light beam transmittances, and comparison results between the respective examples and Comparative Examples are presented in Table 1.

TABLE 1

| | Light emitting | Relative | Total light |
|---|---|---|---|
| | observation area | luminance | beam |
| | of front surface | value ratio | transmittance |
| | luminance | (L₆₀/L₀) | (%) |
| Comparative | ≧6 mm × 6 mm | 0.49 | 58.8 |
| Example 1 | | | |
| Comparative | ≧6 mm × 6 mm | 0.81 | 13.8 |
| Example 2 | | | |
| Example 1 | 2.5 mm × 2.5 mm | 0.70 | 34.3 |
| Example 2 | 2.5 mm × 2.5 mm | 0.55 | 59.3 |
| Example 3 | 2.5 mm × 2.5 mm | 0.77 | 60.1 |

### Example 4

A scatterer substrate model obtained by laminating single particles (particle diameter: 1 μm, refractive index: 2.2, 1.6) and a model including a light source that causes blue parallel light having 460 nm of the single wavelength to be incident on the laminated particle layer side in the direction perpendicular to the surface of the particle layer were prepared on the glass substrate (thickness: 0.7 mm, refractive index: 1.5). By using the models, relationships between a ratio of the scattering light extracted from the glass substrate with respect to the incident light from the light source when the number of laminated particles in the thickness direction of the glass substrate (transmittance characteristics) and the luminance viewing angle characteristics of the scattering light {relative luminance value (L₆₀/L₀) in the direction of the viewing angle 60° with respect to the luminance value in the viewing angle 0° (normal direction)} were calculated.

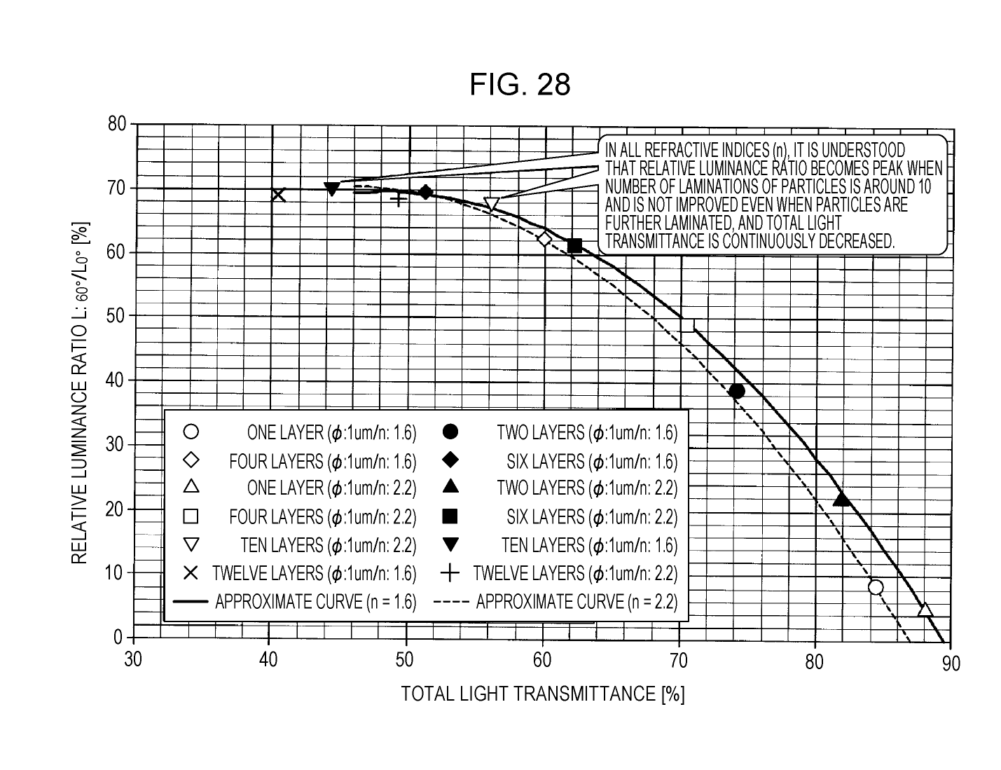

As a result of the calculation, without depending on the refractive index of the particles, the relative luminance value increased as the lamination number of the particles increased, but it was confirmed that the value was saturated about 10 particles. The calculation results are indicated in FIG. 28 as a graph.

### Example 5

### Blue Organic EL+Phosphor Form

In the same manner as in Comparative Examples, after the glass substrate having a thickness of 0.7 mm was washed, 10 minutes of the pure water ultrasonic washing, 10 minutes of the acetone ultrasonic washing, and 5 minutes of the isopropyl alcohol steam washing were performed, and the resultant was dried at 100° C. for one hour.

Subsequently, the partition walls (light scattering film) were formed on the glass substrate. Hereinafter, the method of forming the partition walls is described in detail.

First, the photosensitive white composition including the epoxy-based resin (refractive index: 1.59), the acrylic resin (refractive index: 1.49), the rutile-type titanium oxide (refractive index: 2.71 and particle diameter: 250 nm), the photoinitiator, and the aromatic solvent was stirred and mixed, so as to prepare the negative resist.

Subsequently, the low refractive index material layer formed on one surface of the glass substrate was coated with the negative resist by the spin coating method.

Thereafter, the pre-baking was performed at 80° C. for 10 minutes, and a coating film having a film thickness of 50 μm was formed.

After the coating film was covered with a mask capable of causing a desired image pattern to be formed, the coating film was irradiated with the i ray (300 mJ/cm²), so as to be exposed.

Subsequently, the development was performed by using the alkali developing solution so as to obtain a pixel pattern-shaped structure in which partition walls were formed.

Subsequently, by using the hot air circulation-type drying furnace, the post-baking was performed at 140° C. for 60 minutes so that the partition walls that partition pixels were formed.

A red phosphor film, a green phosphor film, and a blue scatterer film were formed on the inner side of the opening portion surrounded by the partition walls. Hereinafter, the method of forming the red phosphor film, the green phosphor film, and the blue scatterer film is described in detail.

In order to form the red phosphor film, 15 g of ethanol and 0.22 g of y-glycidoxypropyltriethoxysilane were added to 0.16 g of Aerosil having an average particle diameter of 5 nm and stirred in an open system and at room temperature for one hour. The mixture and 20 g of the red phosphor K₅Eu_{2.5}(WO₄)_{6.25} were moved to the mortar, mashed and mixed well, heated in an oven at 70° C. for 2 hours, and further heated in an oven at 120° C. for 2 hours, so as to obtain surface-modified K₅Eu_{2.5}(WO₄)_{6.25}.

Subsequently, 30 g of polyvinyl alcohol dissolved in the mixed solution (300 g) in which water/dimethyl sulfoxide=1/1 was added to 10 g of surface-modified K₅Eu_{2.5}(WO₄)_{6.25}, and stirred with a disperser, so as to prepare a coating liquid for forming the red phosphor.

Subsequently, the inner side of the predetermined opening portion on the partition wall was coated with the coating liquid for forming the red phosphor by the dispenser method.

Subsequently, the resultant was heated and dried in the vacuum oven (in the condition of 200° C. and 10 mmHg) for 4 hours, so as to form the red phosphor film having a film thickness of 50 μm.

In order to form the green phosphor film, 15 g of ethanol and 0.22 g of γ-glycidoxypropyltriethoxysilane were added to 0.16 g of Aerosil having an average particle diameter of 5 nm, and stirred in an open system and at room temperature for one hour. The mixture and 20 g of the green phosphor Ba₂SiO₄:Eu²⁺ were moved to the mortar, mashed and mixed well, heated in an oven at 70° C. for 2 hours, and further heated in an oven at 120° C. for 2 hours, so as to obtain surface-modified Ba₂SiO₄:Eu²⁺.

Subsequently, 30 g of polyvinyl alcohol dissolved in the mixed solution (300 g) in which water/dimethyl sulfoxide=1/1 was added to 10 g of surface-modified Ba₂SiO₄:Eu²⁺, was stirred with a disperser, so as to obtain the coating liquid for forming the green phosphor.

Subsequently, the inner side of the predetermined opening portion on the partition wall was coated with the coating liquid for forming the green phosphor by the dispenser method.

Subsequently, the resultant was heated and dried in the vacuum oven (in the condition of 200° C. and 10 mmHg) for 4 hours, so as to form the green phosphor film having a film thickness of 50 μm.

In order to form the blue scatterer film, 3.2 g of aluminum oxide “AX3-32” (average particle diameter: 1 μm to 4 μm/refractive index: 1.7) manufactured by Nippon Steel & Sumikin Materials Co., Ltd. was first added to 30 g of the 10 wt % aqueous solution of polyvinyl alcohol “Poval 500” manufactured by Kishida Chemical Co., Ltd. used as the binder, mashed and mixed well for 30 minutes with the automatic mortar, and preliminarily stirred at the stirring speed of 3000 rpm in an open system and at room temperature for 15 minutes by using a dispersion stirring apparatus “Filmix 40-40 type” manufactured by Primix Corporation so as to obtain the scatterer material.

Subsequently, the inner side of the opening portion surrounded by the partition walls was coated with the coating liquid for forming the blue scatterer by the dispenser method. Thereafter, the binder was baked by being heated at 400° C. for 30 minutes so as to form the blue scatterer film having a film thickness of 50 μm.

Subsequently, on the surfaces of the red phosphor film, the green phosphor film, and the blue scatterer film to which the excited light was incident, as the wavelength selection transmission reflection film, a dielectric multilayer film manufactured by alternately forming 6 layers of titanium oxide (TiO₂: refractive index=2.30) and silicon oxide (SiO₂: refractive index=1.47) by the EB vapor deposition method was formed to have a film thickness of 100 nm by the sputtering method, so as to obtain the phosphor substrate including the glass substrate, the low refractive index film formed on the one surface of the glass substrate, the red phosphor film, the green phosphor film, the blue scatterer film, the partition wall, and the wavelength selection transmission reflection film.

Meanwhile, the reflective electrode which is formed of silver and has a film thickness of 100 nm was formed on the glass substrate having a thickness of 0.7 mm by the sputtering method, and a transparent indium tin oxide (ITO) film having a film thickness of 20 nm was formed on the reflective electrode by the sputtering method so that the first electrode (anode) was formed.

Thereafter, the first electrode was patterned into 90 stripes so that the width is set to be 160 μm, and the pitch is set to be 200 μm by the photolithographic method in the related art.

Subsequently, SiO₂ was laminated on the first electrode by 200 nm by the sputtering method, and patterned so that only the edge portion of the first electrode is covered by the photolithographic method in the related art.

Here, the present invention has the structure in which the narrow sides were covered with SiO₂ by 10 μm from the end of the first electrode.

After this was washed, 10 minutes of the pure water ultrasonic washing, 10 minutes of the acetone ultrasonic washing, and 5 minutes of the isopropyl alcohol steam washing were performed, and the resultant was dried at 120° C. for one hour.

Subsequently, the substrate on which the first electrode was formed was fixed to the substrate holder in the inline-type resistance heating vapor deposition device, the pressure is reduced to a vacuum of 1×10⁻⁴ Pa or lower, and respective layers configuring the organic EL layer including the organic light emitting layer were formed. Hereinafter, the method of forming respective layers configuring the organic EL layer is described in detail.

First, as a hole injection material, by using 1,1-bis-di-4-tolylamino-phenyl-cyclohexane (TAPC), a hole injection layer having a film thickness of 100 nm was formed by the resistance heating vapor deposition method.

Subsequently, as the hole transportation material, N,N′-di-1-naphthyl-N,N′-diphenyl-1,1′-biphenyl-1,1′-biphenyl-4,4′-diamine (NPD) was used, and the hole transportation layer having a film thickness of 40 nm was formed by the resistance heating vapor deposition method.

Subsequently, the blue organic light emitting layer (thickness: 30 nm) was formed at a desired pixel position on the hole transportation layer. The blue organic light emitting layer was formed by codepositing 1,4-bis-triphenylsilyl-benzene (UGH-2) (host material) and bis[(4,6-difluorophenyl)-pyridinate-N,C2′]picolinate iridium (III) (FIrpic) (blue phosphorescent light emitting dopant), at deposition rates of 0.15 nm/sec and 0.02 nm/sec, respectively.

Subsequently, the hole prevention layer (thickness: 10 nm) was formed on the organic light emitting layer by using 2,9-dimethyl-4,7-diphenyl-1,10-phenanthroline (BCP).

Subsequently, an electron transportation layer (thickness: 30 nm) was formed on the hole prevention layer by using tris(θ-hydroxyquinoline)aluminum (Alq₃).

Subsequently, an electron injection layer (thickness: 0.5 nm) was formed on the electron transportation layer by using lithium fluoride (LiF).

According to the processes above, the respective layers configuring the organic EL layer were formed.

Thereafter, a translucent electrode was formed as the second electrode.

First, the substrate was fixed to a chamber for metal vapor deposition, and the shadow mask for forming the translucent electrode and the substrate were aligned. In addition, as the shadow mask, a mask provided with opening portions so as to form a second electrode in stripe forms having a width of 500 μm and the pitch of 600 μm in the direction of facing the stripe of the first electrode was used.

Subsequently, magnesium silver was formed to a desired pattern (thickness: 1 nm) on the surface of the electron injection layer by the vacuum vapor deposition method by codepositing magnesium and silver at deposition rates of 0.01 nm/sec, 0.09 nm/sec, respectively.

Further, moreover, for the purpose of emphasizing the interference effect and the purpose of preventing the voltage drop caused by the wiring resistance in the second electrode, silver was formed into a desired pattern (thickness: 19 nm) at a deposition rate of 0.1 nm/sec.

According to the processes above, the translucent electrode was formed.

Here, the microcavity effect (interference effect) is achieved between the first electrode and the second electrode, so that the front surface luminance can be increased. Accordingly, the light emitting energy from the organic EL layer can be effectively spread to the light extracting portion side. In addition, in the same manner, by the microcavity effect, the light emitting peak was adjusted to 460 nm, and the half value width was adjusted to 50 nm.

Subsequently, by the plasma CVD method, using the shadow mask, the inorganic protection layer made of SiO₂ having a thickness of 3 μm was patterned and formed of the ends of the display portion to 2 mm of the sealed areas on the upper, lower, left, and right sides.

According to the processes above, the organic EL element substrate in which the organic EL element was formed was obtained.

Subsequently, the organic EL element substrate and the phosphor substrate manufactured as described above were positioned by positioning markers formed on the outside of the pixel arrangement position. In addition, the phosphor substrate was coated with the thermosetting resin in advance.

After the organic EL element substrate and the phosphor substrate were positioned, both of the substrates were adhered via the thermosetting resin, the thermosetting resin was cured by being heated at 80° C. for two hours, and the organic EL element substrate and the phosphor substrate were stuck. In addition, the process of sticking both substrates was performed under dry air conditions (amount moisture: −80° C.), in order to prevent the deterioration of the organic layer due to moisture.

Finally, the organic EL display device of Example 6 was completed by connecting terminals formed on the circumference to the external power supply.

Here, if the desired electric current was applied to the stripe-shaped electrodes by the external power supply, the blue light emitting organic EL element was set to be the arbitrarily switchable excitation light source, blue light was converted to red light by the red phosphor film, and blue light was converted to green light by the green phosphor film. Accordingly, red and green isotropic light emission was obtained, and blue isotropic light emission was obtained by interposing the blue scatterer film. In this manner, it was possible to obtain an image capable of full color display, favorable images, and good viewing angle characteristics.

### Example 6

### Active Driving-Type Blue Organic EL+Phosphor Form

In the same manner as in Example 5, a phosphor substrate was manufactured.

An amorphous silicon semiconductor film was formed on the glass substrate in a square of 100 mm×100 mm by the PECVD method.

Subsequently, a polycrystalline silicon semiconductor film was formed by performing a crystallizing process.

Subsequently, the polycrystalline silicon semiconductor film was patterned into plural island shapes by using the photolithographic method.

Subsequently, the gate insulating film and the gate electrode layer were formed on the patterned polycrystalline silicon semiconductor layer in this sequence, and patterned by the photolithographic method.

Thereafter, the source and drain regions were formed by doping impurity elements such as phosphorus on the patterned polycrystalline silicon semiconductor film and a TFT element was manufactured. Thereafter, the planarizing film was formed. The planarizing film was formed by stacking a silicon nitride film formed by the PECVD method and an acrylic resin layer formed by the spin coater method in this sequence.

Hereinafter, the method of forming the planarizing film is described in detail.

First, after the silicon nitride film was formed, contact holes that communicate with source and/or drain regions were formed by collectively etching the silicon nitride film and the gate insulating film, and subsequently, source wiring was formed.

Thereafter, the acrylic resin layer was formed, and active matrix substrate was completed by forming the contact hole that communicates with the drain region on the same position of the contact hole in the drain region punched on the gate insulating film and the silicon nitride film.

The function as the planarizing film is realized by the acrylic resin layer. In addition, a capacitor for causing the gate potential of the TFT to be constant is formed by interposing an insulating film such as an insulating interlayer between the drain of the TFT for switching and the source of the TFT for driving.

Contact holes that penetrate the planarizing layer and are electrically connected to the TFT for driving, the first electrode of the red light emitting organic EL element, the first electrode of the green light emitting organic EL element, and the first electrode of the blue light emitting organic EL element were formed on the active matrix substrate.

Subsequently, the first electrodes (anodes) of the respective pixels were formed by sputtering so that the respective light emitting pixels were electrically connected to the contact holes that came into contact with the TFT for driving the light emitting pixel and that were provided to penetrate the planarizing layer.

The first electrode was formed by laminating an aluminum (Al) film having a film thickness of 150 nm and indium oxide-zinc oxide (IZO) having a film thickness of 20 nm.

Subsequently, the first electrode was patterned to a shape corresponding to the respective pixels by the photolithographic method in the related art.

Here, the area of the first electrode was set to 300 μm×160 μm. In addition, the substrate in the square of 100×100 was formed. The display portion was 80 mm×80 mm, and the sealed areas having a width of 2 mm were provided on the upper, lower, left, and right sides of the display portion, and the terminal extracting portions of 2 mm were provided respectively on the shorter sides of the display portion. A terminal extracting portion of 2 mm was provided on a longer side of the display portion in a portion in which folding was performed.

Subsequently, SiO₂ was laminated by 200 nm on the first electrode by the sputtering method, and patterned by the photolithographic method in the related art so that only the edge portions of the first electrode were covered.

Here, an edge cover was formed in the structure in which four sides were covered with SiO₂ by 10 μm from the ends of the first electrode.

Subsequently, the active matrix substrate on which the first electrode was formed was washed.

As the method of washing the active matrix substrate, for example, the ultrasonic washing was performed for 10 minutes by using acetone and isopropyl alcohol, and then UV ozone washing was performed for 30 minutes.

Subsequently, the active matrix substrate on which the first electrode was formed was fixed to the substrate holder in the inline-type resistance heating vapor deposition device, the pressure is reduced to a vacuum of 1×10⁻⁴ Pa or lower, and respective layers configuring the organic EL layer including the organic light emitting layer were formed. Hereinafter, the method of forming respective layers configuring the organic EL layer.

First, as a hole injection material, 1,1-bis-di-4-tolylamino-phenyl-cyclohexane (TAPC) was used, and a hole injection layer having a film thickness of 100 nm was formed by the resistance heating vapor deposition method.

Subsequently, as the hole transportation material, N,N′-di-1-naphthyl-N,N′-diphenyl-1,1′-biphenyl-1,1′-biphenyl-4,4′-diamine (NPD) was used, and the hole transportation layer having a film thickness of 40 nm was formed by the resistance heating vapor deposition method.

Subsequently, the blue organic light emitting layer (thickness: 30 nm) was formed at a desired pixel position on the hole transportation layer. The blue organic light emitting layer was formed by codepositing 1,4-bis-triphenylsilyl-benzene (UGH-2) (host material) and bis[(4,6-difluorophenyl)-pyridinate-N,C2′]picolinate iridium (III) (FIrpic) (blue phosphorescent light emitting dopant), at the deposition rates of 0.15 nm/sec and 0.02 nm/sec, respectively.

Subsequently, the hole prevention layer (thickness: 10 nm) was formed on the organic light emitting layer by using 2,9-dimethyl-4,7-diphenyl-1,10-phenanthroline (BCP).

Subsequently, an electron transportation layer (thickness: 30 nm) was formed on the hole prevention layer by using tris(θ-hydroxyquinoline)aluminum (Alq₃).

Subsequently, an electron injection layer (thickness: 0.5 nm) was formed on the electron transportation layer by using lithium fluoride (LiF).

According to the processes above, the respective layers configuring the organic EL layer were formed.

Thereafter, a translucent electrode was formed as the second electrode.

First, the active matrix substrate on which the organic EL layer was formed was fixed to a chamber for metal vapor deposition, and the shadow mask for forming the translucent electrode and the active matrix substrate were aligned. In addition, as the shadow mask, a mask provided with opening portions so as to form a second electrode in stripe forms having a width of 2 mm in the direction of facing the stripe of the first electrode was used.

Subsequently, magnesium silver was formed to a desired pattern (thickness: 1 nm) on the surface of the electron injection layer by the vacuum vapor deposition method by codepositing magnesium silver at deposition rates of 0.01 nm/sec, 0.09 nm/sec, respectively.

Further, moreover, for the purpose of emphasizing the interference effect and the purpose of preventing the voltage drop caused by the wiring resistance in the second electrode, silver was formed to a desired pattern (thickness: 19 nm) at a deposition rate of 0.1 nm/sec.

According to the processes above, the translucent electrode was formed.

Here, the microcavity effect (interference effect) is achieved between the first electrode and the second electrode, so that the front surface luminance can be increased. Accordingly, the light emitting energy from the organic EL layer can be effectively spread to the light extracting portion side. In addition, in the same manner, by the microcavity effect, the light emitting peak was adjusted to 460 nm, and the half value width was adjusted to 50 nm.

Subsequently, by the plasma CVD method, using the shadow mask, the inorganic protection layer made of SiO₂ having a thickness of 3 μm was patterned and formed of the ends of the display portion to 2 mm of the sealed areas on the upper, lower, left, and right sides.

According to the processes above, the active driving-type organic EL element substrate in which the organic EL element was formed was obtained.

Subsequently, the active driving-type organic EL element substrate and the phosphor substrate manufactured as described above were positioned by positioning markers formed on the outside of the pixel arrangement position.

In addition, the phosphor substrate was coated with the thermosetting resin in advance.

After the active driving-type organic EL element substrate and the phosphor substrate were positioned, both of the substrates were adhered via the thermosetting resin, the thermosetting resin was cured by being heated at 90° C. for two hours, and the organic EL element substrate and the phosphor substrate were stuck. In addition, the process of sticking both substrates was performed under the dry air condition (amount moisture: −80° C.), in order to prevent the deterioration of the organic layer by moisture.

The active driving-type organic EL element was obtained by sticking the polarizer on the substrate in the light extracting direction.

Finally, the active driving-type organic EL display device having a display portion of 80 mm×80 mm was completed by connecting the terminal formed on the shorter side to a power supply circuit via a source driver and connecting the terminal formed on the longer side to an external power supply via a gate driver.

Here, if the desired electric current was applied to the desired stripe-shaped electrodes by the external power supply, the blue light emitting organic EL element was set to be the arbitrarily switchable excitation light source, blue light was converted to red light by the red phosphor film, and blue light was converted to green light by the green phosphor film. Accordingly, red and green isotropic light emission was obtained, and blue isotropic light emission was obtained by interposing the blue scatterer film. In this manner, it was possible to obtain an image capable of full color display, a favorable image, and good viewing angle characteristics.

### Example 7

### Blue LED+Phosphor Form

In the same manner as in Example 6, a phosphor substrate was manufactured.

A buffer layer formed of GaN was grown to a film thickness of 60 nm at 550° C. on a C surface of a sapphire substrate set in a reaction vessel by using trimethyl gallium (TMG) and NH₃.

Subsequently, the temperature was increased to 1050° C., an n-type contact layer formed of Si-doped n-type GaN was grown to a film thickness of 5 μm by using SiH₄ gas in addition to TMG and NH₃.

Subsequently, a second contact layer formed of a Si-doped n-type Al_{0.3}Ga_{0.7}N layer was grown to a film thickness of 0.2 μm at 1050° C. in the same manner, by adding trimethylaluminum (TMA) to raw material gas.

Subsequently, the temperature was decreased to 850° C., a first n-type clad layer formed of Si-doped n-type In_{0.01}Ga_{0.99}N was grown to a film thickness of 60 nm by using TMG, trimethylindium (TMI), NH₃, and SiH₄.

Subsequently, an active layer formed of non-doped In_{0.05}Ga_{0.95}N was grown to a film thickness of 5 nm at 850° C. by using TMG, TMI, and NH₃. Further, the first p-type clad layer formed of Mg-doped p-type In_{0.01}Ga_{0.99}N was grown to a film thickness of 60 nm at 850° C. by newly using CPMg (cyclopentadienyl magnesium) in addition to TMG, TMI, NH₃.

Subsequently, the temperature was increased to 1100° C., a second p-type clad layer formed of Mg-doped p-type Al_{0.3}Ga_{0.7}N was grown to a film thickness of 150 nm by using TMG, TMA, NH₃, and CPMg.

Subsequently, the p-type contact layer formed of Mg-doped p-type GaN was grown to a film thickness of 600 nm by using TMG, NH₃, and CPMg at 1100° C.

After the operations above were completed, the temperature was decreased to room temperature, the wafer was extracted from the reaction vessel, and annealing of the wafer was performed at 720° C. so that the resistance of the p-type layer is caused to be decreased.

Subsequently, a predetermined shape of the mask was formed on the surface of the p-type contact layer of the upper most layer, and etching was performed until the surface of the n-type contact layer was exposed.

After the etching, a negative electrode formed of titanium (Ti) and aluminum (Al) was formed on the surface of the n-type contact layer, and a positive electrode formed of nickel (Ni) and gold (Au) was formed on the surface of the p-type contact layer.

After the positive electrode was formed, the wafer was separated into chips in the square of 350 μm, the LED chips were fixed with a UV curable resin on the substrate on which wiring to be connected to an external circuit was formed, the LED chip and the wiring on the substrate were electrically connected, and thus a light source substrate formed of a blue LED was obtained.

Subsequently, the light source substrate and the phosphor substrate manufactured as described above were positioned by positioning markers formed on the outside of the pixel arrangement position. In addition, the phosphor substrate was coated with the thermosetting resin in advance.

After the light source substrate and the phosphor substrate were positioned, both of the substrates were adhered via the thermosetting resin, the thermosetting resin was cured by being heated at 80° C. for two hours, and the organic EL element substrate and the phosphor substrate were stuck. In addition, the process of sticking both substrates was performed under the dry air condition (amount moisture: −80° C.), in order to prevent the deterioration of the organic layer by moisture.

Finally, the LED display device of Example 8 was completed by connecting terminals formed on the circumference to the external power supply.

Here, if the desired electric current was applied to the desired stripe-shaped electrodes by the external power supply, the blue light emitting organic EL element was set to be the arbitrarily switchable excitation light source, blue light was converted to red light by the red phosphor film, and blue light was converted to green light by the green phosphor film. Accordingly, red and green isotropic light emission was obtained, and blue isotropic light emission was obtained by interposing the blue scatterer film. In this manner, it was possible to obtain an image capable of full color display, a favorable image, and good viewing angle characteristics.

### Example 8

### Blue Organic EL+Liquid Crystal+Phosphor Form

The partition walls (light scattering film) were formed on the glass substrate having a thickness of 0.7 mm. Hereinafter, the method of forming the partition wall was described in detail.

The photosensitive white composition formed of an epoxy-based resin (refractive index: 1.59), an acrylic resin (refractive index: 1.49), a rutile-type titanium oxide (refractive index: 2.71, particle diameter: 250 nm), a photoinitiator, and an aromatic solvent was stirred and mixed, so as to prepare the negative resist.

Subsequently, one surface of the glass substrate was coated with the negative resist by the spin coating method.

Thereafter, the pre-baking was performed at 80° C. for 10 minutes, and a coating film having a film thickness of 50 μm was formed.

After the coating film was covered with a mask capable of causing a desired image pattern to be formed, the coating film was irradiated with the i ray (300 mJ/cm²), so as to be exposed.

Subsequently, the development was performed by using the alkali developing solution so as to obtain a pixel pattern-shaped structure in which partition walls were formed.

Subsequently, the post-baking was performed at 140° C. for 60 minutes by using a hot air circulation-type drying furnace so that partition walls that partition pixels were formed.

Subsequently, the red phosphor film, the green phosphor film, and the blue scatterer film were formed in an opening portion surrounded by the partition walls. Hereinafter, the method of forming the red phosphor film, the green phosphor film, and the blue scatterer film is described in detail.

First, in order to form the red phosphor layer, [2-[2-[4-(dimethylamino)phenyl]ethenyl]-6-methyl-4H-pyran-4-iriden]-propanedinitrile (DCM) (0.02 mol/kg (solid content ratio)) was mixed with the epoxy-based thermosetting resin and stirred with a stirrer, so as to prepare the coating liquid for forming the red phosphor.

Subsequently, the inner side of the predetermined opening portion on the partition wall was coated with the coating liquid for forming the red phosphor by the dispenser method.

Subsequently, the resultant was heated and dried in the vacuum oven (in the condition of 150° C.) for one hour, so as to form the red phosphor film having a film thickness of 10 μm.

First, in order to form the green phosphor film, 2,3,6,7-tetrahydro-11-oxo-1H,5H,11H-[1]benzopyrano[6,7,8-ij]quinolizine-10-carboxylic acid (Coumarin 519) (0.02 mol/kg (solid content ratio)) was mixed with the epoxy-based thermosetting resin, stirred with a stirrer, so as to prepare the coating liquid for forming the green phosphor.

Subsequently, the inner side of the predetermined opening portion on the partition wall was coated with the coating liquid for forming the green phosphor by the dispenser method.

Subsequently, the resultant was heated and dried in the vacuum oven (in the condition of 150° C.) for one hour, so as to form the green phosphor film having a film thickness of 10 μm.

First, in order to form the blue scatterer film, 0.1 g of titanium oxide “A-190” (average particle diameter: 150 nm/refractive index: 2.5) manufactured by Sakai Chemical Industry Co., Ltd. and 0.3 g of silica “HS-301” (average particle diameter: 1 μm to 3 μm/refractive index: 1.5) manufactured by Nippon Steel & Sumikin Materials Co., Ltd. were added to 30 g of the 10 wt % aqueous solution of polyvinyl alcohol “Poval 500” manufactured by Kishida Chemical Co., Ltd. used as a binder, mashed and mixed well for 30 minutes with the automatic mortar, and preliminarily stirred at the stirring speed of 3000 rpm in an open system and at room temperature for 15 minutes by using a dispersion stirring apparatus “Filmix 40-40 type” manufactured by Primix Corporation so as to obtain the scatterer material.

Subsequently, the inner side of the opening portion surrounded by the partition walls was coated with the coating liquid for forming the blue scatterer by the dispenser method. Thereafter, the binder was baked by being heated at 400° C. for 30 minutes so as to form the blue scatterer film having a film thickness of 10 μm.

Subsequently, on the surfaces of the red phosphor film, the green phosphor film, and the blue scatterer film to which the excited light was incident, as the wavelength selection transmission reflection film, an dielectric multilayer film manufactured by alternately forming 6 layers of titanium oxide (TiO₂: refractive index=2.30) and silicon oxide (SiO₂: refractive index=1.47) by the EB vapor deposition method was formed to have a film thickness of 100 nm by the sputtering method.

Subsequently, the planarizing film was formed on the wavelength selection transmission reflection film by using the acrylic resin by the spin coating method, and a polarizing film, a transparent electrode, and a light distributing film were formed on the planarizing film by the method in the related art, so that the glass substrate and the phosphor substrate which was formed of the low refractive index film, the red phosphor film, the green phosphor film, the blue scatterer film, the partition wall, the wavelength selection transmission reflection film, and the like and formed on one surface of the glass substrate were obtained.

Subsequently, the switching element formed of the TFT was formed on the glass substrate by the method in the related art.

Subsequently, an ITO transparent electrode having a film thickness of 100 nm was formed so as to the TFT via the contact hole.

Subsequently, the transparent electrode was patterned by the photolithographic method in the related art so as to have the same pitch as the pixels in the organic EL portion manufactured in advance.

Subsequently, an alignment film was formed by a printing process.

Subsequently, the substrate on which the TFT was formed and the phosphor substrate were bonded to each other via a spacer having a thickness of 10 μm, and a TN-mode liquid crystal material was injected between both of the substrates, so as to complete the liquid crystal and phosphor portion.

Meanwhile, the reflective electrode which is formed of silver and has a film thickness of 100 nm was formed on the glass substrate having a thickness of 0.7 mm by the sputtering method, and a transparent indium tin oxide (ITO) film having a film thickness of 20 nm was formed on the reflective electrode by the sputtering method so that the first electrode (anode) was formed.

Thereafter, the first electrode was patterned so that the width of the first electrode becomes the desired size by the photolithographic method in the related art.

Subsequently, SiO₂ was laminated by 200 nm on the first electrode by the sputtering method, and patterned by the photolithographic method in the related art so that only the edge portions of the first electrode were covered.

Here, the present invention has the structure in which the narrow sides were covered with SiO₂ by 10 μm from the end of the first electrode.

After this was washed, 10 minutes of the pure water ultrasonic washing, 10 minutes of the acetone ultrasonic washing, and 5 minutes of the isopropyl alcohol steam washing were performed, and the resultant was dried at 120° C. for one hour.

Subsequently, the substrate on which the first electrode was formed was fixed to the substrate holder in the inline-type resistance heating vapor deposition device, the pressure is reduced to a vacuum of 1×10⁻⁴ Pa or lower, and respective layers configuring the organic EL layer including the organic light emitting layer were formed. Hereinafter, the method of forming respective layers configuring the organic EL layer is described in detail.

First, as a hole injection material, by using 1,1-bis-di-4-tolylamino-phenyl-cyclohexane (TAPC), a hole injection layer having a film thickness of 100 nm was formed by the resistance heating vapor deposition method.

Subsequently, the hole transportation layer having a film thickness of 10 nm was formed by the resistance heating vapor deposition method by using carbazole biphenyl (CBP) as the hole transportation material.

Subsequently, the near ultraviolet organic light emitting layer (thickness: 30 nm) was formed in the desired pixel position on the hole transportation layer. The near ultraviolet organic light emitting layer was formed by vapor-depositing 3,5-bis(4-t-butyl-phenyl)-4-phenyl-[1,2,4]triazole (TAZ) (near ultraviolet phosphorescent light emitting material) at the deposition rate of 0.15 nm/sec.

Subsequently, the hole prevention layer (thickness: 20 nm) was formed on the organic light emitting layer by using 2,9-dimethyl-4,7-diphenyl-1,10-phenanthroline (BCP).

Subsequently, the electron transportation layer (thickness: 30 nm) was formed on the hole prevention layer by using tris(θ-hydroxyquinoline)aluminum (Alq₃).

Subsequently, the electron injection layer (thickness: 0.5 nm) was formed on the electron transportation layer by using lithium fluoride (LiF).

According to the processes above, the respective layers configuring the organic EL layer were formed.

Thereafter, the translucent electrode was formed as the second electrode.

First, the substrate was fixed to a chamber for metal vapor deposition, and the shadow mask for forming a translucent electrode and the substrate were aligned. In addition, as the shadow mask, a mask provided with opening portions so as to form a second electrode in stripe forms having a width of 500 μm and the pitch of 600 μm in the direction of facing the stripe of the first electrode was used.

Subsequently, magnesium silver was formed to a desired pattern (thickness: 1 nm) on the surface of the electron injection layer by the vacuum vapor deposition method by codepositing magnesium and silver at deposition rates of 0.01 nm/sec, 0.09 nm/sec, respectively.

Further, moreover, for the purpose of emphasizing the interference effect and the purpose of preventing the voltage drop caused by the wiring resistance in the second electrode, silver was formed to a desired pattern (thickness: 19 nm) at a deposition rate of 0.1 nm/sec.

According to the processes above, the translucent electrode was formed.

The microcavity effect (interference effect) is achieved between the first electrode and the second electrode, so that the front surface luminance can be increased. Accordingly, the light emitting energy from the organic EL layer can be effectively spread to the light extracting portion side. In addition, in the same manner, by the microcavity effect, the light emitting peak was adjusted to 370 nm, and the half value width was adjusted to 30 nm.

Subsequently, by the plasma CVD method, using the shadow mask, the inorganic protection layer made of SiO₂ having a thickness of 3 μm was patterned and formed of the ends of the display portion to 2 mm of the sealed areas on the upper, lower, left, and right sides.

According to the processes above, the organic EL element substrate in which the organic EL element was formed was obtained.

Subsequently, the organic EL element substrate and the phosphor substrate manufactured as described above were positioned by positioning markers formed on the outside of the pixel arrangement position. In addition, the phosphor substrate was coated with the thermosetting resin in advance.

After the organic EL element substrate and the phosphor substrate were positioned, both of the substrates were adhered via the thermosetting resin, the thermosetting resin was cured by being heated at 80° C. for two hours, and the organic EL element substrate and the phosphor substrate were stuck. In addition, the process of sticking both substrates was performed under the dry air condition (amount moisture: −80° C.), in order to prevent the deterioration of the organic layer by moisture.

Finally, the organic EL display device of Example 9 was completed by connecting terminals formed on the circumference to the external power supply.

Here, if the desired electric current was applied to the stripe-shaped electrodes by the external power supply, the blue light emitting organic EL element was set to be the arbitrarily switchable excitation light source, blue light was converted to red light by the red phosphor film, and blue light was converted to green light by the green phosphor film. Accordingly, red and green isotropic light emission was obtained, and blue isotropic light emission was obtained by interposing the blue scatterer film. In this manner, it was possible to obtain an image capable of full color display, favorable images, and good viewing angle characteristics.

### Example 9

### Blue Back Light+Liquid Crystal+Phosphor Form

In the same manner as in Example 7, a liquid crystal and phosphor substrate portion was manufactured.

A directivity blue back light was combined to the liquid crystal side of the liquid crystal and phosphor substrate portion.

A directivity blue back light formed of a light source, a light guiding plate, a reflecting sheet, a luminance improving film, a condensing lens was used. As the light source, an LED “NFSC036C” having a peak wavelength of 465 nm manufactured by Nichia Corporation was used, and arranged on the side surface of the light guiding plate. As the light guiding plate, a plate obtained by forming a polycarbonate resin to a wedge shape by injection molding was used. A reflecting sheet “ESR” manufactured by 3M was used on the bottom surface of the light guiding plate (LED was provided on the side on which the sectional area of the wedge-shaped light guiding plate was great). The desired directivity blue back light was completed by mounting a luminance improving film “DBEFD400” manufactured by 3M and a condensing Fresnel lens “CF3-0.1” manufactured by Nihon Tokushu Kogaku Jushi Co., Ltd. on the upper surface side of the light guiding plate (emitting surface side) in this sequence.

Finally, the liquid crystal display device of Example 8 was completed by connecting terminals formed on the circumference to the external power supply.

Here, if the desired electric current was applied to the stripe-shaped electrodes by the external power supply, the blue light emitting organic EL element was set to be the arbitrarily switchable excitation light source, blue light was converted to red light by the red phosphor film, and blue light was converted to green light by the green phosphor film. Accordingly, red and green isotropic light emission was obtained, and blue isotropic light emission was obtained by interposing the blue scatterer film. In this manner, it was possible to obtain an image capable of full color display, favorable images, and good viewing angle characteristics.

Appearances of the light emitting sides of the light emitting device according to the first embodiment illustrated in FIG. 4 and the light emitting device in the related art were compared. The light emitting device according to the first embodiment includes a gap formed of air (refractive index=1.0) between the particle and one surface of the substrate, as the light scatterer layer. Meanwhile, in the light emitting device in the related art which is the Comparative Example, particles are dispersed in the resin (refractive index=1.53), as the light scatterer layer.

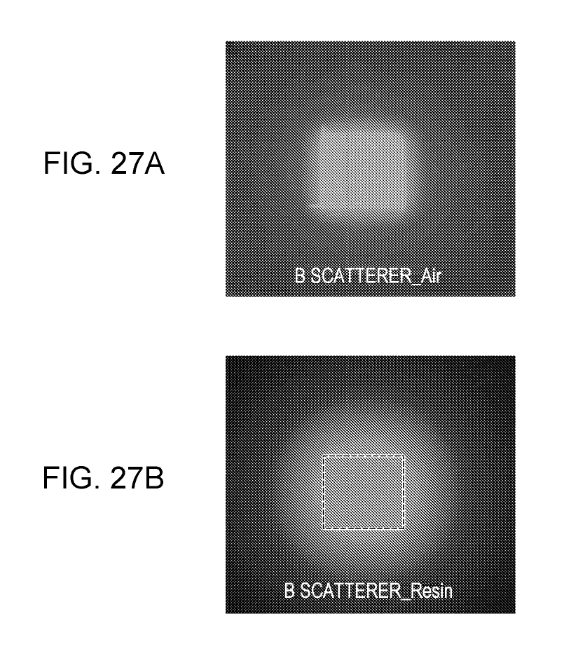

The appearances (photographs) of the scattering of light on the light emitting sides of the light emitting device according to the first embodiment and the light emitting device in the related art are illustrated in FIGS. 27A and 27B. As illustrated in FIG. 27A, in the light emitting device according to the first embodiment, it was found that an interface portion of the rectangular emitting surface became clear and the bleeding of the light was less. However, as illustrated in FIG. 27B, in the light emitting device in the related art, it was found that an interface portion of the rectangular emitting surface became becomes indistinct, and the bleeding of the light was great. Accordingly, if the light emitting device according to the first embodiment is applied, for example, to a display device, it is possible to realize a display device that can display an image in which bleeding is less and which is clear.

(1) A scatterer substrate 39 including at least: a substrate 35; and a scatterer layer 34 which is overlapped and disposed on one surface side 35a of the substrate and has a plurality of non-light emitting particles 32 that change a traveling direction of light,

in which gaps 33 are formed between the one surface of the substrate and the particles.

(2) The scatterer substrate according to (1), in which the particles 32 are formed of an inorganic material.

(3) The scatterer substrate according to (1) or (2), in which two or more and ten or fewer particles 32 are present in a thickness direction of the scatterer layer.

(4) The scatterer substrate according to any one of (1) to (3), in which the particles 32 have an average particle diameter of 50 nm or more and 10 μm or less.

(5) The scatterer substrate according to any one of (1) to (4), in which the particles 32 are formed of at least two kinds of particles 32a and 32b whose average particle diameters are different from each other.

(6) The scatterer substrate according to any one of (1) to (5), in which the particles 32 include first particles 32a and second particles 32b which have average particle diameters different from each other, the relationship between an average particle diameter Da of the first particles and an average particle diameter Db of the second particles satisfies Da≧Db, and the relationship between a volume Va of the first particles occupying the scatterer layer and a volume Vb of the second particles occupying the scatterer layer satisfies Va≧Vb.

(7) The scatterer substrate according to any one of (1) to (6), in which the particles 32 are disposed such that the thickness of the particles on one surface side of the substrate is 10 μm or greater.

(8) The scatterer substrate according to any one of (1) to (7), in which the gaps 33 are filled with a low refractive index medium.

(9) The scatterer substrate according to (θ), in which the low refractive index medium is a gas.

(10) The scatterer substrate according to (9), in which the gas contains at least one selected from air, N₂, O₂, Ar, and CO₂.

(11) The scatterer substrate according to any one of (1) to (7), in which the gaps 33 are a vacuum.

(12) The scatterer substrate according to any one of (1) to (11), in which a bonding layer which bonds the particles adjacent to each other is formed between the particles.

(13) The scatterer substrate according to any one of (1) to (12), in which the substrate 35 is formed of glass.

(14) A light emitting device 30 including: the scatterer substrate 39 according to any one of (1) to (13); and a light source 31 which emits the light.

(15) The light emitting device according to (14), in which a light-reflective partition wall 41 is formed along at least one side surface of the scatterer layer which is arranged along a direction in which the light source and the scatterer substrate are laminated.

(16) The light emitting device according to (15), in which at least a region, which is in contact with the scatterer layer, of the partition wall 41 has light scattering properties.

(17) The light emitting device according to any one of (14) to (16), in which phosphor layers 52 and 53 which emit fluorescence by using light from the light source are arranged along a direction in which the light source 31 and the scatterer substrate 39 are laminated.

(18) The light emitting device according to (17), including: an excitation light source 51 which emits blue light; a red phosphor layer 52 which constitutes a red pixel that is excited by the blue light and emits red fluorescence; a green phosphor layer 53 which constitutes a green pixel that is excited by the blue light and emits green fluorescence; and the scatterer layer 56 which constitutes a blue pixel that scatters the blue light, which are arranged so as to face the excitation light source.

(19) The light emitting device according to (17), including: an excitation light source which emits blue light; a red phosphor layer 52 which constitutes a red pixel that is excited by the blue light and emits red fluorescence; a green phosphor layer 53 which constitutes a green pixel that is excited by the blue light and emits green fluorescence; a blue phosphor layer 71 which constitutes a blue pixel that is excited by the blue light and emits blue fluorescence, which are arranged so as to face the excitation light source; and the scatterer layer which scatters the fluorescence.

(20) The light emitting device according to any one of (17) to (19), in which a light-reflective partition wall 81 is formed along a side surface of the phosphor layers.

(21) The light emitting device according to (20), wherein at least a region, which is in contact with the phosphor layers, of the partition wall 81 has light scattering properties.

(22) The light emitting device according to any one of (17) to (21), in which a wavelength selection layer 91 which has characteristics of transmitting at least light having a predetermined wavelength region centering on a peak wavelength of the blue light and reflecting at least light having a predetermined wavelength region centering on a light emitting peak wavelength of the phosphor layers is formed on an incident surface side of the phosphor layers on which the blue light is incident.

(23) The light emitting device according to any one of (17) to (22), in which a low refractive index layer 101 whose refractive index is lower than that of the phosphor layers is formed between the phosphor layers and the wavelength selection layer.

(24) The light emitting device according to (23), in which the refractive index of the low refractive index layer 101 is in a range of 1 or higher and 1.5 or lower.

(25) The light emitting device according to (23) or (24), in which the low refractive index layer 101 is formed of a gas.

(26) The light emitting device according to any one of (17) to (25), wherein a light absorbing layer 121 is further formed between the phosphor layers adjacent to each other or between the phosphor layers and the blue scatterer layer.

(27) The light emitting device according to (26), in which the light absorbing layer 121 is formed on at least one of an upper surface and a lower surface of the partition wall.

(28) A display device 210 including at least the light emitting device according to any one of (14) to (27).

(29) The display device according to (28), further including an active matrix driving element 264 for the light source 31.

(30) The display device according to (28) or (29), in which the light source 31 is formed of any one of a light emitting diode, an organic electroluminescence element, and an inorganic electroluminescence element.

(31) The display device according to any one of (28) to (30), in which the light source 31 is a planar light source, and a liquid crystal element 303 in which a transmittance of light emitted from the light source is controllable is provided between the light source and the substrate.

(32) The display device according to any one of (28) to (31), in which the light source 31 emits the blue light having directivity.

(33) The display device according to any one of (28) to (32), in which a polarizer 311 in which an extinction ratio in a wavelength range of 435 nm or more and 480 nm or less is 10000 or greater is further provided between the excitation light source and the substrate.

(34) The display device according to any one of (28) to (33), in which color filters 131 and 132 are formed at least between the phosphor layers and blue scatterer film and the low refractive index film or between the low refractive index film and the substrate.

(35) A lighting device including the light emitting device 30 according to any one of (14) to (27).

### INDUSTRIAL APPLICABILITY

The present invention can be applied to a scatterer substrate, a light emitting device, and various display devices and lighting devices using the scatterer substrate and the light emitting device.

### REFERENCE SIGNS LIST

30: LIGHT EMITTING DEVICE
31: LIGHT SOURCE
32: PARTICLES
33: GAP
34: SCATTERER LAYER
35: SUBSTRATE
39: SCATTERER SUBSTRATE

1-35. (canceled)

36. A light emitting device comprising:
a substrate;
a scatterer layer or a scatterer film which is overlapped and disposed on one surface side of the substrate, has a plurality of non-light emitting particles that change a traveling direction of light, and is formed of at least the particles and gaps maintained between the particles and the substrate;
a light source which emits light; and
a phosphor layer which emits fluorescence by using light emitted from the light source,
wherein a refractive index of the gaps is approximately equal to a refractive index of the outside of a surface opposite the surface of the substrate on which gaps are formed.

37. The light emitting device according to claim 36, wherein the refractive index of the gaps is approximately 1.0.

38. The light emitting device according to claim 36, wherein the light emitting device includes an excitation light source which emits blue light; a red phosphor layer which constitutes a red pixel that is excited by the blue light and emits red fluorescence; a green phosphor layer which constitutes a green pixel that is excited by the blue light and emits green fluorescence; and the scatterer layer which constitutes a blue pixel that scatters the blue light, which are arranged so as to face the excitation light source.

39. The light emitting device according to claim 36, wherein the light emitting device includes an excitation light source which emits blue light; a red phosphor layer which constitutes a red pixel that is excited by the blue light and emits red fluorescence; a green phosphor layer which constitutes a green pixel that is excited by the blue light and emits green fluorescence; a blue phosphor layer which constitutes a blue pixel that is excited by the blue light and emits blue fluorescence, which are arranged so as to face the excitation light source; and the scatterer layer or the scatterer film which scatters the fluorescence.

40. The light emitting device according to claim 36, wherein the scatterer layer or the scatterer film is formed between the substrate and the phosphor layer.

41. The light emitting device according to claim 36, wherein the gaps are filled with a gas.

42. The light emitting device according to claim 41, wherein the gas contains at least one selected from air, N₂, O₂, Ar, and CO₂.

43. The light emitting device according to claim 36, wherein the particles are formed of an inorganic material and have an average particle diameter of 50 nm or more and 10 μm or less.

44. The light emitting device according to claim 36, wherein two or more and ten or fewer particles are present in a thickness direction of the scatterer layer or the scatterer film.

45. The light emitting device according to claim 36, wherein the particles are formed of at least two kinds of particles whose average particle diameters are different from each other.

46. The light emitting device according to claim 36,
wherein the particles include first particles and second particles which have average particle diameters different from each other,
the relationship between an average particle diameter Da of the first particles and an average particle diameter Db of the second particles satisfies Da≧Db, and
the relationship between a volume Va of the first particles occupying the scatterer layer or the scatterer film and a volume Vb of the second particles occupying the scatterer layer or the scatterer film satisfies Va≧Vb.

47. The light emitting device according to claim 36, wherein the scatterer layer or the scatterer film is disposed on one surface side of the substrate such that the thickness of the scatterer layer or the scatterer film is 10 μm or greater.

48. The light emitting device according to claim 36,
wherein a light-reflective partition wall, which is arranged along a direction in which the scatterer layer or the scatterer film are laminated, is formed along at least one side surface of the scatterer layer or the scatterer film, and
at least a region, which is in contact with the scatterer layer or the scatterer film, of the partition wall has light scattering properties.

49. The light emitting device according to claim 36,
wherein a light-reflective partition wall is formed along the side surface of the phosphor layer, and
at least a region, which is in contact with the phosphor layer, of the partition wall has light scattering properties.

50. The light emitting device according to claim 48, wherein a light absorbing layer is formed on at least one of a region between the substrate and the partition wall, and an incident surface of the partition wall on which the excitation light is incident.

51. The light emitting device according to claim 36, wherein a wavelength selection layer which has characteristics of transmitting at least light having a predetermined wavelength region centering on a peak wavelength of blue light and reflecting at least light having a predetermined wavelength region centering on a light emitting peak wavelength of the phosphor layer is formed on an incident surface side of the phosphor layer on which the blue light is incident.

52. A display device comprising at least the light emitting device according to claim 36.

53. The display device according to claim 52, wherein the light source is formed of any one of a light emitting diode, an organic electroluminescence element, and an inorganic electroluminescence element.

54. The display device according to claim 52,
wherein the light source is a planar light source, and
a liquid crystal element in which a transmittance of light emitted from the light source is controllable is provided between the light source and the substrate.

55. The display device according to claim 52, wherein a color filter is formed between the scatterer layer or the scatterer film and the substrate.
